(19) United States
(12) Patent Application Publication
(10) Pub. No.: US 2026/0195184 A1
(43) Pub. Date: Jul. 9, 2026

(54) SYSTEM AND METHOD FOR PROMPT OPTIMIZATION AND INTER-MODEL ADAPTATION FOR LARGE LANGUAGE MODULES

(71) Applicant: Aixplain, Inc., San Jose, CA (US)

(72) Inventors: Kamer Ali YUKSEL, Munchen (DE); Hassan SAWAF, San Jose, CA (US)

(73) Assignee: Aixplain, Inc., San Jose, CA (US)

(21) Appl. No.: 19/558,329

(22) Filed: Mar. 5, 2026

Related U.S. Application Data
(63) Continuation-in-part of application No. 19/202,573, filed on May 8, 2025.
Application No. 19/202,573 is a continuation of application No. 18/922,050, filed on Oct. 21, 2024, now Pat. No. 12,307,299.
(60) Provisional application No. 63/767,106, filed on Mar. 5, 2025.

(51) Int. Cl. G06F 9/50

(52) U.S. Cl. CPC G06F 9/5038

(57) ABSTRACT

Computer-implemented method and system for transforming inputs for language models. The method generates paired data comprising original inputs and corresponding transformed inputs based on evaluation against a first language model. A transformation model is trained on the paired data, wherein the transformation model does not share parameters with and is not trained using gradients from any target language model. An adaptation module is trained to convert transformed inputs configured for the first language model into adapted inputs configured for different language models. At runtime, the transformation model is applied to an input to produce a transformed input in a single forward pass without accessing the target language model. For inputs comprising accumulated context from a task sequence, the transformation model compresses the accumulated context based on relevance to upcoming tasks. When the target language model differs from the first language model, the adaptation module is applied to produce adapted input.

### PRIORITY PARAGRAPH

The present non-provisional patent application claims priority to and the benefit from (1) U.S. Application 63/767,106 filed on Mar. 5, 2025, and (2) U.S. application Ser. No. 19/202,573 filed on May 8, 2025, which is incorporated herein by reference in their entirety and for all purposes as if completely and fully set forth herein.

### TECHNICAL FIELD

The present disclosure relates to artificial intelligence systems and natural language processing, and more particularly to systems and methods for transforming input data for large language models through offline-trained transformation models that produce runtime optimized inputs in a zero-shot manner without iteratively querying a target large language model, and through inter-model adaptation modules that convert optimized inputs configured for a first large language model into adapted inputs configured for a second large language model different from the first large language model.

### BACKGROUND

Large language models have become foundational components of modern artificial intelligence systems, deployed across a wide range of applications including conversational agents, document processing, code generation, and multi-step autonomous workflows. The effectiveness of a large language model in producing accurate, relevant, and coherent responses is substantially influenced by the quality and structure of the input supplied to the model. Inputs that are verbose, structurally inconsistent with the model's training distribution, or that exceed the model's context window capacity tend to produce degraded responses, increased inference latency, and higher computational cost relative to inputs that are concise and well-structured.

As large language models are increasingly deployed in agentic workflows involving sequential task execution, tool use, and iterative reasoning, the context supplied to the model at each step of the workflow grows substantially. Each completed task contributes outputs, reasoning traces, tool observations, and retrieved documents to the accumulated context, causing the context to expand progressively over the course of a multi-step workflow. This expansion can cause the accumulated context to exceed the context window capacity of the target large language model, require expensive truncation or manual summarization, and introduce attention dilution that degrades the model's ability to focus on task-relevant information.

Existing approaches to input optimization typically require iterative refinement processes in which a candidate optimized input is repeatedly evaluated by querying the target large language model and modifying the input based on the observed response quality. Such iterative approaches introduce significant latency overhead, require repeated access to the target large language model during the optimization process, and cannot be applied in deployment scenarios that require low-latency single-pass transformation. Additionally, an input optimized for one large language model may not perform equivalently when the same input is supplied to a different large language model, due to differences in tokenization schemes, context window sizes, and interpretive characteristics across model families. There exists a need for a system and method that learns a direct mapping from original inputs to optimized inputs during an offline training phase and applies the learned mapping at runtime in a single forward pass without querying the target large language model, while also providing a mechanism for adapting optimized inputs across different large language model families.

### SUMMARY OF THE INVENTION

In an exemplary embodiment, a computer-implemented method is described. The method includes receiving an input. The method further includes applying, by at least one processor, a transformation model to the input in a single forward pass to produce a transformed input. The transformation model has parameters independent of a target language model and is trained on paired training data generated by applying two or more transformation techniques to training inputs and selecting one candidate per training input based on output quality. The method further includes providing the transformed input to the target language model. The transformed input requires fewer computational resources for the target language model to process than the input.

In an aspect, the paired training data is generated by, for each training input, applying, by the at least one processor, each of the two or more transformation techniques to the training input as a distinct computational operation to produce at least one corresponding candidate, and evaluating each candidate against a quality criterion measuring how well the candidate preserves information from the training input and selecting the candidate that satisfies the quality criterion to a greater degree than the remaining candidates.

In an aspect, the quality criterion is a measure of output similarity between an output produced by the target language model in response to the candidate and a reference output produced by the target language model in response to the corresponding training input. The quality criterion is computed by applying the target language model in inference mode.

In an aspect, the two or more transformation techniques comprise at least two of: a paraphrasing technique that rewrites the training input while preserving semantic content, a summarization technique that produces a condensed version of the training input, a key information extraction technique that retains salient information from the training input, a structured reformatting technique that reorganizes the training input into a structured form, and a semantic compression technique that encodes the semantic content of the training input in a shorter representation.

In an aspect, the transformation model is trained using a training objective independent of a training objective of the target language model, and the parameters of the target language model remain unchanged throughout training of the transformation model.

In an aspect, the transformed input has fewer tokens than the input.

In an aspect, the input is one of: natural language text, programming code, structured data in a machine-readable format, and a multimodal input combining two or more of natural language text, image data, and audio data.

In an aspect, the single forward pass comprises the transformation model processing the input through all layers of the transformation model in one forward direction to produce the transformed input, without iterative processing of the input and without querying the target language model during production of the transformed input.

In an aspect, the method further includes applying a trained adaptation model to the transformed input to produce an adapted input. The trained adaptation model has parameters independent of the parameters of the transformation model and of a second target language model. The trained adaptation model is trained to convert outputs of the transformation model into a form accepted by the second target language model. The method further includes providing the adapted input to the second target language model. The second target language model is different from the target language model.

In another exemplary embodiment, a computer-implemented method is described. The method includes receiving an input and a task identifier specifying a task for a target language model. The method further includes applying, by at least one processor, a transformation model to the input and the task identifier in a single forward pass to produce a compressed output having fewer tokens than the input. The transformation model has parameters independent of the target language model and is trained on task-conditioned paired training data generated by applying two or more transformation techniques to training inputs and selecting one candidate per training input based on output quality. The compressed output retains information sufficient for the target language model to complete the task. The method further includes providing the compressed output to the target language model to perform the task. The compressed output requires fewer computational resources for the target language model to process than the input.

In an aspect, the input is a context window from an agentic workflow comprising interaction history from two or more prior agent steps. The compressed output retains portions of the interaction history the transformation model determines to be critical to completing the task and represents, at a reduced level of detail, portions the transformation model determines to be less critical to completing the task.

In an aspect, the transformation model applies a relevance scoring function to each portion of the interaction history. The relevance scoring function is learned from the task-conditioned paired training data and produces a relevance score for each portion with respect to the task. Portions scoring above a learned threshold are retained at full detail and portions scoring below the learned threshold are represented at a reduced level of detail.

In an aspect, the task-conditioned paired training data is generated by, for each training input and each associated task identifier, applying two or more transformation techniques to the training input to produce candidates, and selecting one candidate based on a quality criterion measuring how well the candidate preserves information sufficient for the target language model to complete the task specified by the task identifier.

In an aspect, the method further includes receiving two or more inputs each with a corresponding task identifier, and executing the transformation model concurrently on each input together with its corresponding task identifier in a respective single forward pass to produce a corresponding compressed output conditioned on that task identifier.

In yet another exemplary embodiment, a system is described. The system includes one or more processors and a memory storing instructions that, when executed by the one or more processors, cause the system to receive an input. The instructions further cause the system to apply a transformation model to the input in a single forward pass to produce a transformed input. The transformation model has a first set of parameters independent of each of a plurality of target language models and is trained on paired training data to produce a transformed input from the input. The instructions further cause the system to apply an adaptation model to the transformed input to produce an adapted input for a selected one of the plurality of target language models. The adaptation model has a second set of parameters independent of the first set of parameters and of the selected target language model. The adaptation model is trained to convert outputs of the transformation model into a form accepted by the selected target language model. The instructions further cause the system to provide the adapted input to the selected target language model. The transformation model and the adaptation model together enable the system to process inputs for each of the plurality of target language models using the first set of parameters.

In an aspect, the transformation model is trained on paired training data generated by applying two or more transformation techniques to training inputs and selecting one candidate per training input based on a quality criterion measuring how well the candidate preserves information from the corresponding training input.

In an aspect, the transformation model is trained using a training objective independent of a training objective of each of the plurality of target language models, and the first set of parameters converge to values encoding input-output mappings learned from the paired training data.

In an aspect, the adaptation model is trained on adaptation training data comprising pairs of transformation model outputs and corresponding input representations of the selected target language model, and the first set of parameters of the transformation model remain unchanged during training of the adaptation model.

In an aspect, the instructions further cause the system to receive a task identifier specifying a task. The transformation model produces the transformed input conditioned on the task identifier. The transformed input has fewer tokens than the input and retains information sufficient for the target language model to complete the task.

In an aspect, the instructions further cause the system to select the selected target language model from among the plurality of target language models based on a selection criterion associated with the input, and apply, from among a plurality of adaptation models, the adaptation model corresponding to the selected target language model. Each adaptation model in the plurality corresponds to a respective one of the plurality of target language models and has parameters mapping outputs of the transformation model to the input format accepted by that target language model.

The foregoing general description of the illustrative embodiments and the following detailed description thereof are merely exemplary aspects of the teachings of this disclosure and are not restrictive.

### BRIEF DESCRIPTION OF THE DRAWINGS

A more complete appreciation of this disclosure and many of the attendant advantages thereof will be readily obtained as the same becomes better understood by reference to the following detailed description when considered in connection with the accompanying drawings, wherein:

FIG. 1 illustrates an exemplary system overview of an input transformation system for large language models, according to certain embodiments.

FIG. 2A illustrates an exemplary component architecture for training an input transformation system, according to certain embodiments.

FIG. 2B illustrates an exemplary runtime processing flow for applying a trained transformation model and inter-model adaptation module, according to certain embodiments.

FIG. 3 illustrates an exemplary paired dataset construction process comprising multiple optimization methods and candidate evaluation, according to certain embodiments.

FIG. 4 illustrates an exemplary data flow diagram of the paired dataset constructor, according to certain embodiments.

FIG. 5 illustrates an exemplary contrastive learning training architecture for the inter-model adaptation module, according to certain embodiments.

FIG. 6 illustrates an exemplary transformation model architecture comprising a transformer encoder, a transformer decoder, a hard output head, and a soft embedding output head, according to certain embodiments.

FIG. 7 illustrates an exemplary inter-model adaptation diagram depicting a training phase and a runtime phase, according to certain embodiments.

FIG. 8 illustrates an exemplary model registry and runtime adaptation system depicting resolution of a target specification against a model registry, according to certain embodiments.

FIG. 9 illustrates an exemplary runtime processing flowchart depicting zero-shot transformation and conditional inter-model adaptation, according to certain embodiments.

FIG. 10 illustrates a transformation constraint diagram depicting the relationship between an input and a transformed output produced by the transformation model, according to certain embodiments.

FIG. 11 illustrates an exemplary confidence score threshold flowchart depicting output and fallback decision logic, according to certain embodiments.

FIG. 12 illustrates an exemplary continuous learning pipeline depicting logging, pair generation, dataset expansion, and periodic retraining, according to certain embodiments.

FIG. 13 illustrates an exemplary plan-aware context compression diagram depicting multi-step workflow context optimization, according to certain embodiments.

FIG. 14 illustrates an exemplary deployment configurations diagram depicting cloud, on-premises, and embedded local deployment options, according to certain embodiments.

FIG. 15 illustrates an exemplary cache-assisted runtime optimization flowchart depicting cache lookup and an optional validation loop, according to certain embodiments.

FIG. 16 is a schematic representation of an encoder-decoder architecture.

FIG. 17 shows an overview of an attention mechanism added onto a Recurrent Neural Network (RNN) encoder-decoder architecture.

FIG. 18 is a schematic representation of the calculation of self-attention showing one attention head.

FIG. 19 is a depiction of several attention heads in a Transformer block.

FIG. 20 is an illustration that shows how one can use multiple workers to compute the multi-head attention in parallel, as the respective heads compute their outputs independently of one another.

FIG. 21 is a portrayal of one encoder layer of a Transformer network.

FIG. 22 shows a schematic overview of a Transformer model.

FIG. 23 is a depiction of a Vision Transformer (ViT).

FIG. 24 illustrates a processing flow of the Vision Transformer (ViT).

FIG. 25 shows example software code that implements a Transformer block.

FIG. 26 illustrates an example configuration of a computing device that can be used to implement the systems and techniques described herein.

### DETAILED DESCRIPTION

In the drawings, like reference numerals designate identical or corresponding parts throughout the several views. Further, as used herein, the words “a,” “an” and the like generally carry a meaning of “one or more,” unless stated otherwise.

Furthermore, the terms “approximately,” “approximate,” “about,” and similar terms generally refer to ranges that include the identified value within a margin of 20%, 10%, or preferably 5%, and any values therebetween.

### Indicia of Novelty, Inventiveness, Non-Obviousness, and Subject-Matter Eligibility

Language models are computer programs that read text and generate responses. These programs power chatbots, translation tools, document summarizers, and many other applications used by businesses and individuals every day. When a person or another computer program sends text to a language model, the quality of the response depends heavily on how the input text is written. A clear, well-structured input produces a useful response. A vague or poorly written input produces a poor response. The same language model can give excellent answers or unhelpful answers depending entirely on how the question is asked.

This creates a problem for organizations that use language models. To get good results, someone must carefully craft each input. This process, called prompt engineering, requires skill and takes time. A person writes an input, sends it to the language model, reads the response, rewrites the input, sends it again, and repeats until the response is satisfactory. For a business that sends thousands of inputs to language models every day, this manual approach does not scale. The process becomes even harder when an organization uses multiple different language models, because an input that works well with one model may not work well with another.

Existing solutions try to automate this process, but they all share a common limitation. They require multiple back-and-forth exchanges with the language model to improve each input. One approach uses the language model itself to critique and revise the input through several rounds of refinement. Another approach tries many different versions of the input and picks the best one after testing them all. These methods work, but they are slow and expensive because they require many calls to the language model for every single input. They also do not learn from past improvements. Each new input starts the optimization process from scratch.

The technology disclosed takes a different approach. Instead of optimizing each input through repeated trial and error, the system trains a separate optimization model that learns how to improve inputs. The training works as follows. The system collects many examples of original inputs paired with improved versions of those inputs. The improved versions are created using multiple different methods, such as rule-based editing, machine learning techniques, compression, and summarization. The system tests each improved version by sending it to a language model and measuring whether the response is better than the response to the original input. The best improved versions are kept. This collection of original and improved input pairs becomes the training data.

Once the optimization model is trained, it can improve new inputs directly. When the system receives a new input, the optimization model converts it into an improved input in a single step. The system does not need to query the target language model during this process. The system does not need to try multiple versions and compare results. The optimization model has already learned the patterns that make inputs effective, so it applies those patterns immediately. This direct approach is fast and inexpensive because it requires only one processing operation per input, not dozens of language model calls.

The technology also solves the problem of using multiple language models. Different language models respond differently to the same input because they were built and trained differently. An input optimized for one model may not work well with another. To address this, the system includes a model adapter. The model adapter learns how to convert an improved input designed for one language model into an adapted input that works well with a different language model. The system maintains a model registry that stores information about each supported language model. When the system receives an input along with a target model identifier, it looks up the target model in the registry and applies the appropriate adaptation. This allows organizations to use the same optimization system across all their language models.

The technology also addresses a challenge that arises when language models perform sequences of tasks, such as gathering information, analyzing it, and generating a report. In these workflows, the input to the language model grows over time as context accumulates from previous steps. This context includes outputs from earlier tasks, documents retrieved from databases, reasoning steps the model generated, and results from tools the model used. As the context grows larger, it becomes expensive to process and may exceed the limits of what the language model can handle. Not all of this accumulated context remains relevant as the workflow progresses. Information needed for early tasks may be irrelevant for later tasks.

The system solves this problem through task-based context compression. The system receives a task plan that indicates what tasks remain to be performed. For each piece of accumulated context, the system computes a relevance score that measures how useful that piece of context is for the upcoming tasks. The system keeps context portions with high relevance scores and removes or compresses context portions with low relevance scores. This process reduces the size of the context by at least 30 percent while preserving the information needed for the remaining tasks. The language model receives a smaller, more focused input that contains only what it needs to complete the upcoming work.

The technology produces measurable improvements in how computer systems use language models. The paired training data represents a specific data structure that captures relationships between original inputs and improved inputs created through multiple methods. The optimization model represents a trained machine learning component that applies learned transformations without repeated language model queries. The model adapter represents a trained component that restructures inputs for different target models. The task-based context compression represents a mechanism that reduces computational cost while keeping task-relevant information. These components work together as a complete system for optimizing language model inputs.

The combination of these components provides capabilities that prior approaches do not offer. Prior approaches require multiple language model queries to optimize each input. This system applies a trained optimization model directly in a single step. Prior approaches optimize for one language model and require re-optimization for other models. This system adapts optimized inputs across different language models through a trained model adapter. Prior approaches compress context without considering what tasks remain. This system compresses context based on relevance to upcoming tasks indicated in a task plan. These capabilities enable organizations to optimize language model inputs at scale, across multiple models, and throughout multi-step workflows, all without the repeated trial and error that prior approaches require.

### Input Optimization and Adaptation System Architecture

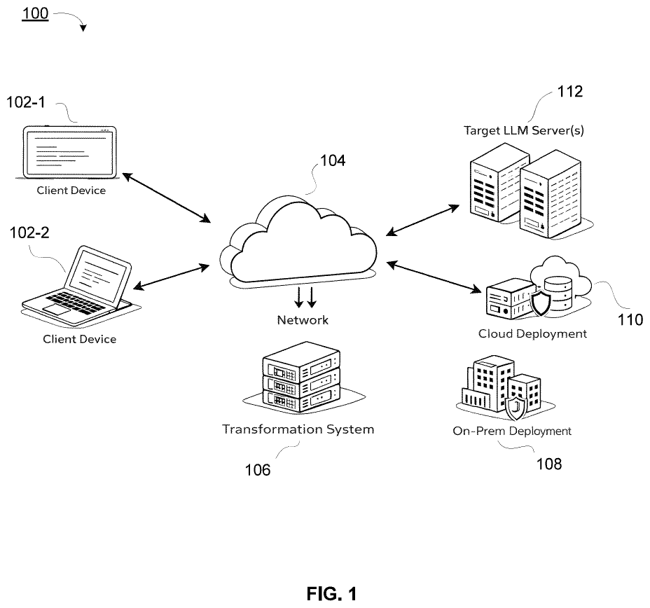

FIG. 1 illustrates an input optimization and adaptation system 100. The input optimization and adaptation system, also referred to as the system 100, is configured to optimize input data for language models and to adapt optimized inputs across different target language models. The system 100 implements a distributed architecture in which client devices submit inputs to a transformation system, and the transformation system produces improved or adapted inputs for use by target language model servers. The system 100 supports multiple deployment configurations including cloud-based deployment, on-premises deployment, and hybrid deployment combining cloud and on-premises components.

The system 100 comprises one or more client devices. FIG. 1 depicts a first client device 102-1 and a second client device 102-2, combinedly referred to a client device 102, as representative examples. The client devices 102 are computing devices configured to generate inputs for language models and to receive improved or adapted inputs from the transformation system. A client device 102 may be implemented as a desktop computer, a laptop computer, a tablet computer, a smartphone, a server system, an embedded computing device, or any other computing device capable of network communication. Each client device 102 includes one or more processors, memory storing instructions executable by the one or more processors, storage for data persistence, and a network interface for communication over the network 104. In various implementations, the client devices 102 execute applications that invoke language model services, including chatbot applications, document processing applications, code generation tools, data analysis pipelines, and automated workflow systems.

The system 100 includes a network 104 that interconnects the client devices 102, the transformation system 106, and the target language model servers 112. The network 104 provides communication pathways through which the components of the system 100 exchange data. The network 104 may be implemented as a local area network, a wide area network, the Internet, a private network, a virtual private network, or any combination of network types. In some implementations, the network 104 includes wired connections such as Ethernet links and fiber optic links. In other implementations, the network 104 includes wireless connections such as Wi-Fi links and cellular connections. The network 104 supports standard network protocols including Transmission Control Protocol/Internet Protocol (TCP/IP), Hypertext Transfer Protocol (HTTP), Hypertext Transfer Protocol Secure (HTTPS), and application programming interface (API) communication protocols.

The system 100 comprises a transformation system 106 connected to the network 104. The transformation system 106 is configured to receive inputs from the client devices 102, apply trained optimization models to produce improved inputs, and conditionally apply model adapters to produce adapted inputs for different target language models. The transformation system 106 includes one or more processors configured to execute the optimization models and model adapters. The transformation system 106 includes memory storing the trained optimization models, the trained model adapters, and program instructions executable by the one or more processors. The transformation system 106 includes storage for maintaining a model registry that stores information about supported target language models. The transformation system 106 includes a network interface for receiving inputs from the client devices 102 and for transmitting improved or adapted inputs to the target language model servers 112.

The transformation system 106 implements the optimization model and the model adapter described in connection with the method embodiments. The optimization model is a trained machine learning model that converts original inputs into improved inputs. The optimization model is separate from the target language models and applies learned transformations directly without querying the target language models during the optimization process. The model adapter is a trained component that converts improved inputs configured for a first language model into adapted inputs configured for a second language model. The transformation system 106 receives, along with each input, a target model identifier that specifies which target language model the input is intended for. When the target language model differs from the first language model for which the optimization model was trained, the transformation system 106 applies the model adapter to restructure the improved input for the specified target language model.

The system 100 comprises one or more target language model servers 112 connected to the network 104. The target language model servers 112 host the language models that process the improved or adapted inputs and generate responses. A target language model server 112 may host a single language model or may host multiple language models accessible through different API endpoints. The target language model servers 112 may be operated by the same entity that operates the transformation system 106, or the target language model servers 112 may be operated by third-party language model providers accessed through public APIs. The target language model servers 112 include processors configured to execute language model inference, memory for storing model parameters, and network interfaces for receiving inputs and returning responses. The improved or adapted inputs produced by the transformation system 106 are transmitted to the target language model servers 112, which process the inputs and return responses to the client devices 102 or to the transformation system 106 for relay to the client devices 102.

The system 100 supports an on-premises deployment configuration represented by on-prem deployment 108. In the on-premises deployment configuration, the transformation system 106 is deployed within an organization's private data center or computing facility. The on-prem deployment 108 includes physical servers, storage systems, and network infrastructure owned or controlled by the organization. The on-premises deployment configuration provides benefits including data locality, reduced network latency between the transformation system 106 and internal client devices 102, compliance with data residency requirements, and direct integration with existing enterprise systems. In the on-premises deployment configuration, the transformation system 106 may communicate with target language model servers 112 that are also deployed on-premises, or the transformation system 106 may communicate with external target language model servers 112 through the network 104.

The system 100 supports a cloud deployment configuration represented by cloud deployment 110. In the cloud deployment configuration, the transformation system 106 is deployed on cloud computing infrastructure provided by a cloud service provider. The cloud deployment 110 includes virtual machines, container instances, serverless functions, managed storage services, and virtual network resources provisioned from the cloud service provider. The cloud service provider may include Amazon Web Services, Microsoft Azure, Google Cloud Platform, or other cloud computing platforms. The cloud deployment configuration provides benefits including elastic scaling to handle variable workloads, reduced capital expenditure for infrastructure, geographic distribution across multiple regions, and managed services for monitoring and maintenance. In the cloud deployment configuration, the transformation system 106 may be deployed as a software-as-a-service (SaaS) application accessible by client devices 102 through the network 104.

The system 100 also supports hybrid deployment configurations that combine elements of the on-prem deployment 108 and the cloud deployment 110. In a hybrid deployment, certain components of the transformation system 106 may be deployed on-premises while other components are deployed in the cloud. For example, an organization may deploy the optimization model on-premises for low-latency processing of inputs while using cloud-deployed model adapters for adaptation to cloud-hosted target language models. The system 100 exposes an application programming interface (API) that client devices 102 invoke to submit inputs for optimization and adaptation. The API accepts a single request containing the input, the target model identifier, and optionally a task plan for task-based context compression. The API returns the improved or adapted input for use by the specified target language model.

The components of the system 100, including the client devices 102, the transformation system 106, and the target language model servers 112, each include computing hardware and software necessary for their respective functions. Each component includes one or more processors that may be implemented as central processing units (CPUs), graphics processing units (GPUs), tensor processing units (TPUs), field-programmable gate arrays (FPGAs), application-specific integrated circuits (ASICs), or combinations thereof. Each component includes non-transitory computer-readable memory that stores program instructions and data. The memory may include random access memory (RAM), read-only memory (ROM), flash memory, solid-state drives, hard disk drives, or other storage media. Each component includes network interface hardware and software that enables communication over the network 104 using wired or wireless connections. The system 100 operates through the coordinated execution of program instructions stored in the memory of each component and executed by the processors of each component.

### Architecture for Training an Input Transformation System

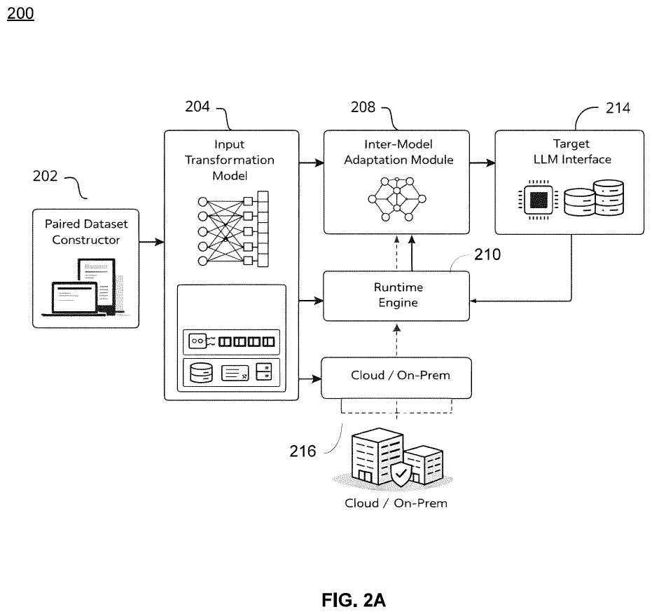

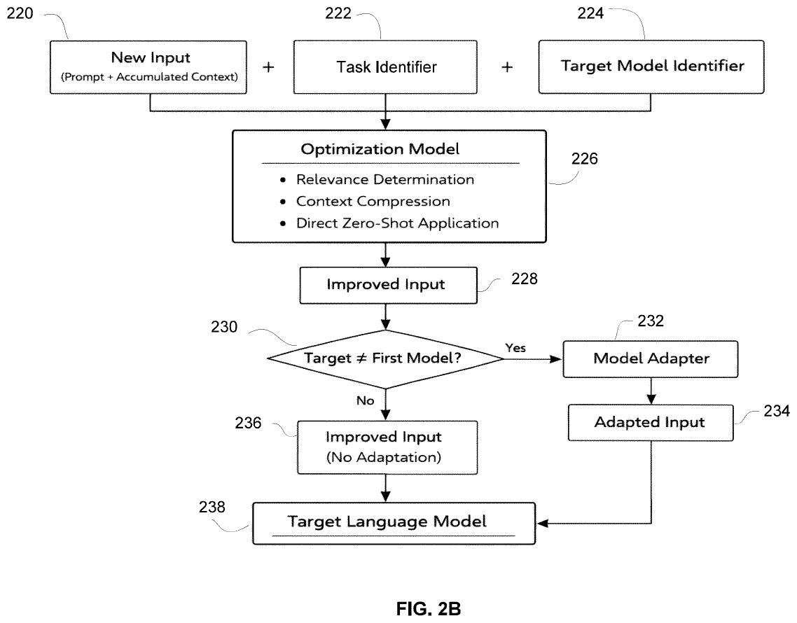

FIG. 2A illustrates a component architecture 200 for training an input transformation system for large language models. The component architecture 200 is configured to train a transformation model and an inter-model adaptation module as separate computational components, wherein each component is trained independently from any target large language model. The component architecture 200 implements an offline training phase that generates trained model artifacts capable of performing zero-shot input optimization at runtime. The component architecture 200 may be deployed within cloud computing environments, on-premises data centers, or hybrid infrastructure configurations depending on computational requirements and data governance policies.

The component architecture 200 addresses a fundamental limitation in existing prompt optimization approaches, wherein conventional systems require iterative refinement processes that repeatedly query a target large language model to evaluate candidate optimizations. The component architecture 200 overcomes this limitation by learning a direct mapping from original inputs to optimized inputs during an offline training phase, thereby enabling single-pass transformation at runtime without requiring access to the target large language model during the transformation process. The learned mapping captures patterns of effective input optimization across diverse task types and input structures, allowing the transformation model to generalize to previously unseen inputs.

The component architecture 200 comprises a paired dataset constructor 202 configured to construct a paired dataset comprising pairs of original inputs and corresponding transformed inputs. The paired dataset constructor 202 generates the paired dataset by applying multiple optimization methods to original inputs and evaluating resulting candidate optimized inputs to select high-quality pairs for inclusion in the training dataset. The paired dataset constructor 202 operates as a data generation pipeline that transforms raw input corpora into structured training examples suitable for supervised learning.

The paired dataset constructor 202 generates candidate optimized inputs using at least two different optimization methods. The use of multiple optimization methods captures diverse optimization strategies and produces training data that reflects various approaches to input improvement. In one embodiment, the paired dataset constructor 202 employs heuristic editing methods that apply rule-based transformations to input text, including sentence restructuring, redundancy removal, instruction clarification, and formatting standardization. The heuristic editing methods may utilize predefined transformation rules derived from linguistic analysis of effective prompts, wherein common patterns of effective prompt structure are encoded as transformation heuristics. For example, a heuristic editing method may restructure a verbose user query into a concise instruction format by identifying and removing filler phrases, consolidating repeated concepts, and reordering clauses to place the primary instruction at the beginning of the prompt.

In another embodiment, the paired dataset constructor 202 employs reinforcement learning-based optimization methods that train a policy network to generate optimized inputs that maximize expected response quality from a language model. The reinforcement learning-based optimization methods formulate input optimization as a sequential decision-making problem, wherein actions correspond to token-level or phrase-level modifications to the input and rewards are derived from evaluation of responses produced by the language model. The policy network learns to predict modification actions that are likely to improve response quality based on features extracted from the current input state. The reinforcement learning framework may employ policy gradient methods such as proximal policy optimization (PPO) or advantage actor-critic (A2C) algorithms to train the policy network. In a specific implementation, the policy network receives an input prompt embedding as state information, predicts a distribution over available modification actions, samples an action to apply, and receives a reward signal based on response quality metrics computed after the language model processes the modified input.

In a further embodiment, the paired dataset constructor 202 employs search-based optimization methods that explore a space of possible input modifications to identify high-quality optimized inputs. The search-based optimization methods may include genetic algorithms that evolve populations of candidate inputs through selection, crossover, and mutation operations. In genetic algorithm implementations, each candidate input is represented as a chromosome encoding its token sequence or phrase structure, fitness is evaluated based on response quality from the language model, and genetic operators produce new candidate inputs by recombining and perturbing existing candidates. The search-based optimization methods may alternatively include beam search techniques that maintain a set of promising partial optimizations and expand each partial optimization by considering multiple possible next modifications. The beam search techniques prune low-scoring candidates at each expansion step to focus computational resources on the most promising optimization trajectories.

In yet another embodiment, the paired dataset constructor 202 employs soft prompt tuning methods that optimize continuous embedding vectors prepended to input sequences. Unlike discrete token optimization, soft prompt tuning operates in continuous embedding space and may use gradient-based optimization to find embedding vectors that improve response quality. The soft prompt tuning methods may utilize prefix tuning approaches that optimize a small number of virtual tokens while keeping the language model parameters frozen. The learned soft prompts may be converted to discrete tokens through nearest-neighbor lookup in the embedding space or through greedy decoding methods, thereby producing discrete optimized inputs suitable for inclusion in the paired dataset.

In still another embodiment, the paired dataset constructor 202 employs extractive compression methods that identify and retain salient portions of the input while removing less relevant content. The extractive compression methods may use attention-based saliency detection to score each sentence or phrase based on its contribution to the overall semantic content of the input. High-scoring portions are retained verbatim while low-scoring portions are removed, producing a compressed input that preserves essential information in a reduced token count. The extractive compression methods are particularly applicable to inputs containing contextual data accumulated during multi-step workflows, wherein significant portions of the accumulated context may be irrelevant to upcoming tasks.

In an additional embodiment, the paired dataset constructor 202 employs abstractive summarization methods that generate condensed paraphrases of input content. Unlike extractive compression, abstractive summarization produces new text that may not appear verbatim in the original input but captures the essential semantic content in a more concise form. The abstractive summarization methods may utilize encoder-decoder neural network architectures trained on summarization corpora to generate fluent condensed representations. The abstractive summarization methods enable more aggressive compression ratios than extractive methods while maintaining semantic fidelity through generation of novel phrasing.

In a yet additional embodiment, the paired dataset constructor 202 employs cost-aware refinement methods that optimize inputs to reduce computational cost while maintaining response quality. The cost-aware refinement methods consider metrics such as token count, inference latency, and API cost when evaluating candidate optimized inputs. A candidate that achieves equivalent response quality with fewer tokens is preferred over a candidate with higher token count, enabling optimization for deployment scenarios where inference cost is a significant operational consideration.

The paired dataset constructor 202 evaluates candidate optimized inputs based on responses produced by at least one large language model. The evaluation process invokes the large language model with each candidate optimized input and analyzes the resulting response to compute quality metrics. In one embodiment, the evaluation comprises computing a response quality metric measuring accuracy, relevance, or coherence of the response. The response quality metric may be computed using automated evaluation methods such as BLEU, ROUGE, or BERTScore that compare generated responses against reference responses. The response quality metric may alternatively be computed using learned evaluation models trained to predict human quality judgments based on response features. In another embodiment, the evaluation comprises computing a computational cost metric measuring token usage, latency, or inference cost associated with processing the candidate optimized input. The computational cost metric enables selection of candidates that achieve favorable quality-cost tradeoffs. In a further embodiment, the evaluation comprises computing a semantic equivalence metric measuring similarity between responses produced using the original input and responses produced using the candidate optimized input. The semantic equivalence metric verifies that optimization preserves the semantic intent of the original input and does not introduce distortions that alter the expected response behavior.

The paired dataset constructor 202 selects, based on the evaluation, a candidate optimized input that improves response quality or reduces computational cost relative to the original input. The selection process may apply threshold-based filtering to retain only candidates that meet minimum quality criteria, followed by ranking to identify the best candidate among those that pass the threshold. The original input and the selected candidate optimized input form a pair in the paired dataset. Repetition of this process across a large corpus of original inputs produces a paired dataset suitable for training the transformation model.

The original inputs in the paired dataset each comprise a prompt component and a contextual data component in embodiments where the transformation system is applied to multi-step workflow scenarios. The prompt component contains the user query, instruction, or task specification that defines what the language model should accomplish. The contextual data component contains information accumulated during prior execution steps that provides relevant background for the current task. The contextual data component comprises at least one of outputs from prior task executions, memory elements, retrieved documents, reasoning traces, tool observations, or environment state data.

Outputs from prior task executions comprise results generated by the language model during earlier steps in a multi-step workflow. For example, in a research workflow that involves initial information gathering followed by synthesis and report generation, outputs from the information gathering step constitute prior task outputs that inform subsequent synthesis steps. Memory elements comprise information stored by an agent system for later retrieval, including key-value stores, episodic memories, or working memory buffers that maintain state across interactions. Retrieved documents comprise content fetched from external knowledge sources such as document databases, search engines, or retrieval-augmented generation (RAG) pipelines. Reasoning traces comprise intermediate reasoning steps generated by the language model during chain-of-thought or stepwise reasoning processes. Tool observations comprise results returned by external tools invoked by the language model agent, including API responses, computation results, or sensor readings. Environment state data comprises information about the current state of an external environment with which the agent interacts, including system status indicators, user interface states, or physical world observations in embodied agent scenarios.

Flowing from the paired dataset constructor 202, the component architecture 200 comprises a transformation model 204, also referred to as an input transformation model 204. The transformation model 204 is trained on the paired dataset to learn a mapping from original inputs to transformed inputs. The transformation model 204 does not share parameters with and is not trained using gradients from any target language model. The separation of the transformation model 204 from any target language model means that during training of the transformation model 204, no gradient signals propagate from any target language model to update parameters of the transformation model 204, and the transformation model 204 maintains its own set of learned parameters that are entirely independent from the parameters of any target language model. This architectural separation enables the transformation model 204 to be trained once and deployed to transform inputs for multiple different target language models without modification to the transformation model 204 itself. This separation enables the transformation model 204 to be trained once and deployed to optimize inputs for multiple different target large language models without modification.

The transformation model 204 comprises an encoder-decoder architecture in one embodiment. The encoder-decoder architecture includes an encoder component that processes the original input to produce a latent representation and a decoder component that generates the optimized input conditioned on the latent representation. The encoder component may be implemented using transformer encoder layers that apply self-attention mechanisms to capture contextual relationships among tokens in the original input. The self-attention mechanism computes attention scores between all pairs of tokens, allowing each token's representation to incorporate information from all other tokens in the input. The encoder processes the original input token sequence to produce a sequence of contextualized token embeddings that capture the semantic content and structure of the input.

The decoder component generates the optimized input token by token, conditioned on the encoder output and previously generated tokens. The decoder may be implemented using transformer decoder layers that apply masked self-attention to attend to previously generated tokens and cross-attention to attend to encoder output representations. At each decoding step, the decoder predicts a probability distribution over the vocabulary and samples or greedily selects the next token. Decoding continues until an end-of-sequence token is generated or a maximum length is reached.

In another embodiment, the transformation model 204 comprises a recurrent neural network (RNN) architecture using long short-term memory (LSTM) or gated recurrent unit (GRU) cells. The RNN encoder processes the input sequence one token at a time, maintaining a hidden state that accumulates information about the input. The final encoder hidden state is passed to the decoder as an initial state, and the decoder generates the optimized output sequence one token at a time. The RNN architecture may include attention mechanisms that allow the decoder to dynamically attend to different portions of the encoder output at each decoding step, addressing the information bottleneck that arises when compressing all input information into a fixed-size hidden state vector.

In a further embodiment, the transformation model 204 comprises a hybrid architecture combining convolutional and recurrent components. Convolutional layers may be applied to extract local features and patterns from the input sequence, producing feature maps that capture n-gram patterns and phrase structures. Recurrent or transformer layers then process the convolutional features to capture long-range dependencies and produce the final encoded representation. The hybrid architecture leverages the complementary strengths of convolutional processing for local pattern detection and recurrent or attention-based processing for global context integration.

Training the transformation model 204 comprises minimizing a loss function that encourages the model to generate outputs matching the target optimized inputs from the paired dataset while preserving semantic content of the original inputs. The loss function comprises a reconstruction loss measuring fidelity between a generated output and the target optimized input from the paired dataset. The reconstruction loss may be implemented as cross-entropy loss computed over the token probability distributions predicted by the decoder, where the target tokens are drawn from the paired optimized input. Minimizing the reconstruction loss trains the transformation model 204 to accurately reproduce the optimized inputs in the training dataset.

The loss function further comprises a semantic preservation loss measuring semantic similarity between the original input and the generated output. The semantic preservation loss encourages the transformation model 204 to generate outputs that preserve the semantic meaning of the original input, even when the surface form is substantially modified. The semantic preservation loss may be computed using cosine similarity between embedding vectors of the original input and the generated output, where embeddings are produced by a pretrained sentence encoder. The semantic preservation loss may alternatively be computed using a learned semantic similarity model that predicts similarity scores based on input-output pairs.

The transformation model 204 is trained using backpropagation-based gradient update techniques. Example gradient descent techniques that may be used for training the transformation model 204 include stochastic gradient descent (SGD), batch gradient descent, and mini-batch gradient descent. Optimization algorithms that may be used include Momentum, Adam, AdaMax, Nadam, RMSprop, Adagrad, and Adadelta. Regularization techniques such as dropout, weight decay, and data augmentation may be applied to prevent overfitting and improve generalization. The training process may employ learning rate scheduling to adjust the learning rate during training, including warm-up periods with gradually increasing learning rates followed by decay schedules that reduce the learning rate as training progresses.

The component architecture 200 further comprises an input transformation model 204 representing an alternative or supplementary embodiment of the transformation model. The input transformation model 204 illustrates embedding-based representations used within the transformation architecture. In this representation, inputs are converted to continuous embedding vectors that capture semantic content in a dense numerical format. The embedding representations enable similarity computations, interpolation in embedding space, and application of neural network operations to the input content.

Flowing from the transformation models, the component architecture 200 comprises an inter-model adaptation module 208 configured to convert an optimized input configured for a first large language model into an adapted input configured for a second large language model different from the first large language model. The inter-model adaptation module 208 addresses the challenge that different large language models may respond differently to the same input due to differences in training data, model architecture, and learned behaviors. An input optimized for one large language model may not produce optimal results when used with a different large language model.

Training the inter-model adaptation module 208 comprises applying contrastive learning on input-response pairs collected from a plurality of different large language models. The contrastive learning objective causes the inter-model adaptation module 208 to learn a shared embedding space in which semantically equivalent inputs for different large language models are mapped to nearby positions. Inputs that produce similar responses across different large language models are considered semantically equivalent and should be embedded close together, while inputs that produce dissimilar responses should be embedded far apart.

The contrastive learning process collects input-response pairs by invoking multiple different large language models with the same or equivalent inputs and recording the resulting responses. For each input, response pairs from different large language models are compared to determine semantic equivalence. The inter-model adaptation module 208 is trained to produce embeddings that reflect this equivalence structure, learning to identify when inputs for different models are semantically equivalent despite potential differences in surface form.

The inter-model adaptation module 208 is configured to restructure the optimized input to account for differences between large language models. In one embodiment, the inter-model adaptation module 208 accounts for differences in tokenization schemes between the first large language model and the target large language model. Different large language models may use different tokenization algorithms such as byte-pair encoding (BPE), WordPiece, or SentencePiece with different vocabularies, resulting in different token sequences for the same text. The inter-model adaptation module 208 may restructure the input to align with the target model's expected token patterns.

In another embodiment, the inter-model adaptation module 208 accounts for differences in context window sizes between the first large language model and the target large language model. A large language model with a larger context window may accept longer inputs, while a model with a smaller context window may require additional compression or truncation. The inter-model adaptation module 208 may adjust input length and structure to fit within the target model's context window constraints.

In a further embodiment, the inter-model adaptation module 208 accounts for differences in interpretive characteristics between the first large language model and the target large language model. Different large language models may exhibit different sensitivities to instruction phrasing, different default response styles, or different handling of ambiguous queries. The inter-model adaptation module 208 may rephrase instructions or add clarifying context to align with the target model's interpretive patterns.

The component architecture 200 further comprises a runtime engine 210 and a runtime engine 212 representing computational environments for executing the trained models. The runtime engines 210 and 212 provide the execution infrastructure for applying the transformation model 204 and the inter-model adaptation module 208 to runtime inputs. The runtime engines may be implemented using model serving frameworks such as TensorFlow Serving, TorchServe, or NVIDIA Triton that provide optimized inference execution with batching, caching, and resource management capabilities.

The component architecture 200 further comprises a target LLM interface 214 configured to communicate with target large language models. The target LLM interface 214 provides abstraction over different large language model APIs, enabling the system to interact with various large language models through a unified interface. The target LLM interface 214 may support both cloud-based large language model services accessed through REST APIs and locally deployed models accessed through local inference frameworks.

The component architecture 200 may be deployed in cloud or on-premises environments as indicated by component 216. Cloud deployment enables elastic scaling of computational resources to handle variable workloads and provides access to managed infrastructure services. On-premises deployment provides data sovereignty and may be required for applications with strict data governance requirements. Hybrid deployment configurations may combine cloud and on-premises resources to balance scalability with data control requirements.

### Runtime Processing Flow

FIG. 2B illustrates a runtime processing flow 200B for applying a transformation model to transform inputs at runtime to produce a transformed input requiring fewer computational resources for a target language model to process than the input. The runtime processing flow 200B receives an input and produces a transformed input or an adapted input suitable for invocation of a target language model 238. The runtime processing flow 200B implements a zero-shot transformation capability enabled by the offline training described with reference to FIG. 2A, wherein the transformation model and an adaptation model are applied to new inputs without requiring retraining or iterative refinement. The term “zero-shot” as used herein refers to a descriptive characterization of the single forward pass behavior of the transformation model, wherein the transformation model processes an input and produces a transformed input in a single forward pass without requiring task-specific examples, iterative refinement, or access to the target language model 238 during inference, and does not introduce a separate limitation beyond the single forward pass. Unlike iterative prompt optimization approaches that repeatedly query a target language model to evaluate and refine candidate outputs over multiple iterations, the transformation model of the present disclosure generates the transformed input in one forward pass without querying the target language model 238 during production of the transformed input.

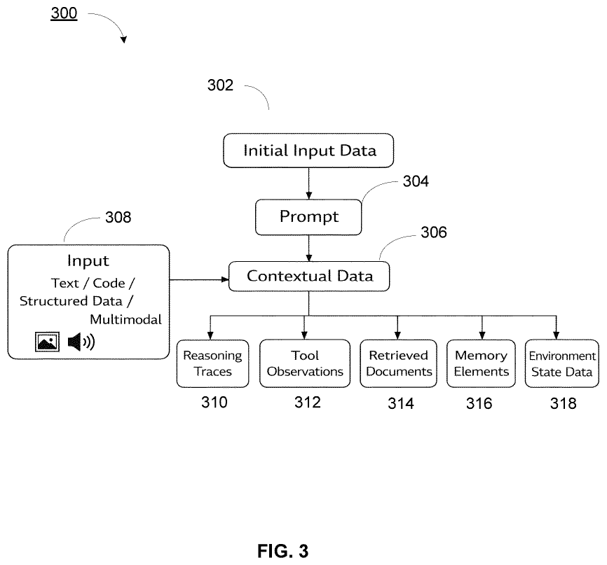

The runtime processing flow 200B begins with receipt of a new input 220 comprising a prompt and accumulated context. The new input 220 represents the complete input to be transformed before invocation of the target language model 238. The prompt portion of the new input 220 contains the user instruction, query, or task specification that defines the requested operation. The accumulated context portion of the new input 220 contains information gathered during prior steps in a multi-step workflow that provides relevant background for the current task. The new input 220 may comprise one of: natural language text, programming code, structured data in a machine-readable format, or a multimodal input combining two or more of natural language text, image data, and audio data, as described with reference to FIG. 3. In one embodiment, the new input 220 is a context window from an agentic workflow comprising interaction history from two or more prior agent steps. The interaction history accumulated during the agentic workflow may include reasoning traces, tool observations, retrieved documents, memory elements, and environment state data, as described with reference to FIG. 3. In multi-step workflow scenarios, the accumulated context may grow substantially as the workflow progresses, accumulating information from each completed step. Without transformation, the accumulated context may exceed context window limits of the target language model 238 or cause attention dilution that degrades response quality. The runtime processing flow 200B addresses the growing context challenge by compressing the accumulated context while preserving information relevant to the task specified by a task identifier 222.

The runtime processing flow 200B further receives a task identifier 222 specifying a task for the target language model 238. The task identifier 222 identifies a task that the target language model 238 is expected to perform using the transformed input. The task identifier 222 enables task-aware transformation by identifying what information from the accumulated context in the new input 220 is likely to be relevant to the specified task. Context that is irrelevant to the task specified by the task identifier 222 may be compressed or removed more aggressively, while context that is highly relevant to the specified task is preserved with higher fidelity. In one embodiment, the task identifier 222 comprises a natural language description of the task, such as “summarize the findings” or “generate recommendations based on the analysis.” In another embodiment, the task identifier 222 comprises a structured task specification including a task type identifier, an expected input schema, an expected output schema, and dependency relationships among tasks. In a further embodiment, the task identifier 222 is dynamically generated by a planning component that analyzes an overall workflow objective and determines a sequence of tasks required to achieve the objective. The task identifier 222 may further indicate one or more upcoming tasks in a sequence of tasks, enabling the transformation model to condition the transformation on future task requirements in addition to the immediate task.

The runtime processing flow 200B further receives a target model identifier 224 identifying the target language model 238 for which the input is being transformed. The target model identifier 224 enables the runtime processing flow 200B to determine whether inter-model adaptation is required and to select appropriate adaptation parameters if adaptation is required. The target model identifier 224 comprises at least one of an identifier of the target language model 238, a model architecture descriptor of the target language model 238, a model capability profile of the target language model 238, or an application programming interface endpoint specification for invoking the target language model 238. The identifier may comprise a model name or version string. The model architecture descriptor may comprise information about the architecture type, parameter count, or training approach of the target language model 238. The model capability profile may comprise information about the strengths, weaknesses, or specializations of the target language model 238 relevant to input transformation. The application programming interface endpoint specification comprises the network address and protocol information required to invoke the target language model 238.

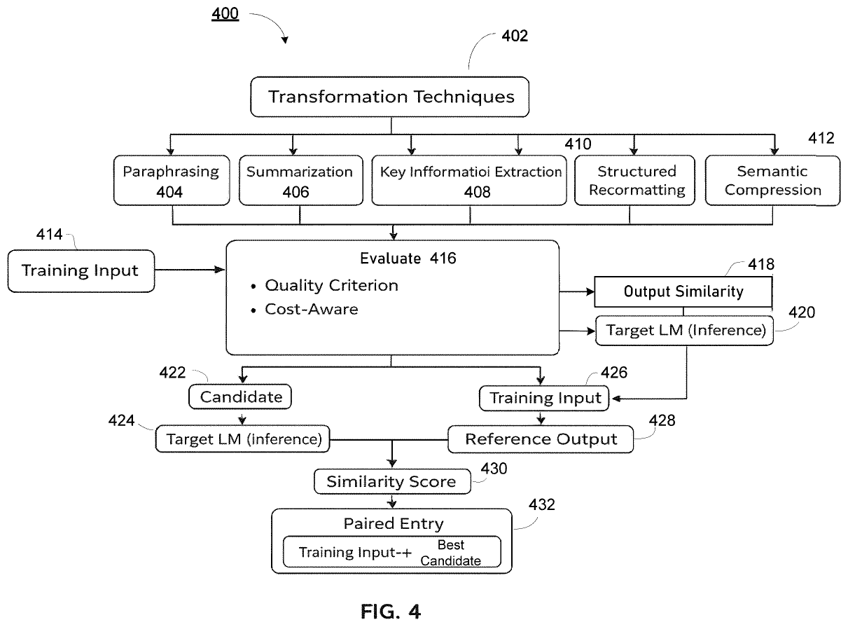

The runtime processing flow 200B applies a transformation model 226, also labeled as the optimization model in FIG. 2B, to the new input 220 and the task identifier 222 in a single forward pass to produce a transformed input 228, also labeled as the improved input in FIG. 2B. The transformation model 226 has parameters independent of the target language model 238 and is trained on paired training data generated by applying two or more transformation techniques to training inputs and selecting one candidate per training input based on output quality, as described with reference to FIG. 4. The transformation model 226 is trained using a training objective independent of a training objective of the target language model 238, and the parameters of the target language model 238 remain unchanged throughout training of the transformation model 226. The parameters of the transformation model 226 converge to values encoding input-output mappings learned from the paired training data. Because the transformation model 226 does not share parameters with and is not trained using gradients from any target language model, the transformation model 226 operates independently at runtime and does not require invocation of, communication with, or access to the target language model 238 to produce the transformed input 228. In embodiments where the runtime processing flow 200B receives the task identifier 222, the transformation model 226 is trained on task-conditioned paired training data generated by applying the two or more transformation techniques to training inputs and selecting one candidate per training input based on output quality, wherein the task-conditioned paired training data associates each training input with a corresponding task identifier. The transformation model 226 produces the transformed input 228 conditioned on the task identifier 222, wherein the transformed input 228 has fewer tokens than the new input 220 and retains information sufficient for the target language model 238 to complete the task specified by the task identifier 222. The single forward pass comprises the transformation model 226 processing the new input 220 through all layers of the transformation model 226 in one forward direction to produce the transformed input 228, without iterative processing of the new input 220 and without querying the target language model 238 during production of the transformed input 228.

The transformation model 226 implements three primary functions as depicted in FIG. 2B: relevance determination, context compression, and direct zero-shot application. The three functions operate in concert within the single forward pass to produce the transformed input 228 from the new input 220 and the task identifier 222.

The relevance determination function of the transformation model 226 determines which portions of the context data in the new input 220 are relevant to the task specified by the task identifier 222. The transformation model 226 applies a relevance scoring function to each portion of the interaction history in the new input 220. The relevance scoring function is learned from the task-conditioned paired training data and produces a relevance score for each portion with respect to the task specified by the task identifier 222. The relevance scoring function may be implemented using embedding-based similarity computation, wherein both the context portion and the task description are encoded as embedding vectors and similarity is computed as cosine distance between the vectors. The relevance scoring function may alternatively be implemented using a trained scoring model that directly predicts relevance scores from context-task pairs. The relevance determination function retains portions of the interaction history scoring above a learned threshold at full detail, wherein the learned threshold is learned from the task-conditioned paired training data. Portions of the interaction history scoring below the learned threshold are represented at a reduced level of detail. The learned threshold may be a fixed value determined during training of the transformation model 226 on the task-conditioned paired training data, or a dynamic value adjusted based on available context window capacity and the total volume of context data. When context volume is high relative to available capacity, the learned threshold may be raised to achieve more aggressive compression. When context volume is low, the learned threshold may be lowered to preserve more information. The transformation model 226 thereby retains portions of the interaction history that the transformation model 226 determines to be critical to completing the task and represents, at a reduced level of detail, portions that the transformation model 226 determines to be less critical to completing the task.

The context compression function of the transformation model 226 compresses the context data in the new input 220 based on relevance to the task specified by the task identifier 222. The context compression function produces a compressed representation of the context that reduces token count while preserving information necessary for the target language model 238 to produce high-quality responses to the specified task. In one embodiment, the context compression function achieves compression by removing low-relevance portions entirely. In another embodiment, the context compression function achieves compression by summarizing low-relevance portions into condensed representations that preserve key information in fewer tokens. In a further embodiment, the context compression function achieves compression by merging redundant information across multiple context portions into a single consolidated representation. The context compression function reduces a size of the context data by at least 30 percent while preserving information relevant to the task specified by the task identifier 222. In practice, compression ratios may vary based on the nature of the context data and the specificity of the task, with higher compression ratios achievable when the context contains significant redundancy or low-relevance content.

The direct zero-shot application function of the transformation model 226 applies the transformation model 226 to the new input 220 and the task identifier 222 to produce the transformed input 228 in a single forward pass without iteratively processing the new input 220. The direct zero-shot application function produces the transformed input 228 in one application without requiring multiple rounds of generation and evaluation. The transformation model 226 does not query the target language model 238 during the transformation process, maintaining separation between the transformation model 226 and the target language model 238.

The transformed input 228, also labeled as the improved input in FIG. 2B, is the output of the single forward pass of the transformation model 226. The transformed input 228 has a reduced token count relative to the new input 220 while preserving semantic content sufficient to produce an equivalent response from the target language model 238. The transformed input 228 retains information from the context data in the new input 220 that is sufficient for the target language model 238 to complete the task specified by the task identifier 222. The transformed input 228 requires fewer computational resources for the target language model 238 to process than the new input 220, because the reduced token count of the transformed input 228 decreases the computational cost of inference by the target language model 238.

In embodiments where the runtime processing flow 200B receives the new input 220 without the task identifier 222, the runtime processing flow 200B applies the transformation model 226 to the new input 220 in a single forward pass to produce the transformed input 228 based on the paired training data described with reference to FIG. 4, without conditioning the transformation on a task. The transformed input 228 in the embodiment without the task identifier 222 requires fewer computational resources for the target language model 238 to process than the new input 220.

The runtime processing flow 200B may further receive two or more inputs each with a corresponding task identifier. In the embodiment with two or more inputs, the runtime processing flow 200B executes the transformation model 226 concurrently on each input together with the corresponding task identifier in a respective single forward pass to produce a corresponding compressed output conditioned on that task identifier. The concurrent execution enables parallel processing of multiple inputs, reducing the total time required to transform a batch of inputs for the target language model 238.

The runtime processing flow 200B includes a decision 230 that determines whether a first language model for which the transformation model 226 was trained is different from the target language model 238 identified by the target model identifier 224. The decision 230 is depicted in FIG. 2B as the diamond labeled “Target First Model?” and evaluates whether inter-model adaptation is required based on the target model identifier 224. When the decision 230 determines that the target language model 238 is different from the first language model, the runtime processing flow 200B proceeds to apply an adaptation model 232, also labeled as the model adapter in FIG. 2B. When the decision 230 determines that the target language model 238 is the same as the first language model, the runtime processing flow 200B proceeds to output the transformed input 228 directly without adaptation as described below.

When the decision 230 determines that the target language model 238 is different from the first language model, the target language model 238 is herein referred to as a second target language model 238, wherein the second target language model 238 is different from the first language model for which the transformation model 226 was trained. The runtime processing flow 200B applies the adaptation model 232 to the transformed input 228 to produce an adapted input 234. The adaptation model 232 has a second set of parameters independent of the first set of parameters of the transformation model 226 and independent of the second target language model 238. The adaptation model 232 is trained to convert outputs of the transformation model 226 into a form accepted by the second target language model 238. The adaptation model 232 is trained on adaptation training data comprising pairs of transformation model outputs and corresponding input representations of the second target language model 238, and the first set of parameters of the transformation model 226 remain unchanged during training of the adaptation model 232. The resulting adapted input 234 is configured for the specific characteristics of the second target language model 238 and is expected to produce higher quality results than applying the transformed input 228 directly to the second target language model 238 without adaptation. The runtime processing flow 200B provides the adapted input 234 to the second target language model 238 for invocation.

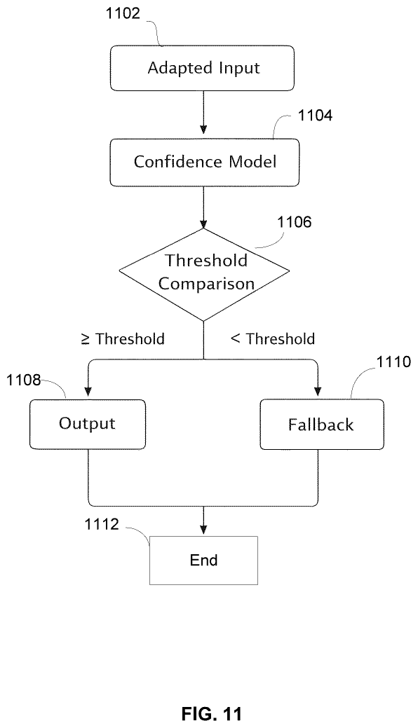

The adaptation model 232 may be configured to generate a confidence score indicating a predicted quality of the adapted input 234 for the target language model 238. The confidence score provides an estimate of how well the adaptation is expected to perform, enabling downstream components to make decisions based on adaptation quality. In one embodiment, the adapted input 234 is output only when the confidence score exceeds a predetermined threshold, providing a quality gate that prevents low-quality adaptations from being sent to the target language model 238, as described in further detail with reference to FIG. 11.

When the decision 230 determines that the target language model 238 is the same as the first language model, the runtime processing flow 200B outputs the transformed input 228 as an improved input 236, also labeled as the “Improved Input (No Adaptation)” in FIG. 2B. The improved input 236 carries the same content as the transformed input 228, wherein numeral 236 identifies the No-branch output path through which the transformed input 228 is forwarded directly to the target language model 238 without application of the adaptation model 232, distinct from the adapted input 234 on the Yes-branch. The improved input 236 is suitable for direct invocation of the first language model for which the transformation model 226 was trained.

The runtime processing flow 200B concludes by providing the improved input 236 or the adapted input 234 to the target language model 238. The target language model 238 receives the improved input 236 or the adapted input 234 and generates a response. The response is returned to the invoking system or user.

In embodiments supporting a plurality of target language models, the runtime processing flow 200B selects the target language model 238 from among the plurality of target language models based on a selection criterion associated with the new input 220. The runtime processing flow 200B applies, from among a plurality of adaptation models, the adaptation model 232 corresponding to the selected target language model 238. Each adaptation model in the plurality of adaptation models corresponds to a respective one of the plurality of target language models and has parameters mapping outputs of the transformation model 226 to the input format accepted by that target language model. The transformation model 226 has a first set of parameters independent of each of the plurality of target language models, and each adaptation model has a second set of parameters independent of the first set of parameters and of the corresponding target language model. The transformation model 226 and the adaptation model 232 together enable the runtime processing flow 200B to process inputs for each of the plurality of target language models using the first set of parameters of the transformation model 226, while each adaptation model in the plurality of adaptation models applies model-specific adaptation to convert the output of the transformation model 226 into the form accepted by the corresponding target language model.

In embodiments supporting multi-step workflows, the runtime processing flow 200B may operate iteratively. After receiving a response from the target language model 238, the system updates the context data in the new input 220 with the response and repeats the transformation process for subsequent tasks using the updated context data. Each iteration applies the transformation model 226 to the accumulated context, compresses the context based on relevance to the next task in the sequence specified by the task identifier 222, and produces a transformed input for the next invocation of the target language model 238. The iterative operation enables the system to maintain efficient context management throughout extended multi-step workflows.

The system may further support continuous learning by updating the paired training data with additional pairs generated from runtime inputs and transformed inputs, and retraining the transformation model 226 on an updated paired training data set comprising the additional pairs. The continuous learning capability enables the system to improve over time as the system processes more inputs and observes the quality of transformed outputs in production use. The additional pairs may be selected based on quality metrics computed from responses to the transformed inputs, with high-quality input-output pairs added to the paired training data to reinforce effective transformation patterns.

In certain embodiments, the first language model and the target language model 238 are from different large language model families. Large language model families may include models from different providers, models trained with different methodologies including instruction tuning, reinforcement learning from human feedback, or constitutional artificial intelligence, or models with different architectural designs including different attention mechanisms, context lengths, or parameter scales. The adaptation model 232 learns to bridge differences between large language model families, enabling transformed inputs to be adapted across provider boundaries and architectural variations.

### Input Data Structure

FIG. 3 illustrates an initial input data structure 300 depicting the decomposition of an input received by a transformation model into constituent components processed by the transformation model to produce a transformed input requiring fewer computational resources for a target language model to process than the input. The initial input data structure 300 establishes the data model upon which the transformation model operates during both the training phase, wherein the transformation model is trained on paired training data generated by applying two or more transformation techniques to training inputs, and the runtime processing flow, wherein the trained transformation model applies a single forward pass to a received input to produce a transformed input without querying the target language model during production of the transformed input. The initial input data structure 300 is applicable to single-turn interactions wherein the input consists solely of a prompt with no accumulated contextual data, and to agentic workflow interactions wherein the input is a context window from an agentic workflow comprising interaction history from two or more prior agent steps.

The initial input data structure 300 depicts two distinct entry points that both converge at a contextual data 306. A first entry point is an initial input data 302 at the top of the initial input data structure 300 that flows through a prompt 304 into the contextual data 306. A second entry point is an input 308 that flows directly into the contextual data 306 from the left side of the initial input data structure 300 as depicted in FIG. 3. The initial input data 302 and the input 308 together represent the complete input received by the transformation model, wherein the initial input data 302 supplies the directive content through the prompt 304 and the input 308 supplies the contextual content accumulated from prior sources, both converging at the contextual data 306 for processing by the transformation model.

The input 308 may comprise natural language text, programming code, structured data in a machine-readable format, or a multimodal input combining two or more of natural language text, image data, and audio data. The input 308 is depicted in FIG. 3 as a block labeled “Input/Text/Code/Structured Data/Multimodal” accompanied by image and audio icons reflecting the multimodal input type. In one embodiment, the input 308 comprises natural language text expressing a user request or instruction in conversational or directive form. In another embodiment, the input 308 comprises programming code submitted for analysis, completion, refactoring, or documentation by the target language model. In a further embodiment, the input 308 comprises structured data in a machine-readable format such as JSON, XML, or CSV that the target language model is to analyze, transform, or reason over. In yet another embodiment, the input 308 comprises a multimodal input combining natural language text with image data, audio data, or both, wherein the transformation model processes the combined multimodal content to produce a transformed input that reduces the computational resources required for the target language model to process the input.

The prompt 304, also referred to as the prompt component, contains the user query, instruction, or task specification that defines what the target language model is requested to accomplish. In one embodiment, a task identifier specifying a task for the target language model is received alongside the input 308 and the prompt 304, wherein the task identifier conditions the transformation model to produce a compressed output, also referred to as the transformed input, that retains information sufficient for the target language model to complete the task. The task identifier may be embedded within the prompt 304 as a structured task specification, or may be supplied as a separate input field received together with the input 308. The contextual data 306, also referred to as the contextual data component, encompasses background information provided alongside the prompt 304 to supply the target language model with relevant context for producing an accurate response. In embodiments wherein the input 308 is a context window from an agentic workflow, the contextual data 306 constitutes the context window comprising interaction history from two or more prior agent steps. In such embodiments, the transformation model applies a relevance scoring function to each portion of the interaction history within the contextual data 306, the relevance scoring function learned from the task-conditioned paired training data and producing a relevance score for each portion with respect to the task specified by the task identifier, portions scoring above a learned threshold being retained at full detail and portions scoring below the learned threshold being represented at a reduced level of detail in the compressed output.

The contextual data 306 branches into five sub-components that represent non-limiting examples of the interaction history content that may be accumulated across two or more prior agent steps: reasoning traces 310, tool observations 312, retrieved documents 314, memory elements 316, and environment state data 318. The reasoning traces 310 comprise intermediate reasoning steps generated by the target language model during chain-of-thought or stepwise reasoning processes executed during prior agent steps, capturing the inferential path followed as the target language model derived intermediate conclusions or decomposed complex tasks into sub-operations. The tool observations 312 comprise results returned by external tools invoked by the target language model agent during prior execution steps, including results from application programming interfaces, computation engines, database query interfaces, web search services, and code execution environments. The retrieved documents 314 comprise content fetched from external knowledge sources by the agent or by a retrieval component associated with the agent system during prior execution steps, including documents retrieved through dense embedding-based retrieval, sparse lexical retrieval, or hybrid retrieval methods from document databases, enterprise knowledge bases, or retrieval-augmented generation pipelines. The memory elements 316 comprise information stored by the target language model agent system for later retrieval, including key-value store entries, episodic memory records, semantic memory entries, and working memory buffers that maintain agent state across interactions and workflow steps. The environment state data 318 comprises information about the current state of an external environment with which the target language model agent interacts during workflow execution, including system status indicators, user interface state information, and physical world observations from sensors in embodied agent deployments.

The five sub-components 310 through 318, together with the prompt 304, constitute the complete input received by the transformation model at each agent step. The transformation model processes the input in a single forward pass to produce a transformed input, also referred to as a compressed output when the transformation model is conditioned on a task identifier, that requires fewer computational resources for the target language model to process than the input, by compressing the contextual data 306 based on the relevance scores produced by the relevance scoring function with respect to the task while preserving information within the sub-components 310 through 318 sufficient for the target language model to complete the task.

### Paired Dataset Construction Process

FIG. 4 illustrates a paired dataset construction process 400 implemented by the paired dataset constructor 202 to generate paired training data used for training the transformation model 204. The paired dataset construction process 400 defines a sequence of operations by which a training input is transformed into a plurality of candidates through application of two or more transformation techniques, each candidate is evaluated against a quality criterion, and a selected best candidate is paired with the training input to form a paired entry in the paired training data. The paired dataset construction process 400 operates as an offline data generation pipeline that executes prior to training of the transformation model 204, producing a corpus of paired entries that captures diverse patterns of effective input transformation across a wide range of input types, task domains, and transformation strategies. The paired dataset construction process 400 may be executed over large corpora of training inputs drawn from existing applications, user interaction logs, synthetic generation pipelines, or domain-specific input collections, enabling the resulting paired training data to reflect the breadth of input variations encountered in production deployment.

The paired dataset construction process 400 begins with a training input 414. The training input 414 represents an original, unmodified input supplied to the paired dataset construction process 400 as the starting point for candidate generation. The training input 414 may comprise a prompt component alone, in embodiments where the transformation system 106 is applied to single-turn interactions, or a combination of a prompt component and a contextual data component, in embodiments where the transformation system 106 is applied to multi-step workflow scenarios as described with reference to FIG. 3. For example, the training input 414 in a single-turn interaction may comprise a natural language question directed to a target language model as described with reference to FIG. 2A, while the training input 414 in a multi-step workflow scenario may comprise a prompt accompanied by accumulated contextual data including reasoning traces, tool observations, retrieved documents, memory elements, and environment state data. The training input 414 may be suboptimal in one or more respects, including excessive token length that increases computational cost when processed by the target language model, ambiguous or imprecisely formulated instructions that reduce response quality, redundant or irrelevant contextual content that dilutes the attention of the target language model, or formatting that is poorly suited to the processing characteristics of the target language model. The paired dataset construction process 400 does not require the training input 414 to be deficient in any particular respect. The paired dataset construction process 400 operates on any input for which a transformation technique is capable of producing a candidate that performs better on at least one evaluation criterion than the training input 414. The training input 414 may comprise one of: natural language text, programming code, structured data in a machine-readable format, and a multimodal input combining two or more of natural language text, image data, and audio data.

The paired dataset construction process 400 applies a plurality of transformation techniques 402 to the training input 414 to generate candidates. The paired dataset construction process 400 applies each of the transformation techniques 402 to the training input 414 as a distinct computational operation to produce at least one corresponding candidate. Each transformation technique of the transformation techniques 402 applies a different strategy for modifying, condensing, or restructuring the training input 414, and application of multiple transformation techniques 402 to the training input 414 captures diverse transformation strategies. The diversity of transformation strategies reflected in the transformation techniques 402 provides a broad range of candidates that vary in length, structure, phrasing, and content relative to each other and relative to the training input 414. The transformation techniques 402 depicted in FIG. 4 comprise a paraphrasing technique 404, a summarization technique 406, a key information extraction technique 408, a structured reformatting technique 410, and a semantic compression technique 412.

The paraphrasing technique 404 rewrites the training input 414 while preserving semantic content. The paraphrasing technique 404 generates one or more candidate rewrites of the training input 414 by altering the surface form of the training input 414, including word choice, sentence structure, and phrasing, without changing the underlying meaning conveyed by the training input 414. For example, the paraphrasing technique 404 may convert a verbose user query into a concise instruction format by identifying and removing filler phrases, consolidating repeated concepts, and reordering clauses to place the primary instruction at the beginning of the input. In another example, the paraphrasing technique 404 may replace complex or ambiguous phrasing with simpler and more precise language that is more amenable to processing by the target language model. The paraphrasing technique 404 may be implemented using rule-based transformation heuristics derived from linguistic analysis of effective inputs, or using neural paraphrase generation models trained on corpora of semantically equivalent sentence pairs. In one embodiment, the paraphrasing technique 404 employs an instruction-following large language model that receives the training input 414 together with a paraphrasing instruction and generates a paraphrased version of the training input 414 as the candidate output.

The summarization technique 406 produces a condensed version of the training input 414. The summarization technique 406 generates one or more candidate summaries that capture the essential semantic content of the training input 414 in a more concise form, reducing the token count of the training input 414 while retaining the information needed by the target language model to produce a response equivalent to the response produced from the full training input 414. The summarization technique 406 may produce new text that does not appear verbatim in the training input 414, enabling more aggressive token count reductions while maintaining semantic fidelity through the generation of novel phrasing. In one embodiment, the summarization technique 406 employs encoder-decoder neural network architectures trained on summarization corpora to generate fluent condensed representations of the training input 414. In another embodiment, the summarization technique 406 employs hierarchical summarization approaches that first summarize individual sections or sub-components of the training input 414 independently and then combine the section-level summaries into a coherent consolidated summary, enabling effective compression of long inputs that contain multiple distinct content segments.

The key information extraction technique 408 retains salient information from the training input 414 while removing less relevant content. The key information extraction technique 408 operates on the discrete token sequence or sentence structure of the training input 414, identifying portions of the training input 414 that carry high informational value with respect to the expected task and removing portions that carry low informational value. Unlike the summarization technique 406, the key information extraction technique 408 retains content that was present in the training input 414 without generating novel text. In one embodiment, the key information extraction technique 408 employs attention-based saliency detection to score each sentence or phrase in the training input 414 based on its contribution to the overall semantic content, retaining high-scoring portions and removing low-scoring portions. In another embodiment, the key information extraction technique 408 employs a learned token retention model trained to predict which tokens in a given input are likely to be attended to by the target language model when generating a response, retaining tokens with high predicted attention weight and removing tokens with low predicted attention weight. The key information extraction technique 408 is particularly applicable to inputs comprising a contextual data component accumulated during multi-step workflows, where significant portions of the accumulated contextual data component may be irrelevant to the current task and may be removed without affecting the response quality of the target language model.

The structured reformatting technique 410 reorganizes the training input 414 into a structured form. The structured reformatting technique 410 applies formatting transformations that impose a structured layout on the training input 414, converting unstructured prose instructions into organized formats that are more amenable to processing by the target language model. For example, the structured reformatting technique 410 may convert a paragraph of unstructured instructions into a numbered step sequence, a tabular representation, or a hierarchical outline that delineates distinct subtasks or requirements within the training input 414. In another example, the structured reformatting technique 410 may apply instruction clarification transformations that resolve ambiguities in the training input 414 by expanding underspecified references, adding explicit role assignments, or inserting output format specifications that constrain the response behavior of the target language model. The structured reformatting technique 410 may be implemented using rule-based formatting heuristics, template-based restructuring approaches, or neural models trained to convert unstructured inputs into structured representations.

The semantic compression technique 412 encodes the semantic content of the training input 414 in a shorter representation. The semantic compression technique 412 generates one or more candidates that convey the same or substantially equivalent semantic information as the training input 414 using fewer tokens. The semantic compression technique 412 differs from the summarization technique 406 in that the semantic compression technique 412 operates at the level of semantic encoding rather than at the level of natural language generation, compressing the informational payload of the training input 414 by identifying and eliminating semantic redundancies, collapsing co-referential expressions, and encoding frequently occurring patterns into compact representations. In one embodiment, the semantic compression technique 412 optimizes continuous embedding vectors that capture the semantic content of the training input 414 in a compressed form, and the resulting optimized embedding representation is decoded into a discrete token sequence through greedy decoding or beam search over the vocabulary. In another embodiment, the semantic compression technique 412 employs learned compression models that map input token sequences to shorter output token sequences while preserving the information content needed to elicit equivalent responses from the target language model.

The transformation techniques 402 collectively produce candidates from the training input 414. Each candidate represents a distinct modification of the training input 414 produced by a different transformation technique of the transformation techniques 402 or by a different configuration of the same transformation technique. The candidates are forwarded to an evaluate step 416 of the paired dataset construction process 400 for quality assessment.

The paired dataset construction process 400 applies the evaluate step 416 to the candidates generated by the transformation techniques 402. The evaluate step 416 assesses each candidate by analyzing the candidate against a quality criterion measuring how well the candidate preserves information from the training input 414. The evaluate step 416 additionally applies a cost-aware evaluation that measures the computational cost associated with processing the candidate by the target language model, where a candidate with fewer tokens corresponds to a lower computational cost because the computational cost of large language model inference scales with the number of input tokens. The evaluate step 416 applies threshold-based filtering to identify candidates that satisfy minimum quality requirements, followed by ranking of the filtered candidates to identify the candidate that achieves the most favorable combination of preserved information quality and reduced computational cost relative to the training input 414.

In one embodiment, the quality criterion of the evaluate step 416 is a measure of output similarity 418. The output similarity 418 is a measure of output similarity between an output produced by the target language model in response to the candidate and a reference output produced by the target language model in response to the corresponding training input 414. The output similarity 418 is computed by a target language model (inference) 420 that processes both the candidate and the training input 414 without any modification to the parameters of the target language model. The target language model (inference) 420 generates a response for each input the target language model (inference) 420 receives, and the output similarity 418 quantifies the degree to which the response generated from the candidate matches the response generated from the training input 414. The output similarity 418 indicates whether the transformation applied to the training input 414 to produce the candidate preserves the semantic intent of the training input 414 and does not introduce distortions that alter the expected response behavior of the target language model.

FIG. 4 further illustrates a detailed breakdown of the output similarity computation. A candidate 422 produced by the transformation techniques 402 is provided to a target language model (inference) 424. The target language model (inference) 424 processes the candidate 422 and generates a candidate output. A training input 426, which corresponds to the same training input 414, is provided to the target language model (inference) 424 to generate a reference output 428. The reference output 428 represents the output that the target language model (inference) 424 produces when the target language model (inference) 424 receives the original, unmodified training input 426 as input. The reference output 428 serves as the baseline against which the candidate output from the candidate 422 is compared. The target language model (inference) 420 depicted in the output similarity 418 block and the target language model (inference) 424 depicted in the detailed flow represent invocations of the same target language model operating with frozen parameters, the quality criterion being computed by applying the target language model in inference mode.

The paired dataset construction process 400 computes a similarity score 430 by comparing the candidate output generated by the target language model (inference) 424 in response to the candidate 422 against the reference output 428 generated by the target language model (inference) 424 in response to the training input 426. The similarity score 430 quantifies the degree of semantic correspondence between the two outputs. In one embodiment, the similarity score 430 is computed as the cosine similarity between embedding vectors of the candidate output from the candidate 422 and the reference output 428, where the embedding vectors are produced by a pretrained sentence encoder. In another embodiment, the similarity score 430 is computed as a BLEU or ROUGE overlap score between the two outputs. In a further embodiment, the similarity score 430 is computed by a learned equivalence model that receives both outputs as input and produces a scalar similarity value reflecting the degree of semantic correspondence between the candidate output from the candidate 422 and the reference output 428. The evaluate step 416 evaluates each candidate against the quality criterion and selects the candidate that satisfies the quality criterion to a greater degree than the remaining candidates as the best candidate. The paired dataset construction process 400 selects one candidate per training input based on output quality.

The paired dataset construction process 400 produces a paired entry 432 upon identification of the best candidate. The paired entry 432 comprises the training input 414 and the selected best candidate paired together as a training example for the transformation model 204. The paired entry 432 represents a single data point in the paired training data, encoding a mapping from the training input 414 to a corresponding transformed version of the training input 414 that achieves preserved response quality at reduced computational cost relative to the training input 414. The paired entry 432 may additionally include metadata comprising the identity of the transformation technique that produced the selected best candidate, the quality criterion value, the cost-aware evaluation value, the similarity score 430 achieved by the selected best candidate, as well as the task domain of the training input 414. The metadata associated with the paired entry 432 may be used during training of the transformation model 204 to condition the transformation on task types or target quality levels.

Repetition of the paired dataset construction process 400 across a large corpus of training inputs produces paired training data comprising a plurality of paired entries 432 suitable for training the transformation model 204. The transformation model 204 learns from the paired training data to perform input transformation across diverse task types and input structures in a single forward pass at runtime, without accessing the target language model during production of the transformed input. The paired training data generated by the paired dataset construction process 400 captures the collective knowledge of the multiple transformation techniques 402 in a single, unified training corpus, enabling the transformation model 204 to internalize the diverse transformation strategies applied during paired training data generation and to apply learned transformation patterns to new inputs at runtime.

### Optimization Methods Embodiment Diagram

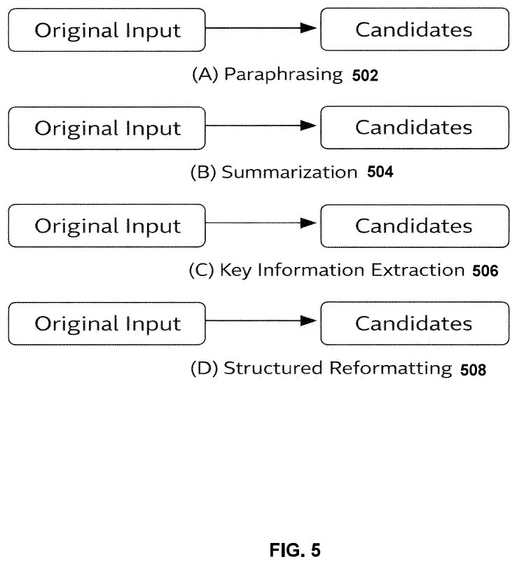

FIG. 5 illustrates a transformation techniques embodiment diagram 500 depicting four representative transformation techniques applied to generate candidates from a training input, also referred to as an original input, during construction of the paired training data. The transformation techniques embodiment diagram 500 presents each transformation technique as an independent panel, wherein each panel depicts the transformation of the training input through the respective technique into one or more candidates. The transformation techniques embodiment diagram 500 illustrates how structurally and operationally distinct transformation techniques each operate on the same training input yet produce candidates that differ in structure, content density, token count, and representational form, reflecting the diversity of transformation strategies captured by the two or more transformation techniques applied by a paired dataset constructor 202 described with reference to FIG. 2A and FIG. 4. The transformation techniques embodiment diagram 500 provides detailed structural and operational description of a paraphrasing technique, a summarization technique, a key information extraction technique, and a structured reformatting technique as four embodiments of the two or more transformation techniques applied by the paired dataset constructor 202 for candidate generation from the training input.

The transformation techniques embodiment diagram 500 comprises a first panel 502, which depicts the paraphrasing technique, also referred to as panel (A) Paraphrasing. The paraphrasing technique of the first panel 502 receives the training input and rewrites the training input while preserving semantic content, producing one or more candidates that convey the same meaning as the training input using different surface form. The paraphrasing technique of the first panel 502 generates candidates by altering the word choice, sentence structure, and phrasing of the training input without changing the underlying meaning conveyed by the training input. The candidates produced by the paraphrasing technique of the first panel 502 maintain the informational content of the training input while potentially reducing ambiguity, improving clarity, and restructuring the phrasing to be more amenable to processing by a target language model.

In one embodiment, the paraphrasing technique of the first panel 502 converts a verbose user query into a concise instruction format by identifying and removing filler phrases, consolidating repeated concepts, and reordering clauses to place the primary instruction at the beginning of the candidate. For example, a training input containing the phrase “I was wondering if you could possibly help me by providing an analysis of the quarterly revenue data” may be paraphrased into the candidate “Analyze the quarterly revenue data.” In another embodiment, the paraphrasing technique of the first panel 502 replaces complex or ambiguous phrasing with simpler and more precise language, converting a training input containing multiple nested subordinate clauses into a sequence of short, direct sentences that convey the same instructions with reduced syntactic complexity. In a further embodiment, the paraphrasing technique of the first panel 502 employs an instruction-following language model that receives the training input together with a paraphrasing instruction and generates a paraphrased version of the training input as the candidate. The paraphrasing technique of the first panel 502 may alternatively be implemented using rule-based transformation heuristics derived from linguistic analysis of effective inputs, or using neural paraphrase generation models trained on corpora of semantically equivalent sentence pairs. The candidates produced by the paraphrasing technique of the first panel 502 are discrete token sequences suitable for inclusion in the paired training data and for evaluation by an evaluate step described with reference to FIG. 4.

The transformation techniques embodiment diagram 500 comprises a second panel 504, which depicts the summarization technique, also referred to as panel (B) Summarization. The summarization technique of the second panel 504 receives the training input and produces a condensed version of the training input, generating one or more candidates that capture the essential semantic content of the training input in a more concise form through the generation of novel phrasing. The summarization technique of the second panel 504 differs structurally from the paraphrasing technique of the first panel 502 in that the summarization technique actively reduces the informational scope of the training input by identifying and retaining core content while omitting peripheral or supporting detail, whereas the paraphrasing technique preserves the full informational scope while altering surface form.

In one embodiment, the summarization technique of the second panel 504 employs an encoder-decoder neural network architecture trained on summarization corpora, wherein the encoder processes the full token sequence of the training input to produce a sequence of contextualized embedding vectors and the decoder generates the condensed candidate token by token conditioned on the encoder output. The encoder-decoder architecture may be implemented using transformer-based neural network architectures that have demonstrated strong abstractive summarization performance across diverse text domains. In another embodiment, the summarization technique of the second panel 504 employs an instruction-following language model that receives the training input together with a natural-language summarization instruction specifying the desired compression level, the information types to preserve, and any task-specific constraints on the output format, generating the condensed candidate as the instruction-following response. In a further embodiment, the summarization technique of the second panel 504 employs hierarchical summarization, wherein individual sections or sub-components of the training input are each summarized independently to produce section-level summaries, and the section-level summaries are then combined into a coherent consolidated summary that represents the complete training input at a reduced token count. The hierarchical approach is particularly effective for training inputs containing multiple distinct content segments, for example, training inputs comprising both a prompt component and a contextual data component with multiple sub-blocks as described with reference to FIG. 3, wherein summarizing each sub-block independently before composing the consolidated summary preserves the structural boundaries between sub-blocks in the condensed output. The candidates produced by the summarization technique of the second panel 504 may contain text that does not appear verbatim in the training input, enabling more aggressive token count reductions while maintaining semantic fidelity. The candidates produced by the summarization technique of the second panel 504 are discrete token sequences suitable for inclusion in the paired training data and for evaluation by the evaluate step described with reference to FIG. 4.

The transformation techniques embodiment diagram 500 comprises a third panel 506, which depicts the key information extraction technique, also referred to as panel (C) Key Information Extraction. The key information extraction technique of the third panel 506 receives the training input and retains salient information from the training input while removing less relevant content, producing one or more candidates that preserve the essential information content of the training input in a reduced token count. The key information extraction technique of the third panel 506 operates on the discrete token sequence or sentence structure of the training input, identifying and retaining segments that carry high informational value with respect to the expected task while removing segments that carry low informational value. Unlike the summarization technique of the second panel 504, the key information extraction technique of the third panel 506 retains content that was present verbatim in the training input without generating novel text.

In one embodiment, the key information extraction technique of the third panel 506 employs attention-based saliency detection to score each sentence or phrase in the training input based on its contribution to the overall semantic content, assigning higher saliency scores to segments that receive high aggregate attention across multiple attention heads and lower saliency scores to segments that receive low aggregate attention. Segments with saliency scores above a retention threshold are retained verbatim, and segments with saliency scores below the retention threshold are removed. In another embodiment, the key information extraction technique of the third panel 506 employs a learned token retention model trained to predict which tokens in a given training input are likely to be attended to by the target language model when generating a response, retaining tokens with high predicted attention weight and removing tokens with low predicted attention weight. The key information extraction technique of the third panel 506 is particularly applicable to training inputs comprising a contextual data component accumulated during multi-step workflows, wherein the accumulated contextual data component contains tool observations, retrieved documents, reasoning traces, and memory elements from prior execution steps that may contain significant portions irrelevant to current or upcoming tasks. In one embodiment, the key information extraction technique of the third panel 506 identifies and removes duplicate or near-duplicate passages within the retrieved documents sub-block of the contextual data component, retaining a single representative passage for each distinct semantic content cluster. In another embodiment, the key information extraction technique of the third panel 506 applies sentence-level retention decisions to the reasoning traces sub-block of the contextual data component, retaining reasoning steps that led to intermediate conclusions referenced in subsequent steps and removing reasoning steps that were exploratory, abandoned, or superseded by later conclusions. The candidates produced by the key information extraction technique of the third panel 506 are discrete token sequences suitable for inclusion in the paired training data and for evaluation by the evaluate step described with reference to FIG. 4.

The transformation techniques embodiment diagram 500 comprises a fourth panel 508, which depicts the structured reformatting technique, also referred to as panel (D) Structured Reformatting. The structured reformatting technique of the fourth panel 508 receives the training input and reorganizes the training input into a structured form, producing one or more candidates that present the content of the training input in an organized layout that is more amenable to processing by the target language model. The structured reformatting technique of the fourth panel 508 differs from the paraphrasing technique of the first panel 502, the summarization technique of the second panel 504, and the key information extraction technique of the third panel 506 in that the structured reformatting technique focuses on altering the organizational structure and formatting of the training input rather than primarily altering the wording or reducing the content volume.

In one embodiment, the structured reformatting technique of the fourth panel 508 converts a paragraph of unstructured prose instructions into a numbered step sequence that delineates distinct subtasks or requirements within the training input. For example, a training input containing a single paragraph describing multiple tasks may be reformatted into a numbered list wherein each number corresponds to a distinct task, with explicit delineation of the expected output for each task. In another embodiment, the structured reformatting technique of the fourth panel 508 converts an unstructured training input into a tabular representation or a hierarchical outline that organizes the content of the training input into logically grouped sections. In a further embodiment, the structured reformatting technique of the fourth panel 508 applies instruction clarification transformations that resolve ambiguities in the training input by expanding underspecified references, adding explicit role assignments, or inserting output format specifications that constrain the response behavior of the target language model. The structured reformatting technique of the fourth panel 508 may be implemented using rule-based formatting heuristics, template-based restructuring approaches, or neural models trained to convert unstructured inputs into structured representations. The candidates produced by the structured reformatting technique of the fourth panel 508 are discrete token sequences suitable for inclusion in the paired training data and for evaluation by the evaluate step described with reference to FIG. 4.

In a further embodiment not depicted as a separate panel in FIG. 5, the paired dataset constructor 202 employs a semantic compression technique as a fifth transformation technique. The semantic compression technique encodes the semantic content of the training input in a shorter representation, generating candidates that convey the same or substantially equivalent semantic information as the training input using fewer tokens. The semantic compression technique differs from the summarization technique of the second panel 504 in that the semantic compression technique operates at the level of semantic encoding rather than at the level of natural language generation, compressing the informational payload of the training input by identifying and eliminating semantic redundancies, collapsing co-referential expressions, and encoding frequently occurring patterns into compact representations. In one embodiment, the semantic compression technique optimizes continuous embedding vectors that capture the semantic content of the training input in a compressed form, and the resulting optimized embedding representation is decoded into a discrete token sequence through greedy decoding or beam search over the vocabulary. In another embodiment, the semantic compression technique employs learned compression models that map input token sequences to shorter output token sequences while preserving the information content needed to elicit equivalent responses from the target language model. The candidates produced by the semantic compression technique are forwarded to the evaluate step described with reference to FIG. 4 along with the candidates produced by the four transformation techniques depicted in panels 502 through 508 of FIG. 5.

In embodiments where a task identifier specifying a task for the target language model is available, each of the transformation techniques depicted in panels 502 through 508 may be applied in a task-conditioned manner, wherein the candidate generation is conditioned on the task specified by the task identifier in addition to the training input. In task-conditioned application, the paraphrasing technique of the first panel 502 rewrites the training input with emphasis on preserving phrasing relevant to the specified task, the summarization technique of the second panel 504 condenses the training input by prioritizing retention of content relevant to the specified task, the key information extraction technique of the third panel 506 computes saliency scores with respect to the specified task to determine which segments to retain, and the structured reformatting technique of the fourth panel 508 reorganizes the training input into a structured form that foregrounds the content most relevant to the specified task. The task-conditioned candidates produced by each transformation technique are incorporated into the task-conditioned paired training data described with reference to FIG. 2B and FIG. 4, wherein each training input is associated with a corresponding task identifier and the selected candidate retains information sufficient for the target language model to complete the task specified by the task identifier.

The four transformation techniques depicted in panels 502 through 508, together with the semantic compression technique, collectively represent the two or more transformation techniques applied by the paired dataset constructor 202 as described with reference to FIG. 4. Each transformation technique operates on the training input as a distinct computational operation to produce at least one corresponding candidate. The candidates produced by all applied transformation techniques are forwarded to the evaluate step described with reference to FIG. 4, wherein each candidate is evaluated against a quality criterion measuring how well the candidate preserves information from the training input. The quality criterion is a measure of output similarity between an output produced by the target language model in response to the candidate and a reference output produced by the target language model in response to the corresponding training input, the quality criterion being computed by applying the target language model in inference mode. The candidate that satisfies the quality criterion to a greater degree than the remaining candidates is selected as the one candidate per training input for inclusion in the paired training data, forming a pair comprising the training input and the selected candidate that constitutes one entry in the paired training data upon which the transformation model is trained as described with reference to FIG. 2A and FIG. 2B.

### Transformation Model Architecture

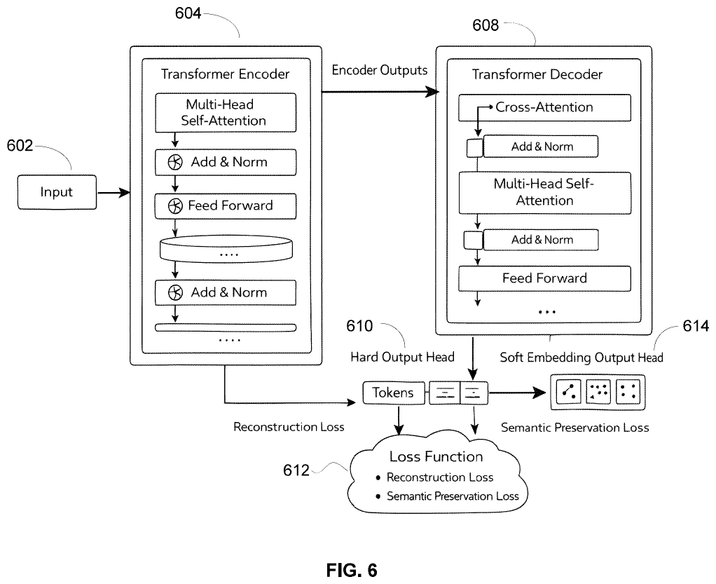

FIG. 6 illustrates a transformation model architecture 600 depicting the detailed neural network structure of the transformation model 204, also referred to as the input transformation model 204, described with reference to FIG. 2A. The transformation model architecture 600 implements an encoder-decoder neural network architecture that learns a mapping from original inputs to optimized inputs during the offline training phase and applies the learned mapping in a single forward pass at runtime to produce runtime optimized inputs without accessing the target language model. The transformation model architecture 600 is trained by minimizing a loss function 612 comprising a reconstruction loss and a semantic preservation loss, wherein the reconstruction loss and the semantic preservation loss together enforce that the transformation model 204 generates outputs that match the target optimized inputs from the paired dataset while preserving the semantic content of the original inputs from which those target optimized inputs were derived. The transformation model architecture 600 produces outputs through two parallel output heads, a hard output head 610 and a soft embedding output head 614, each contributing a distinct supervisory signal to the loss function 612 during training and each producing a distinct form of output representation during inference.

The transformation model architecture 600 receives an input 602, also referred to as the original input 602, which corresponds to an original input from the paired dataset during the training phase and to a runtime input during the inference phase. The input 602 comprises a token sequence representing the content to be optimized, including in embodiments where the input 602 is a multi-component input, both a prompt component containing the user instruction or task specification and a contextual data component containing information accumulated during prior steps of a multi-step workflow. The input 602 is tokenized using a tokenization scheme compatible with the transformation model architecture 600 prior to processing, producing a sequence of discrete token identifiers that are mapped to token embedding vectors by a token embedding layer at the entry point of the encoder. The token embedding vectors are combined with positional encoding vectors that encode the position of each token in the sequence, providing the encoder with information about token order that is not captured by the token embedding vectors themselves. In one embodiment, the positional encoding is implemented as learned positional embeddings that are optimized jointly with the other parameters of the transformation model architecture 600 during training. In another embodiment, the positional encoding is implemented as fixed sinusoidal positional encodings that assign each position a unique fixed encoding vector computed from sinusoidal functions of position index and embedding dimension, enabling the transformation model architecture 600 to generalize to input lengths not seen during training.

The transformation model architecture 600 comprises a transformer encoder 604 that processes the input 602 to produce encoder outputs. The transformer encoder 604 receives the combined token embedding and positional encoding representation of the input 602 and applies a stack of transformer encoder layers to produce a sequence of contextualized token representations, also referred to as the encoder outputs, that capture the semantic content and structural relationships among all tokens in the input 602. The encoder outputs are passed to the transformer decoder 608 to condition the generation of the optimized output sequence.

The transformer encoder 604 comprises a multi-head self-attention sublayer as the first computational component of each encoder layer. The multi-head self-attention sublayer computes attention scores between all pairs of token positions in the input sequence, allowing each token's representation to be updated to incorporate information from all other tokens in the sequence regardless of their positional distance. The multi-head self-attention sublayer implements the attention mechanism using multiple parallel attention heads, wherein each attention head applies a distinct learned linear projection to the input token representations to produce query matrices, key matrices, and value matrices for that head. For each attention head h, the attention computation produces scaled dot-product attention scores by computing the dot product between the query matrix and the transpose of the key matrix, dividing by the square root of the key dimension to prevent gradient vanishing from large dot product magnitudes, and applying a softmax normalization to produce a probability distribution over positions. The attention output for each head is computed as the weighted sum of the value matrix using the softmax-normalized attention scores as weights. The outputs of all attention heads are concatenated and projected through a learned output projection matrix to produce the multi-head self-attention sublayer output, which has the same dimensionality as the input to the sublayer. The multi-head formulation allows the transformer encoder 604 to jointly attend to information from different representational subspaces at different positions, enabling the encoder to capture diverse syntactic and semantic relationships simultaneously within a single encoder layer.

The transformer encoder 604 comprises an Add & Norm sublayer following the multi-head self-attention sublayer within each encoder layer. The Add & Norm sublayer implements a residual connection that adds the input to the multi-head self-attention sublayer to the output of the multi-head self-attention sublayer, followed by layer normalization applied to the sum. The residual connection preserves gradient flow during backpropagation by providing a direct path from the sublayer input to the sublayer output, enabling effective training of deep transformer encoder stacks that comprise many stacked encoder layers. The layer normalization normalizes the activations across the embedding dimension for each token position independently, computing the mean and variance of the activation values for each token position and normalizing the activations to have zero mean and unit variance, then applying learned per-dimension scale and shift parameters to restore expressive capacity. The layer normalization stabilizes training by reducing internal covariate shift and enables higher learning rates without gradient explosion.

The transformer encoder 604 comprises a feed-forward sublayer following the Add & Norm sublayer within each encoder layer. The feed-forward sublayer applies a position-wise feed-forward network to each token position independently, comprising a first linear transformation that expands the token representation dimensionality to a larger intermediate dimension, a nonlinear activation function applied element-wise to the expanded representation, and a second linear transformation that projects the expanded intermediate representation back to the encoder model dimension. The first linear transformation and second linear transformation each have learned weight matrices and bias vectors that are shared across all positions but are distinct for each encoder layer. In one embodiment, the nonlinear activation function is the rectified linear unit (ReLU), which applies a piecewise linear function that outputs zero for negative activations and the identity for positive activations. In another embodiment, the nonlinear activation function is the Gaussian error linear unit (GELU), which applies a smooth approximation to the ReLU that provides gradient information for negative activations, enabling more effective optimization. The feed-forward sublayer enables each token position to undergo a learned nonlinear transformation that integrates information gathered by the preceding multi-head self-attention sublayer, increasing the representational capacity of each encoder layer beyond what attention alone provides.

The transformer encoder 604 comprises a second Add & Norm sublayer following the feed-forward sublayer within each encoder layer, applying the same residual connection and layer normalization pattern as the first Add & Norm sublayer to the output of the feed-forward sublayer. The stacking of the multi-head self-attention sublayer, first Add & Norm sublayer, feed-forward sublayer, and second Add & Norm sublayer constitutes one complete encoder layer, and the transformer encoder 604 comprises a plurality of such encoder layers arranged in a stack, wherein the output of each encoder layer serves as the input to the next encoder layer. The dotted line separators depicted within the transformer encoder 604 in FIG. 6 indicate that the transformer encoder 604 comprises multiple stacked encoder layers, with the depicted sublayer sequence repeating for each layer in the stack. The final encoder layer of the transformer encoder 604 produces the encoder outputs, which are a sequence of contextualized token embedding vectors of the same length as the input token sequence, wherein each vector encodes the semantic content of its corresponding input token in the context of all surrounding tokens.

The transformation model architecture 600 comprises a transformer decoder 608 that receives the encoder outputs from the transformer encoder 604 and generates the optimized output sequence token by token conditioned on the encoder outputs and previously generated output tokens. The transformer decoder 608 is implemented as a stack of transformer decoder layers, each of which differs from the encoder layers of the transformer encoder 604 by comprising three sublayers rather than two: a masked multi-head self-attention sublayer, an Add & Norm sublayer following the masked self-attention, a cross-attention sublayer, an Add & Norm sublayer following the cross-attention, a feed-forward sublayer, and a final Add & Norm sublayer. The transformer decoder 608 generates the optimized output sequence autoregressively, wherein at each decoding step the decoder generates one output token conditioned on the encoder outputs and all previously generated output tokens, repeating until an end-of-sequence token is generated or a maximum output length constraint is reached.

The transformer decoder 608 comprises a cross-attention sublayer as the first depicted computational component in FIG. 6. The cross-attention sublayer, also referred to as encoder-decoder attention, allows each position in the decoder to attend to all positions in the encoder outputs. The cross-attention sublayer computes query matrices from the decoder's current hidden state, using the outputs of the preceding masked self-attention sublayer and its Add & Norm sublayer as the query source, and computes key matrices and value matrices from the encoder outputs produced by the transformer encoder 604. The cross-attention computation applies the same scaled dot-product attention mechanism used in the self-attention sublayers, but with the query and key-value sources coming from different sequences: queries from the decoder state and keys and values from the encoder output. The cross-attention mechanism enables the transformer decoder 608 to selectively retrieve information from the encoder outputs at each decoding step, focusing attention on the encoder positions that are most relevant to generating the current output token. The cross-attention sublayer implements multiple parallel attention heads following the same multi-head formulation as the multi-head self-attention sublayer of the transformer encoder 604, enabling the decoder to attend to different aspects of the encoder output simultaneously.

The transformer decoder 608 comprises an Add & Norm sublayer following the cross-attention sublayer, applying a residual connection from the input to the cross-attention sublayer to the output of the cross-attention sublayer followed by layer normalization, using the same residual connection and layer normalization pattern described for the transformer encoder 604. The transformer decoder 608 further comprises a multi-head self-attention sublayer that applies masked self-attention to the decoder's own output sequence. The masked self-attention sublayer applies causal masking to the attention score matrix before softmax normalization, setting attention scores for future positions to negative infinity so that they receive zero weight after softmax, ensuring that the decoder's self-attention at each position attends only to previously generated positions and does not access future output tokens during training. The causal masking enforces the autoregressive generation property, wherein the prediction of each output token depends only on the encoder outputs and the output tokens generated before the current position. The transformer decoder 608 comprises an Add & Norm sublayer following the multi-head self-attention sublayer, applying the same residual connection and layer normalization pattern. The transformer decoder 608 further comprises a feed-forward sublayer following the Add & Norm sublayer, applying the same position-wise feed-forward network described for the transformer encoder 604, with its own set of learned weight matrices and bias vectors that are distinct from those of the encoder feed-forward sublayers. The dotted line within the transformer decoder 608 in FIG. 6 indicates that the transformer decoder 608 comprises multiple stacked decoder layers following the same sublayer sequence, with each decoder layer receiving as input the output of the preceding decoder layer and the encoder outputs from the transformer encoder 604 via the cross-attention sublayer of each decoder layer.

The transformation model architecture 600 comprises a hard output head 610, depicted in FIG. 6 as receiving the output of the transformer decoder 608 and producing a discrete token sequence representing the optimized input. The hard output head 610 implements a linear projection from the decoder output dimension to the vocabulary size, followed by a softmax normalization over the vocabulary dimension, producing at each decoding step a probability distribution over the full vocabulary from which the next output token is selected. The hard output head 610 is referred to as the “hard” output head because it produces discrete token selections that correspond to entries in the vocabulary of the transformation model architecture 600, generating a discrete token sequence that constitutes a hard prompt, also referred to as a hard optimized input, directly usable as a discrete text input for invocation of the target large language model. During training, the hard output head 610 produces the token probability distributions used to compute the reconstruction loss, which measures fidelity between the generated token sequence and the target optimized input tokens from the paired dataset. During inference, the hard output head 610 applies greedy decoding, beam search decoding, or sampling-based decoding to select output tokens from the predicted probability distributions, producing the final discrete token sequence of the runtime optimized input.

In one embodiment, the hard output head 610 applies greedy decoding by selecting the highest-probability token at each decoding step, producing a deterministic discrete output sequence. In another embodiment, the hard output head 610 applies beam search decoding by maintaining a set of the top-k partial output sequences ranked by cumulative log-probability at each decoding step, expanding each partial sequence by one token and pruning back to the top-k sequences, and returning the highest-scoring complete sequence upon termination. The beam search decoding enables the hard output head 610 to find output sequences with higher overall probability than greedy decoding by exploring multiple candidate output sequences in parallel. In a further embodiment, the hard output head 610 applies sampling-based decoding with temperature scaling or nucleus sampling to introduce diversity into the generated output sequences, enabling the generation of multiple distinct candidate optimized inputs from a single original input for use in populating the plurality of candidate optimized inputs evaluated during the paired dataset construction process 400.

The transformation model architecture 600 comprises a soft embedding output head 614, depicted in FIG. 6 as receiving the output of the transformer decoder 608 in parallel with the hard output head 610 and producing continuous embedding vectors representing the optimized input in continuous embedding space. The soft embedding output head 614 is referred to as the “soft” output head because it produces continuous-valued embedding vectors rather than discrete token selections, generating a soft prompt, also referred to as a soft optimized input, that exists in the continuous embedding space of the transformation model architecture 600 rather than in the discrete token vocabulary. The soft embedding output head 614 implements a linear projection from the decoder output dimension to the embedding space dimension, optionally followed by a nonlinear activation function, producing at each decoding step a continuous embedding vector of the output embedding dimension. The continuous embedding vectors produced by the soft embedding output head 614 constitute the soft prompt representation of the optimized input, capturing the semantic intent of the optimized input in a dense continuous form that may encode optimization information that is not fully representable in the discrete token vocabulary.

During training, the soft embedding output head 614 produces the continuous embedding vectors used to compute the semantic preservation loss, which measures semantic similarity between the continuous embedding representation of the original input and the continuous embedding representation of the generated output. The semantic preservation loss is computed using the soft embedding representation produced by the soft embedding output head 614 rather than the discrete token representation produced by the hard output head 610 because the continuous embedding space provides a differentiable similarity metric that supports gradient-based optimization, whereas discrete token sequences do not admit a differentiable similarity computation. The semantic preservation loss thus provides a gradient signal through the soft embedding output head 614 that guides the transformation model architecture 600 to generate outputs that preserve the semantic content of the original input even when the surface form of the generated output differs substantially from the surface form of the original input.

In one embodiment, the soft embedding output head 614 produces embeddings used to compute cosine similarity between the embedding representation of the original input and the embedding representation of the generated output, wherein both embeddings are produced by processing the respective token sequences through a pretrained sentence encoder that maps variable-length token sequences to fixed-dimensional embedding vectors. In another embodiment, the soft embedding output head 614 directly produces the embedding representations used in the semantic preservation loss computation, and the original input embedding is produced by passing the original input token sequence through the transformer encoder 604 and applying a pooling operation over the encoder outputs, such as mean pooling or taking the representation of a special classification token prepended to the input sequence, to produce a single fixed-dimensional embedding vector representing the entire original input. At inference time, the continuous embedding vectors produced by the soft embedding output head 614 may be converted to discrete token sequences through nearest-neighbor lookup in the token embedding matrix of the transformation model architecture 600, wherein each continuous embedding vector is replaced by the vocabulary token whose embedding vector minimizes Euclidean distance, or may be used directly as continuous soft prompt embeddings when the target large language model supports continuous embedding inputs.

The transformation model architecture 600 is trained by minimizing a loss function 612 depicted in FIG. 6 as a cloud-shaped element receiving inputs from both the hard output head 610 and the soft embedding output head 614 and labeled with its two constituent terms: Reconstruction Loss and Semantic Preservation Loss. The loss function 612 is a composite of the reconstruction loss and the semantic preservation loss, wherein both loss terms are computed for each training example and summed or weighted-summed to produce the total loss value used for backpropagation and parameter update. The loss function 612 is formally expressed as the weighted combination L=L_{recon}+λ·Lₛₑₘ, where L_{recon} is the reconstruction loss, Lₛₑₘ is the semantic preservation loss, and λ is a hyperparameter controlling the relative weighting of the two loss terms. The two loss terms enforce complementary training objectives: the reconstruction loss enforces that the transformation model architecture 600 generates output sequences that reproduce the target optimized inputs from the paired dataset, while the semantic preservation loss enforces that the output sequences preserve the semantic meaning of the original inputs regardless of surface-level differences from the target optimized inputs.

The reconstruction loss of the loss function 612 measures fidelity between the generated output and the target optimized input from the paired dataset. The reconstruction loss is implemented as a cross-entropy loss computed over the token probability distributions produced by the hard output head 610 at each decoding step, wherein the target token at each position is the corresponding token of the target optimized input from the paired dataset. The cross-entropy loss at each decoding position is computed as the negative log-probability assigned by the hard output head 610 to the target token, and the reconstruction loss for a complete training example is the mean of the per-position cross-entropy values across all positions of the target optimized input sequence. Minimizing the reconstruction loss trains the transformation model architecture 600 to accurately reproduce the target optimized inputs from the paired dataset, learning the mapping from original inputs to optimized inputs captured in the paired dataset. The reconstruction loss is computed using teacher forcing during training, wherein at each decoding step the target token from the paired dataset is provided as the decoder input for the next step regardless of what token the hard output head 610 predicted at the current step, enabling efficient parallel computation of all decoding step losses within a single forward pass and stabilizing early training when the decoder's predictions are far from the target.

The semantic preservation loss of the loss function 612 measures semantic similarity between the original input and the generated output. The semantic preservation loss is computed using the continuous embedding vectors produced by the soft embedding output head 614 for the generated output and the embedding representation of the original input. The semantic preservation loss is implemented as one minus the cosine similarity between the embedding vector of the original input and the embedding vector of the generated output, wherein cosine similarity is computed as the dot product of the two unit-normalized embedding vectors and ranges from minus one for maximally dissimilar vectors to one for identical vectors. Minimizing the semantic preservation loss drives the cosine similarity between the original input embedding and the generated output embedding toward one, training the transformation model architecture 600 to generate output sequences whose continuous embedding representation is close to the continuous embedding representation of the original input in the embedding space defined by the pretrained sentence encoder or the pooled encoder output, thereby enforcing semantic fidelity between the original input and the generated optimized output. The semantic preservation loss provides a training signal complementary to the reconstruction loss: while the reconstruction loss enforces that the output matches the specific target optimized input from the paired dataset, the semantic preservation loss enforces that the output preserves the semantic intent of the original input, providing a regularizing effect that prevents the transformation model architecture 600 from generating semantically distorted outputs for original inputs whose target optimized inputs in the paired dataset are imperfect or whose surface form differs substantially from the original input semantic content.

The loss function 612 is minimized using backpropagation-based gradient descent applied to all parameters of the transformation model architecture 600, including the parameters of the transformer encoder 604, the transformer decoder 608, the hard output head 610, and the soft embedding output head 614. Gradient optimization algorithms applicable to minimizing the loss function 612 include the Adam optimizer, the AdamW optimizer with weight decay regularization, and the Adafactor optimizer optimized for memory efficiency with large-scale transformer architectures. The training process employs a learning rate schedule comprising a linear warm-up phase during which the learning rate is increased gradually from zero to the peak learning rate over a specified number of warm-up steps, followed by a cosine decay or linear decay phase during which the learning rate is reduced from the peak value toward zero over the remaining training steps. Regularization techniques including dropout applied within the multi-head self-attention sublayers, feed-forward sublayers, and output head projections, and weight decay applied to the non-bias parameters of the transformer encoder 604 and transformer decoder 608, are employed to prevent overfitting to the training examples in the paired dataset and improve generalization to original inputs not seen during training. The transformation model architecture 600 is trained on the paired dataset constructed by the paired dataset constructor 202 until the loss function 612 converges to a minimum, at which point the trained parameters are saved as a deployable model artifact for use at runtime.

### Inter-Model Adaptation

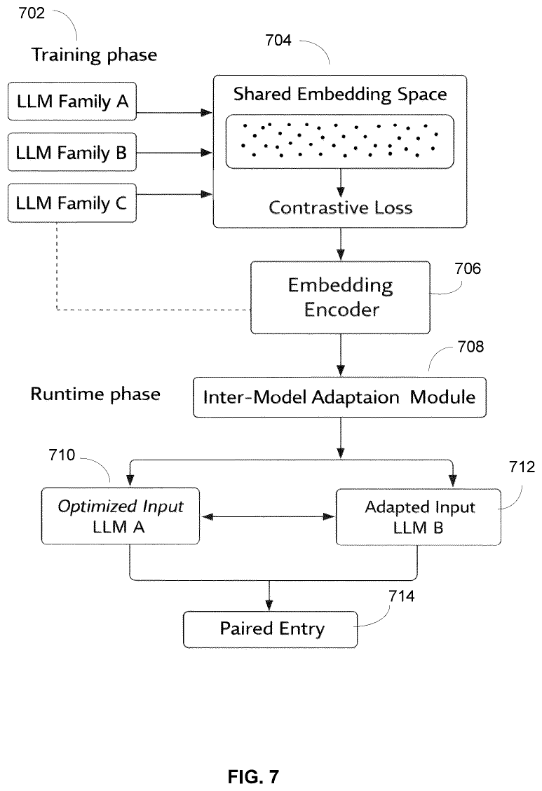

FIG. 7 illustrates an inter-model adaptation diagram 700 depicting the architecture and operational flow of the inter-model adaptation module 708, also referred to as the inter-model adaptation module 208 of FIG. 2A. The inter-model adaptation diagram 700 is organized into a training phase 702 and a runtime phase, wherein the training phase 702 establishes the shared embedding space 704 and the learned adaptation parameters of the inter-model adaptation module 208 through contrastive learning on input response pairs collected from a plurality of different large language models, and the runtime phase applies the trained inter-model adaptation module 208 to convert an optimized input configured for a first large language model into an adapted input configured for a second large language model different from the first large language model.

The training phase 702 receives input response pairs collected from a plurality of large language model families, depicted in FIG. 7 as LLM Family A, LLM Family B, and LLM Family C. Each large language model family represents a distinct provider, architectural lineage, or training methodology, encompassing differences in tokenization schemes, context window sizes, and interpretive characteristics that cause the same input to produce materially different responses across families. For each input in the training corpus, the training phase 702 invokes each of the represented large language model families with the same input and records the resulting response from each family, producing a set of input response pairs of the form (input, response_A), (input, response_B), (input, response_C) that collectively characterize how different large language model families respond to the same semantic content. In one embodiment, the first large language model and the second large language model are from different large language model families, wherein large language model families include models from different providers, models trained with different methodologies such as instruction tuning, reinforcement learning from human feedback, or constitutional AI, or models with architecturally distinct designs such as different attention mechanisms, context lengths, or parameter scales.

The training phase 702 passes the collected inputs from each large language model family through an embedding encoder 706, using the corresponding responses as supervisory signals to determine semantic equivalence across families. The embedding encoder 706 maps each input to a continuous embedding vector in a common representational space, encoding the semantic content in a dense fixed dimensional form that supports similarity computation across different large language model families. Two inputs from different large language model families are treated as semantically equivalent when the responses they produce from their respective large language model families are semantically similar, as measured by cosine similarity between the response embedding vectors or by a learned evaluation model that assigns equivalence scores to response pairs. In one embodiment, the embedding encoder 706 is implemented as a pretrained sentence encoder, consistent with the semantic preservation loss computation described with reference to FIG. 6, that processes token sequences of arbitrary length and produces fixed dimensional embedding vectors through mean pooling or classification token pooling over the token level outputs. In another embodiment, the embedding encoder 706 is a learned encoder whose parameters are updated during the contrastive learning training process to produce embeddings optimized for the cross model alignment objective.

The training phase 702 applies a contrastive loss to the embedding vectors produced by the embedding encoder 706 to learn the shared embedding space 704 in which semantically equivalent inputs for different large language models are mapped to nearby positions. The contrastive loss treats inputs from different large language model families that were generated from the same original input and that produce semantically similar responses as positive pairs that should be mapped close together in the shared embedding space 704, and treats inputs derived from different original inputs as negative pairs that should be mapped far apart. In one embodiment, the contrastive loss is implemented as an InfoNCE loss that, for each anchor input embedding, computes the normalized temperature scaled cross-entropy of the similarity between the anchor embedding and the positive pair embedding relative to the similarities between the anchor embedding and all other samples in the same training batch serving as in-batch negatives, driving the inter-model adaptation module 208 to maximize the mutual information between semantically equivalent representations across large language model families. In another embodiment, the contrastive loss may be implemented as a triplet loss that operates on anchor, positive, and negative triplets, wherein the anchor is an input from one large language model family, the positive is a semantically equivalent input from a different large language model family derived from the same original input, and the negative is an input derived from a different original input, and the triplet loss minimizes the anchor to positive distance while maximizing the anchor to negative distance by a margin. The contrastive learning process causes the inter-model adaptation module 208 to learn the shared embedding space 704 in which semantically equivalent inputs for different large language models are mapped to nearby positions, enabling the trained module to identify when inputs for different families are semantically equivalent despite differences in surface form and to perform adaptation by mapping an optimized input from the source family region of the shared embedding space 704 to the corresponding region of the target family.

The runtime phase of the inter-model adaptation diagram 700 applies the inter-model adaptation module 708 to convert a runtime optimized input into a runtime adapted input suitable for the target large language model. The inter-model adaptation module 708 receives an optimized input 710, also referred to as the runtime optimized input 228 described with reference to FIG. 2B, labeled in FIG. 7 as “Optimized Input/LLM A.” The inter-model adaptation module 708 encodes the optimized input 710 into the shared embedding space 704 using the trained embedding encoder 706 and applies a learned adaptation transformation that maps the embedding of the optimized input 710 from the region of the shared embedding space 704 associated with the first large language model to the corresponding region associated with the target large language model, then decodes the adapted embedding into a discrete token sequence forming the adapted input 712, also referred to as the runtime adapted input, labeled in FIG. 7 as “Adapted Input/LLM B.”

The inter-model adaptation module 708 restructures the optimized input 710 to account for differences between the first large language model and the target large language model, comprising at least one of: differences in tokenization schemes, wherein the inter-model adaptation module 708 adjusts the token boundary structure of the optimized input 710 to align with the vocabulary and subword segmentation algorithm of the target large language model; differences in context window sizes, wherein the inter-model adaptation module 708 applies additional compression or expansion to fit the optimized input 710 within the context window capacity of the target large language model; or differences in interpretive characteristics, wherein the inter-model adaptation module 708 rephrases instruction components or adds clarifying context elements to align with the response patterns and handling of ambiguous queries exhibited by the target large language model. The inter-model adaptation module 708 further generates a confidence score indicating a predicted quality of the adapted input 712 for the target large language model, and the adapted input 712 is provided for invocation of the target large language model only when the confidence score exceeds a predetermined threshold, providing a quality gate that prevents low confidence adaptations from degrading the quality of responses produced by the target large language model.

The runtime phase further depicts a paired entry 714 produced from the optimized input 710 and the adapted input 712. The paired entry 714 represents an additional training pair for the training corpus of the inter-model adaptation module 208, wherein the optimized input 710 serves as the source side input and the adapted input 712 serves as the corresponding adapted input for the mapping from the first large language model to the target large language model. The paired entry 714 is distinct from the pairs in the paired dataset used to train the transformation model 204, which comprise original inputs and corresponding optimized inputs as described with reference to FIG. 4. The paired entry 714 supports the continuous learning mechanism described with reference to FIG. 2A, wherein additional pairs generated from runtime inputs and runtime optimized inputs are used to update the training corpus of the inter-model adaptation module 208, enabling the inter-model adaptation module 208 to improve its adaptation accuracy over time as it processes more runtime input response pairs from the target large language model families encountered in production deployment.

### Model Registry and Runtime Adaptation System

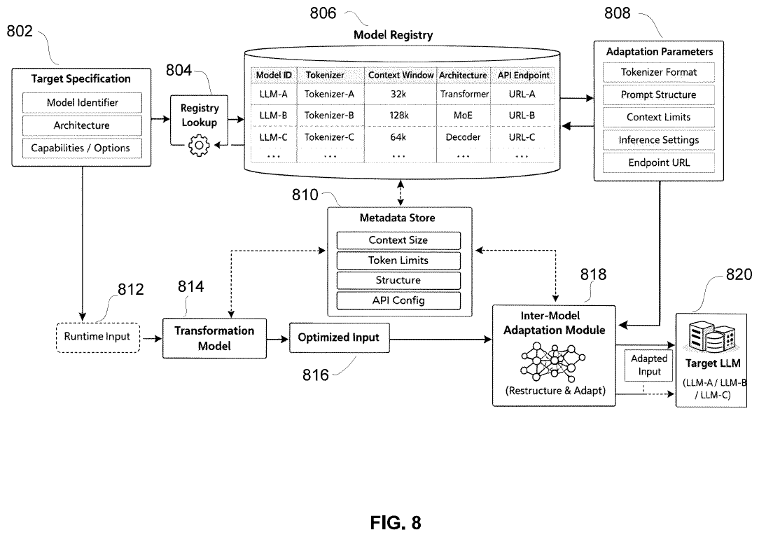

FIG. 8 illustrates a model registry and runtime adaptation system 800 depicting the detailed operational flow by which a target specification 802 is resolved against a model registry 806 to retrieve model specific adaptation parameters 808, and by which the retrieved parameters are used to configure the inter-model adaptation module 818 to produce a runtime adapted input for a target large language model 820. The model registry and runtime adaptation system 800 corresponds to the runtime processing flow described with reference to FIG. 2B, providing a detailed expanded view of the model registry component referenced in § 0058 of the FIG. 2A description and the target specification 224 described in § 0038 through § 0039 of the FIG. 2B description. The model registry and runtime adaptation system 800 operates entirely at runtime and does not require retraining or offline reconfiguration when new target large language models are registered or when adaptation parameters for existing target large language models are updated.

The model registry and runtime adaptation system 800 receives a target specification 802 identifying the target large language model for which the runtime input is to be optimized and adapted. The target specification 802, also referred to as the target specification 224 of FIG. 2B, comprises at least one of a model identifier, an architecture descriptor, or a capabilities and options profile corresponding to the target large language model. The model identifier comprises a name or version string uniquely identifying the target large language model within the model registry 806. The architecture descriptor comprises information about the architectural type of the target large language model, including the attention mechanism variant, parameter scale, and training methodology. The capabilities and options profile comprises information about the operational characteristics of the target large language model, including supported input formats, default response styles, and any special handling requirements relevant to input optimization and adaptation.

The target specification 802 is submitted to a registry lookup 804 that resolves the target specification 802 against the model registry 806. The model registry 806 is a centralized repository storing metadata for a plurality of supported target large language models. The model registry 806 is depicted in FIG. 8 as a table comprising, for each registered large language model, a model identifier field, a tokenizer field, a context window field, an architecture field, and an API endpoint field. The model registry 806 entries depicted in FIG. 8 include LLM A with Tokenizer A, a 32k context window, a Transformer architecture, and API endpoint URL A; LLM B with Tokenizer B, a 128k context window, a Mixture of Experts architecture, and API endpoint URL B; and LLM C with Tokenizer C, a 64k context window, a Decoder architecture, and API endpoint URL C. The tokenizer field records the tokenization scheme associated with each registered large language model, including the tokenization algorithm such as byte pair encoding, WordPiece, or SentencePiece and the vocabulary size, enabling the inter-model adaptation module 818 to identify tokenization scheme differences of the type. The context window field records the maximum token length accepted by each registered large language model as input, enabling the inter-model adaptation module 818 to determine whether compression or expansion of the runtime optimized input is required to fit within the context window capacity of the target large language model. The architecture field records the architectural type of each registered large language model, enabling the system to determine whether the target large language model differs architecturally from the first large language model for which the transformation model 814 was trained. The API endpoint field records the network address and protocol specification required to invoke each registered large language model, corresponding to the API endpoint specification component of the target specification 224 described in the FIG. 2B description.

The registry lookup 804 retrieves the model registry 806 entry matching the model identifier component of the target specification 802 and passes the retrieved metadata to two downstream components: the metadata store 810 and the adaptation parameters 808.

The metadata store 810 receives the retrieved model registry 806 entry and exposes a structured set of model specific metadata fields used by the transformation model 814 and the inter-model adaptation module 818 during the runtime adaptation process. The metadata store 810 is depicted in FIG. 8 as comprising a context size field, a token limits field, a structure field, and an API configuration field. The context size field stores the context window size of the target large language model retrieved from the model registry 806, which the transformation model 814 uses to determine the target token budget for the runtime optimized input 816. The token limits field stores the maximum input token count and any per segment token constraints applicable to the target large language model. The structure field stores structural formatting requirements of the target large language model, including expected input layout conventions, role assignment formats, and system prompt positioning conventions that affect how the inter-model adaptation module 818 restructures the optimized input 816 to align with the interpretive characteristics of the target large language model. The API configuration field stores the API endpoint specification and authentication parameters required to invoke the target large language model 820 following adaptation.

The adaptation parameters 808 are retrieved from the model registry 806 by the registry lookup 804 and provided to the inter-model adaptation module 818 to configure its adaptation behavior for the specific target large language model identified by the target specification 802. The adaptation parameters 808 are depicted in FIG. 8 as comprising a tokenizer format parameter, a prompt structure parameter, a context limits parameter, an inference settings parameter, and an endpoint URL parameter. The tokenizer format parameter specifies the tokenization algorithm and vocabulary of the target large language model, enabling the inter-model adaptation module 818 to restructure the runtime optimized input 816 to account for differences in tokenization schemes. The prompt structure parameter specifies the input formatting conventions expected by the target large language model, including role tags, delimiters, system prompt syntax, and instruction framing conventions that differ across large language model families. The context limits parameter specifies the maximum context length and any segment level length constraints of the target large language model, enabling the inter-model adaptation module 818 to apply compression or restructuring to ensure the adapted input fits within the target large language model context window. The inference settings parameter specifies generation configuration values applicable to the target large language model, including temperature, top p sampling thresholds, and any model specific decoding parameters. The endpoint URL parameter provides the API endpoint address for invoking the target large language model 820 following production of the runtime adapted input.

The model registry and runtime adaptation system 800 receives a runtime input 812 and applies the transformation model 814, also referred to as the transformation model 204 of FIG. 2A and the optimization model 226 of FIG. 2B, to produce a runtime optimized input 816, also referred to as the improved input 228 of FIG. 2B. The transformation model 814 applies a single forward pass to the runtime input 812 without querying the target large language model 820 during the applying. The transformation model 814 uses the context size and token limits fields from the metadata store 810 to constrain the token count of the runtime optimized input 816 to the capacity of the target large language model 820, ensuring that the runtime optimized input 816 produced by the single forward pass does not exceed the context window of the target large language model 820.

The runtime optimized input 816 is passed to the inter-model adaptation module 818, also referred to as the inter-model adaptation module 208 of FIG. 2A and the model adapter 232 of FIG. 2B, together with the adaptation parameters 808 retrieved from the model registry 806. The inter-model adaptation module 818 applies the learned adaptation transformation described with reference to FIG. 7 to restructure the runtime optimized input 816 for the target large language model 820, using the tokenizer format, prompt structure, context limits, and inference settings provided by the adaptation parameters 808 to configure the restructuring operation for the specific characteristics of the target large language model 820. The inter-model adaptation module 818 produces a runtime adapted input, labeled in FIG. 8 as “Adapted Input,” that is configured for the target large language model 820 identified as LLM A, LLM B, or LLM C depending on the target specification 802, and outputs the runtime adapted input to the target large language model 820 for invocation.

The target large language model 820 receives the runtime adapted input via the API endpoint specified by the endpoint URL parameter of the adaptation parameters 808 and generates a response. The model registry and runtime adaptation system 800 thus provides a unified lookup and configuration mechanism that enables the inter-model adaptation module 818 to adapt runtime optimized inputs for any large language model registered in the model registry 806 without requiring retraining, by resolving the target specification 802 to a complete set of model specific adaptation parameters 808 at runtime and applying those parameters to configure the restructuring and adaptation operations of the inter-model adaptation module 818.

### Runtime Processing Flowchart

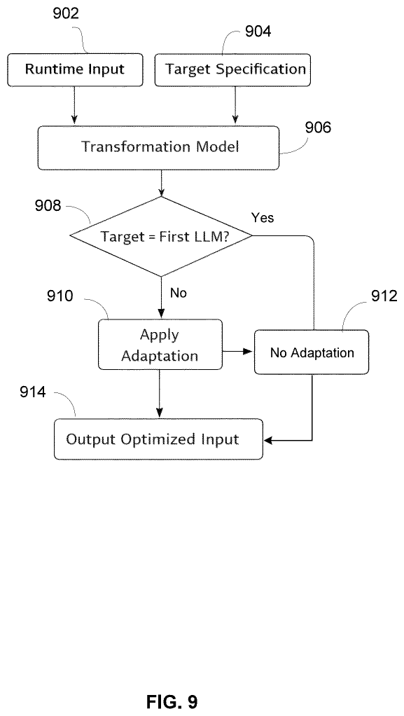

FIG. 9 illustrates a runtime processing flowchart 900 depicting the sequence of operations performed at runtime to transform a runtime input into either a runtime optimized input or a runtime adapted input for invocation of a target large language model. The runtime processing flowchart 900 corresponds to the runtime processing flow described with reference to FIG. 2B and provides a concise procedural view of the decision logic governing whether inter-model adaptation is applied. The runtime processing flowchart 900 is implemented by the trained transformation model 204 and the inter-model adaptation module 208 described with reference to FIG. 2A, and executes entirely without querying the target large language model during the transformation and adaptation steps.

The runtime processing flowchart 900 begins with two parallel inputs: a runtime input 902 and a target specification 904, also referred to as the target specification 224 of FIG. 2B and the target specification 802 of FIG. 8. The runtime input 902 comprises the input to be optimized, which may include a prompt component and a contextual data component. The target specification 904 identifies the target large language model for which the runtime input 902 is to be optimized and adapted, comprising at least one of a model identifier, a model architecture descriptor, a model capability profile, or an API endpoint specification.

The runtime input 902 and the target specification 904 are jointly received by a transformation model 906, also referred to as the transformation model 204 of FIG. 2A and the transformation model 814 of FIG. 8. The transformation model 906 applies a single forward pass to the runtime input 902 to produce a runtime optimized input without iteratively optimizing the runtime input 902 and without querying the target large language model during the application. The transformation model 906 uses the target specification 904 to determine the token budget and structural constraints applicable to the target large language model, consistent with the metadata store 810 described with reference to FIG. 8.

The runtime processing flowchart 900 proceeds to a decision 908 that evaluates whether the target large language model identified by the target specification 904 is the same as the first large language model for which the transformation model 906 was trained, labeled in FIG. 9 as “Target=First LLM?” The decision 908 corresponds to the decision 230 of the FIG. 2B runtime processing flow. When the decision 908 evaluates to ‘No,’ indicating that the target large language model is the same as the first large language model, the runtime processing flowchart 900 proceeds to apply adaptation 910, which outputs the transformed input directly without restructuring. When the decision 908 evaluates to ‘Yes,’ indicating that the target large language model is different from the first large language model, the runtime processing flowchart 900 proceeds to apply adaptation 912. In one embodiment, when the target large language model is the same as the first large language model, the apply adaptation step 910 is a pass-through that outputs the runtime optimized input directly without restructuring. When the decision 908 evaluates to “No,” indicating that the target large language model is different from the first large language model, the runtime processing flowchart 900 proceeds to apply adaptation 912, which invokes the inter-model adaptation module 208, also referred to as the inter-model adaptation module 818 of FIG. 8 and the model adapter 232 of FIG. 2B, to restructure the runtime optimized input to account for differences in tokenization schemes, context window sizes, or interpretive characteristics between the first large language model and the target large language. The apply adaptation 912 further generates a confidence score and outputs the runtime adapted input to output optimized input 914 only when the confidence score exceeds a predetermined threshold.

Both the “Yes” path through apply adaptation 910 and the “No” path through apply adaptation 912 converge at output optimized input 914, which represents either the runtime optimized input produced by the transformation model 906 when no adaptation is required or the runtime adapted input produced by the inter-model adaptation module 208 when the target large language model is different from the first large language model. The output optimized input 914, also referred to as the runtime optimized input or the runtime adapted input depending on the path taken through the runtime processing flowchart 900, is forwarded for invocation of the target large language model.

### Token Reduction and Semantic Preservation Example

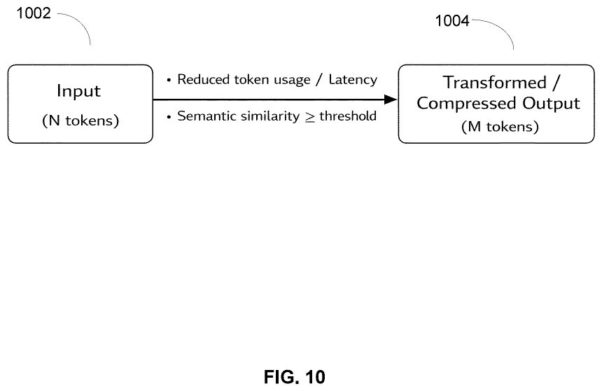

FIG. 10 illustrates a token reduction and semantic preservation example 1000 depicting a representative result of applying a transformation model to an input to produce a transformed input, also referred to as a compressed output, that requires fewer computational resources for a target language model to process than the input. The token reduction and semantic preservation example 1000 provides a concrete quantitative illustration of two properties of the transformed input produced by the transformation model: a reduction in token usage and inference latency relative to the input, and a preservation of semantic similarity between the input and the transformed input at or above a predetermined threshold.

The token reduction and semantic preservation example 1000 comprises an input 1002 having a token count of N tokens, depicted as a document representation labeled “Input (N tokens)” in FIG. 10. The input 1002 corresponds to the input received by the transformation model as described with reference to FIG. 2B and FIG. 3, and may comprise any of the input types described with reference to FIG. 3, including natural language text, programming code, structured data in a machine-readable format, or a multimodal input. In embodiments wherein the input 1002 is a context window from an agentic workflow, the N tokens of the input 1002 represent the accumulated token count of the interaction history from two or more prior agent steps as described with reference to FIG. 2B, wherein the token count N may grow substantially across workflow steps as reasoning traces, tool observations, retrieved documents, memory elements, and environment state data accumulate in the context window. Without transformation, submitting the input 1002 of N tokens to the target language model would incur a computational cost and inference latency proportional to N, which may exceed the context window capacity of the target language model or cause degraded response quality due to attention dilution across a large token sequence.

The transformation model applies a single forward pass to the input 1002 to produce a transformed input 1004, also referred to as a compressed output 1004, having a token count of M tokens, wherein M is less than N as recited in Claim 6 of the present disclosure. The transformed input 1004 is depicted as a document representation labeled “Transformed/Compressed Output (M tokens)” in FIG. 10. The relationship between the input 1002 and the transformed input 1004 is depicted by an arrow annotated with two properties: “Reduced token usage/Latency” and “Semantic similarity≥threshold.” The reduced token count M of the transformed input 1004 relative to the token count N of the input 1002 directly reduces the computational resources required for the target language model to process the transformed input 1004, as recited in claim 1, by decreasing the number of tokens that the target language model must process during inference, thereby reducing token usage and inference latency. The values of N and M are not fixed and vary based on the content and structure of the input 1002, the task specified by a task identifier when present, and the compression behavior of the transformation model learned from the paired training data. In one embodiment, the transformation model achieves a reduction of at least 30 percent in token count, wherein M is at most 70 percent of N, while preserving the information sufficient for the target language model to complete the task. In practice, the degree of token count reduction may be higher when the input 1002 contains significant redundancy, low-relevance content, or accumulated contextual data from prior agent steps that is not relevant to the upcoming task.

The “Semantic similarity≥threshold” annotation in FIG. 10 indicates that the transformation model constrains the production of the transformed input 1004 such that the semantic similarity between the input 1002 and the transformed input 1004 meets or exceeds a predetermined threshold. The semantic similarity constraint ensures that the transformed input 1004 preserves information sufficient to produce a response from the target language model that is equivalent to the response the target language model would produce from the input 1002. In one embodiment, the semantic similarity is computed as the cosine similarity between embedding vector representations of the input 1002 and the transformed input 1004 produced by an embedding encoder, wherein the cosine similarity value ranges from zero to one and values at or above the predetermined threshold indicate that the transformed input 1004 preserves sufficient semantic content for equivalent response generation. In another embodiment, the semantic similarity is computed as a measure of output similarity between an output produced by the target language model in response to the transformed input 1004 and a reference output produced by the target language model in response to the input 1002, wherein the output similarity is computed by applying the target language model in inference mode as described with reference to FIG. 4. The predetermined threshold is a configurable value set during training of the transformation model on the paired training data and may be adjusted based on the quality requirements of the application context and the acceptable degree of information loss for the specified task. The combination of reduced token usage and latency with semantic similarity at or above the predetermined threshold represents the dual optimization objective of the transformation model: minimizing the computational cost of invoking the target language model while preserving the semantic content of the input 1002 to a degree sufficient to produce an equivalent response from the target language model.

The token reduction and semantic preservation properties depicted in FIG. 10 apply regardless of whether the transformed input 1004 is provided directly to the target language model as the transformed input or is further processed by an adaptation model to produce an adapted input for a second target language model different from the first language model for which the transformation model was trained, as described with reference to FIG. 2B. In both cases, the transformation model produces the transformed input 1004 having M tokens from the input 1002 having N tokens in a single forward pass, wherein M is less than N and the semantic similarity between the input 1002 and the transformed input 1004 meets or exceeds the predetermined threshold, and wherein the transformed input 1004 requires fewer computational resources for the target language model to process than the input 1002.

### Confidence Score Threshold Flowchart

FIG. 11 illustrates a confidence score threshold flowchart 1100 depicting the decision logic by which the inter-model adaptation module 208, also referred to as the inter-model adaptation module 818 of FIG. 8, determines whether a runtime adapted input is of sufficient quality to be forwarded to the target large language model or whether a fallback action is required. The confidence score threshold flowchart 1100 provides a detailed procedural view of the confidence score mechanism.

The confidence score threshold flowchart 1100 begins with an adapted input 1102, also referred to as the runtime adapted input produced by the inter-model adaptation module 208 following the adaptation of the runtime optimized input 816 of FIG. 8 and the apply adaptation 912 step of FIG. 9. The adapted input 1102 is passed to a confidence model 1104. The confidence model 1104 is a learned scoring component of the inter-model adaptation module 208 that evaluates the adapted input 1102 and produces a confidence score indicating a predicted quality of the runtime adapted input for the target large language model. In one embodiment, the confidence model 1104 is implemented as a learned regression head applied to the embedding representation of the adapted input 1102 produced by the embedding encoder 706 of FIG. 7, outputting a scalar confidence score in the range of zero to one. In another embodiment, the confidence model 1104 is implemented as a separate neural network trained on historical input response pairs to predict whether an adapted input will produce a response of acceptable quality from the target large language model.

The confidence score produced by the confidence model 1104 is evaluated at a threshold comparison 1106. The threshold comparison 1106 compares the confidence score against a predetermined threshold to determine whether the adapted input 1102 meets the minimum quality criterion required for forwarding to the target large language model. The predetermined threshold is a configurable value set during system deployment and may be adjusted based on the quality requirements of the application context and the characteristics of the target large language model. When the confidence score is greater than or equal to the predetermined threshold, the threshold comparison 1106 routes the adapted input 1102 to output 1108, wherein the runtime adapted input is output for invocation of the target large language model. When the confidence score is less than the predetermined threshold, the threshold comparison 1106 routes the processing to fallback 1110, wherein a fallback action is applied instead of forwarding the low confidence adapted input to the target large language model.

The fallback 1110 represents the action taken when the confidence score does not exceed the predetermined threshold. In one embodiment, the fallback 1110 submits the runtime optimized input 816 directly to the target large language model without adaptation, bypassing the inter-model adaptation module 208 to avoid the risk of degraded adaptation quality. In another embodiment, the fallback 1110 triggers a re-adaptation attempt using updated adaptation parameters 808 retrieved from the model registry 806 of FIG. 8 with modified configuration. In a further embodiment, the fallback 1110 returns an error signal to the invoking system indicating that adaptation quality is insufficient and requesting a revised target specification 802. Both the output 1108 path and the fallback 1110 path converge at end 1112, which represents the termination of the confidence score threshold evaluation process and the handoff of either the runtime adapted input or the fallback output to the downstream invocation of the target large language model.

### Continuous Learning Pipeline

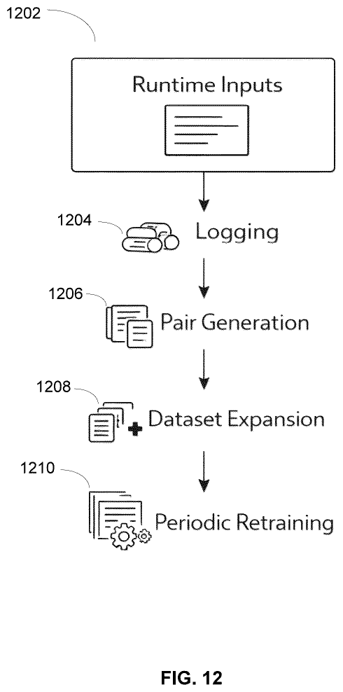

FIG. 12 illustrates a continuous learning pipeline 1200 depicting the sequence of operations by which runtime inputs and runtime optimized inputs generated during production deployment are used to update the paired dataset and retrain the transformation model 204, enabling the transformation model 204 to improve its optimization accuracy over time. The continuous learning pipeline 1200 corresponds to the continuous learning mechanism.

The continuous learning pipeline 1200 begins with runtime inputs 1202, also referred to as the runtime inputs received during production deployment of the transformation model 204. The runtime inputs 1202 represent the stream of inputs processed by the transformation model 204 during normal operation, including both the original runtime inputs received from the invoking system and the corresponding runtime optimized inputs produced by the transformation model 204 in response to each runtime input.

The runtime inputs 1202 are processed by logging 1204, depicted as a logging component that records each runtime input together with its corresponding runtime optimized input and associated metadata, including the target specification, token count reduction achieved, and any quality metrics computed from the response produced by the target large language model following invocation with the runtime optimized input. The logging 1204 component maintains a persistent log of runtime input and runtime optimized input pairs that accumulates over the deployment period, providing a growing corpus of production input output pairs for use in updating the paired dataset.

The logged runtime input and runtime optimized input pairs are passed to pair generation 1206, which evaluates the logged pairs to identify those suitable for inclusion in the updated paired dataset. The pair generation 1206 applies quality filtering criteria consistent with the evaluation process of the paired dataset constructor 202, retaining pairs in which the runtime optimized input improves response quality or reduces computational cost relative to the runtime input, and discarding pairs that do not meet minimum quality thresholds. The pair generation 1206 produces a set of additional pairs of the form, wherein each additional pair comprises a runtime input and a corresponding runtime optimized input generated from that runtime input.

The additional pairs produced by pair generation 1206 are passed to dataset expansion 1208, which incorporates the additional pairs into the existing paired dataset to produce an updated paired dataset comprising both the original pairs from the offline training phase and the additional pairs generated from runtime inputs. The dataset expansion 1208 may apply deduplication to remove pairs that duplicate or closely resemble pairs already present in the paired dataset, ensuring that the updated paired dataset reflects a diverse range of input types and optimization patterns. The updated paired dataset produced by dataset expansion 1208 is larger and more representative of the distribution of inputs encountered in production deployment than the original paired dataset used in the offline training phase.

The updated paired dataset is passed to periodic retraining 1210, which retrains the transformation model 204 on the updated paired dataset. The periodic retraining 1210 executes on a scheduled basis, such as daily, weekly, or after a predetermined number of additional pairs have been accumulated by dataset expansion 1208, rather than continuously, to avoid disrupting the production deployment of the transformation model 204 during active inference. The periodic retraining 1210 may apply fine tuning of the existing transformation model 204 parameters on the additional pairs rather than full retraining from random initialization, reducing computational cost while incorporating the distribution shift captured in the runtime input corpus. Upon completion of the periodic retraining 1210, the updated transformation model 204 is deployed to replace the prior version, and the continuous learning pipeline 1200 repeats with the updated transformation model 204 processing subsequent runtime inputs 1202.

### Plan-Aware Context Compression in Multi-Step Workflows

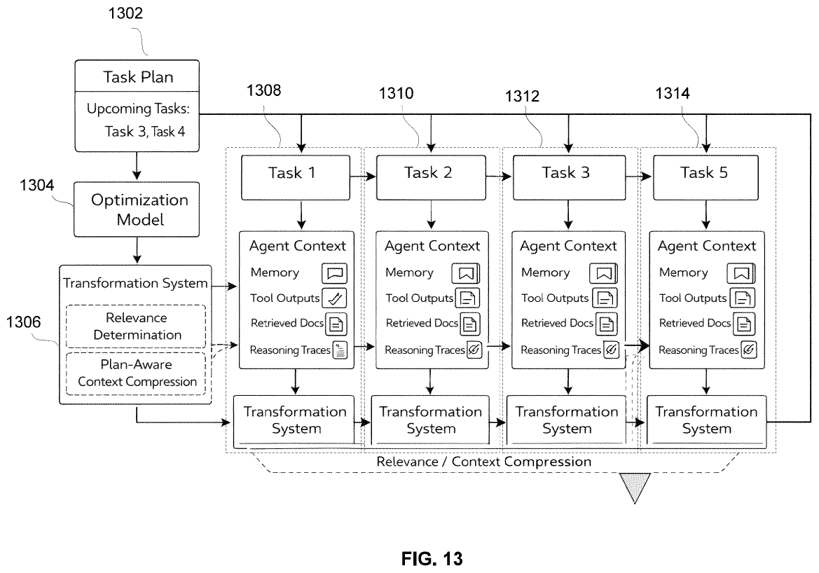

FIG. 13 illustrates a plan-aware context compression diagram 1300 depicting the application of the transformation model 204 to compress agent context across multiple sequential tasks in a multi-step workflow. The plan-aware context compression diagram 1300 provides a detailed operational view of the relevance determination and context compression functions of the optimization model 226 described with reference to § 0040 through § 0046 of the FIG. 2B description, instantiated across a concrete multi-task workflow sequence.

The plan-aware context compression diagram 1300 receives a task plan 1302, also referred to as the task plan 222 of FIG. 2B, indicating the upcoming tasks in the workflow sequence. The task plan 1302 is depicted in FIG. 13 as specifying upcoming tasks comprising Task 3 and Task 4, indicating that the system is currently preparing context for execution of Task 3 and Task 4 and that preceding task outputs are available for compression. The task plan 1302 is provided to an optimization model 1304, also referred to as the optimization model 226 of FIG. 2B and the transformation model 204 of FIG. 2A. The optimization model 1304 instantiates a transformation system 1306 comprising two functions operating in concert: a relevance determination function and a plan-aware context compression function. The relevance determination function computes a relevance score for each portion of the agent context accumulated during prior tasks, comparing each context portion against the upcoming task descriptions in the task plan 1302 using the learned similarity measure. The plan-aware context compression function then compresses or removes context portions having relevance scores below the applicable threshold while retaining context portions that are likely to be needed for the execution of the upcoming tasks identified in the task plan 1302.

FIG. 13 depicts four task columns corresponding to Task 1 at 1308, Task 2 at 1310, Task 3 at 1312, and Task 5 at 1314, each containing an agent context block and a transformation system block. Each agent context block comprises four context component types: memory, tool outputs, retrieved documents, and reasoning traces, corresponding to the contextual data component types, namely outputs from prior task executions, memory elements, retrieved documents, and reasoning traces. Each context component is depicted with a checkmark or other indicator reflecting its retention status following application of the relevance determination function, wherein components that are relevant to the upcoming tasks identified in the task plan 1302 are retained and components that are not relevant are compressed or removed by the plan-aware context compression function. Each task column includes a transformation system block that applies the optimization model 1304 to the agent context of that task, compressing the accumulated context before it is passed forward to the next task in the workflow sequence. The arrow labeled “Relevance/Context Compression” spanning the bottom of the task columns in FIG. 13 indicates that the transformation system 1306 operates continuously across the task sequence, applying plan-aware context compression at each task transition to maintain a compressed but semantically complete agent context throughout the multi-step workflow execution. The context compression at each task transition reduces the token count of the agent context supplied to the target large language model at each task step, reducing inference cost and preventing context window overflow while preserving the information necessary for the target large language model to produce accurate responses to each upcoming task as recited in the FIG. 2B description.

### Deployment Configurations

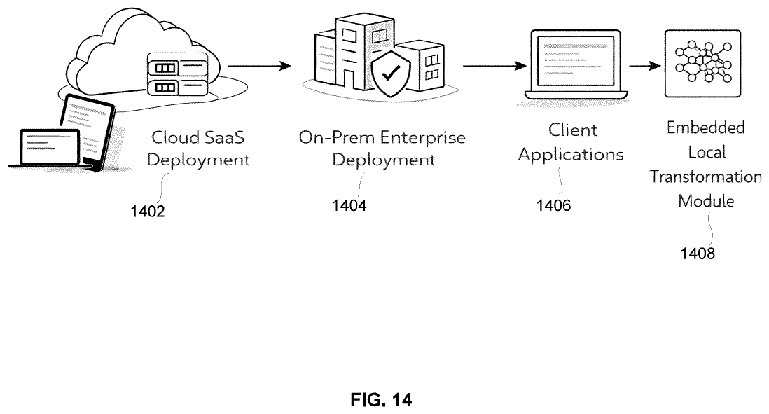

FIG. 14 illustrates a deployment configurations diagram 1400 depicting three distinct deployment configurations through which the transformation model 204 and the inter-model adaptation module 208 may be deployed to serve different operational environments and data governance requirements.

The deployment configurations diagram 1400 depicts three deployment configurations arranged in a left-to-right sequence representing decreasing infrastructure scale and increasing operational proximity to the end user application. A first deployment configuration is a cloud software-as-a-service deployment 1402, depicted as a cloud infrastructure icon in FIG. 14, in which the transformation model 204 and the inter-model adaptation module 208 are hosted on cloud infrastructure and made accessible to client applications through a network API. The cloud software-as-a-service deployment 1402 enables elastic scaling of computational resources to handle variable workloads, provides access to managed infrastructure services, and allows client applications to invoke the transformation and adaptation capabilities without hosting model artifacts locally. A second deployment configuration is an on-premises enterprise deployment 1404, depicted as an enterprise server icon in FIG. 14, in which the transformation model 204 and the inter-model adaptation module 208 are deployed within the customer's own data center or private cloud infrastructure. The on-premises enterprise deployment 1404 provides data sovereignty for enterprises with strict data governance requirements, ensuring that runtime inputs and runtime optimized inputs do not leave the customer's controlled infrastructure environment. The transformation model 204 and the inter-model adaptation module 208 are stored as separately deployable model artifacts in both the cloud software-as-a-service deployment 1402 and the on-premises enterprise deployment 1404, enabling independent updating and scaling of each component.

A third deployment configuration is an embedded local transformation module 1408, accessible through client applications 1406, in which the transformation model 204 is embedded directly within the client application as a locally executing model artifact. The embedded local transformation module 1408 enables transformation to be performed entirely on the client device without requiring network communication with a remote transformation service, reducing latency and enabling deployment in environments with limited or restricted network connectivity. The client applications 1406 represent the layer through which end users or invoking systems interact with the transformation capabilities, receiving the runtime optimized input or the runtime adapted input produced by whichever of the three deployment configurations is active and forwarding it to the target large language model for invocation. In one embodiment, the embedded local transformation module 1408 comprises a compressed or distilled version of the transformation model 204 that has been optimized for on-device inference through techniques such as quantization, knowledge distillation, or pruning, reducing model size and computational requirements to levels compatible with client device hardware while preserving acceptable optimization quality.

Cache-Assisted Runtime Optimization with Optional Validation Loop

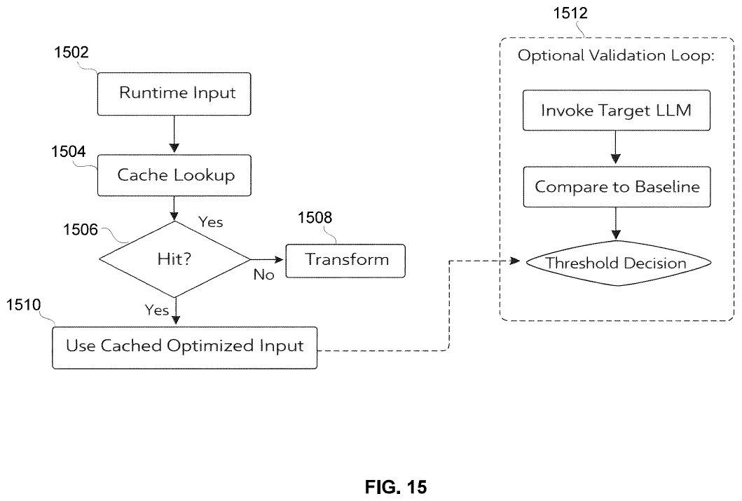

FIG. 15 illustrates a cache-assisted runtime optimization flowchart 1500 depicting an optional caching mechanism that accelerates the runtime optimization process by reusing previously computed runtime optimized inputs for runtime inputs that are identical or semantically equivalent to prior inputs, and an optional validation loop that verifies the quality of the runtime optimized input against a baseline before forwarding it to the target large language model.

The cache-assisted runtime optimization flowchart 1500 begins with a runtime input 1502, also referred to as the runtime input 902 of FIG. 9 and the runtime input 812 of FIG. 8. The runtime input 1502 is submitted to a cache lookup 1504 that queries a cache of previously computed runtime optimized inputs to determine whether a cached optimized input corresponding to the runtime input 1502 is available. The cache lookup 1504 may perform exact matching, comparing the token sequence of the runtime input 1502 against the token sequences of previously cached runtime inputs, or semantic matching, comparing the embedding representation of the runtime input 1502 against the embedding representations of previously cached runtime inputs using cosine similarity above a configurable threshold, to determine whether a sufficiently similar prior runtime input exists in the cache.

The cache lookup 1504 evaluates to a hit decision 1506 that determines whether the cache contains a usable cached optimized input for the runtime input 1502. When the hit decision 1506 evaluates to “Yes,” indicating that a cache hit has occurred, the cache-assisted runtime optimization flowchart 1500 proceeds to use cached optimized input 1510, retrieving the previously computed runtime optimized input from the cache and forwarding it directly as the output of the optimization step, bypassing the transformation model 906 entirely and eliminating the computational cost of the single forward pass. When the hit decision 1506 evaluates to “No,” indicating that no usable cached optimized input is available, the cache-assisted runtime optimization flowchart 1500 proceeds to transform 1508, which applies the transformation model 204 to the runtime input 1502 to produce a new runtime optimized input through the single forward pass, and stores the resulting runtime input and runtime optimized input pair in the cache for potential reuse by future runtime inputs.

FIG. 15 further depicts an optional validation loop 1512, shown in a dashed boundary to indicate its optional nature. The optional validation loop 1512 comprises three sequential steps: invoke target large language model, compare to baseline, and threshold decision. The invoke target large language model step invokes the target large language model with the runtime optimized input produced by either the transform 1508 step or the use cached optimized input 1510 step and records the resulting response. The compare to baseline step compares the response produced from the runtime optimized input against a baseline response produced from the original runtime input 1502 without optimization, computing a semantic equivalence metric measuring similarity between the two responses consistent with the semantic equivalence metric. The threshold decision step evaluates whether the semantic equivalence metric meets a configurable threshold indicating that the runtime optimized input preserves sufficient semantic content to produce an equivalent response from the target large language model. When the threshold decision determines that the semantic equivalence metric meets the threshold, the runtime optimized input is confirmed as acceptable and forwarded for invocation. When the semantic equivalence metric does not meet the threshold, the optional validation loop 1512 may trigger re-transformation of the runtime input 1502 using modified transformation parameters or may fall back to submitting the original runtime input 1502 to the target large language model without optimization. The optional validation loop 1512 is designated as optional because in the primary zero-shot operating mode the transformation model 204 produces the runtime optimized input in a single forward pass without querying the target large language model, and the optional validation loop 1512 is activated only in deployment configurations where quality verification against a live target large language model response is required by the application context.

The systems and methods described herein are implemented on one or more computing systems comprising one or more processors and one or more non-transitory computer-readable media storing instructions that, when executed by the one or more processors, cause the computing system to perform the operations described herein, wherein the one or more processors may comprise central processing units, graphics processing units, tensor processing units, or other hardware accelerators suitable for the matrix multiplication, attention computation, and gradient-based optimization operations performed by the transformation model and the inter-model adaptation module. The computing systems may be deployed in cloud computing environments, on-premises data centers, hybrid infrastructure configurations, or embedded client device environments, and may utilize machine learning frameworks including TensorFlow, PyTorch, JAX, or ONNX Runtime for training and inference, and model serving infrastructure such as TensorFlow Serving, TorchServe, or NVIDIA Triton Inference Server for production deployment, with the transformation model and the inter-model adaptation module stored as separately deployable model artifacts that may be independently updated, scaled, and loaded on demand in accordance with the deployment configurations described herein.

### Machine Learning Techniques

Some implementations of the technology disclosed relate to using a Transformer model to provide an AI system. In particular, the technology disclosed proposes an AI management system based on the Transformer architecture. The Transformer model relies on a self-attention mechanism to compute a series of context-informed vector-space representations of elements in the input sequence and the output sequence, which are then used to predict distributions over subsequent elements as the model predicts the output sequence element-by-element. Not only is this mechanism straightforward to parallelize, but as each input's representation is also directly informed by all other inputs' representations, this results in an effectively global receptive field across the whole input sequence. This stands in contrast to, e.g., convolutional architectures which typically only have a limited receptive field.

In one implementation, the disclosed AI system is a multilayer perceptron (MLP). In another implementation, the disclosed AI system is a feedforward neural network. In yet another implementation, the disclosed AI system is a fully connected neural network. In a further implementation, the disclosed AI system is a fully convolution neural network. In a yet further implementation, the disclosed AI system is a semantic segmentation neural network. In a yet another further implementation, the disclosed AI system is a generative adversarial network (GAN) (e.g., CycleGAN, StyleGAN, pixelRNN, text-2-image, DiscoGAN, IsGAN). In a yet another implementation, the disclosed AI system includes self-attention mechanisms like Transformer, Vision Transformer (ViT), Bidirectional Transformer (BERT), Detection Transformer (DETR), Deformable DETR, UP-DETR, DeiT, Swin, GPT, iGPT, GPT-2, GPT-3, various ChatGPT versions, various LLaMA versions, BERT, SpanBERT, RoBERTa, XLNet, ELECTRA, UniLM, BART, T5, ERNIE (THU), KnowBERT, DeiT-Ti, DeiT-S, DeiT-B, T2T-ViT-14, T2T-ViT-19, T2T-ViT-24, PVT-Small, PVT-Medium, PVT-Large, TNT-S, TNT-B, CPVT-S, CPVT-S-GAP, CPVT-B, Swin-T, Swin-S, Swin-B, Twins-SVT-S, Twins-SVT-B, Twins-SVT-L, Shuffle-T, Shuffle-S, Shuffle-B, XCiT-S12/16, CMT-S, CMT-B, VOLO-D1, VOLO-D2, VOLO-D3, VOLO-D4, MoCo v3, ACT, TSP, Max-DeepLab, VisTR, SETR, Hand-Transformer, HOT-Net, METRO, Image Transformer, Taming transformer, TransGAN, IPT, TTSR, STTN, Masked Transformer, CLIP, DALL-E, Cogview, UniT, ASH, TinyBert, FullyQT, ConvBert, FCOS, Faster R-CNN+FPN, DETR-DC5, TSP-FCOS, TSP-RCNN, ACT+MKDD (L=32), ACT+MKDD (L=16), SMCA, Efficient DETR, UP-DETR, UP-DETR, ViTB/16-FRCNN, ViT-B/16-FRCNN, PVT-Small+RetinaNet, Swin-T+RetinaNet, Swin-T+ATSS, PVT-Small+DETR, TNT-S+DETR, YOLOS-Ti, YOLOS-S, and YOLOS-B.

In one implementation, the disclosed AI system is a convolution neural network (CNN) with a plurality of convolution layers. In another implementation, the disclosed AI system is a recurrent neural network (RNN) such as a long short-term memory network (LSTM), bi-directional LSTM (Bi-LSTM), or a gated recurrent unit (GRU). In yet another implementation, the disclosed AI system includes both a CNN and an RNN.

In yet other implementations, the disclosed AI system can use 1D convolutions, 2D convolutions, 3D convolutions, 4D convolutions, 5D convolutions, dilated or atrous convolutions, transpose convolutions, depthwise separable convolutions, pointwise convolutions, 1×1 convolutions, group convolutions, flattened convolutions, spatial and cross-channel convolutions, shuffled grouped convolutions, spatial separable convolutions, and deconvolutions. The disclosed AI system can use one or more loss functions such as logistic regression/log loss, multi-class cross-entropy/softmax loss, binary cross-entropy loss, mean-squared error loss, L1 loss, L2 loss, smooth L1 loss, and Huber loss. The disclosed AI system can use any parallelism, efficiency, and compression schemes such TFRecords, compressed encoding (e.g., PNG), sharding, parallel calls for map transformation, batching, prefetching, model parallelism, data parallelism, and synchronous/asynchronous stochastic gradient descent (SGD). The disclosed AI system can include upsampling layers, downsampling layers, recurrent connections, gates and gated memory units (like an LSTM or GRU), residual blocks, residual connections, highway connections, skip connections, peephole connections, activation functions (e.g., non-linear transformation functions like rectifying linear unit (ReLU), leaky ReLU, exponential liner unit (ELU), sigmoid and hyperbolic tangent (tanh)), batch normalization layers, regularization layers, dropout, pooling layers (e.g., max or average pooling), global average pooling layers, and attention mechanisms.

The disclosed AI system can be a linear regression model, a logistic regression model, an Elastic Net model, a support vector machine (SVM), a random forest (RF), a decision tree, and a boosted decision tree (e.g., XGBoost), or some other tree-based logic (e.g., metric trees, kd-trees, R-trees, universal B-trees, X-trees, ball trees, locality sensitive hashes, and inverted indexes). The disclosed AI system can be an ensemble of multiple models, in some implementations.

In some implementations, the disclosed AI system can be trained using backpropagation-based gradient update techniques. Example gradient descent techniques that can be used for training the disclosed AI system include stochastic gradient descent, batch gradient descent, and mini-batch gradient descent. Some examples of gradient descent optimization algorithms that can be used to train the disclosed AI system are Momentum, Nesterov accelerated gradient, Adagrad, Adadelta, RMSprop, Adam, AdaMax, Nadam, and AMSGrad.

### Transformer Logic

Machine learning is the use and development of computer systems that can learn and adapt without following explicit instructions, by using algorithms and statistical models to analyze and draw inferences from patterns in data. Some of the state-of-the-art models use Transformers, a more powerful and faster model than neural networks alone. Transformers originate from the field of natural language processing (NLP), but can be used in computer vision and many other fields. Neural networks process input in series and weight relationships by distance in the series. Transformers can process input in parallel and do not necessarily weigh by distance. For example, in natural language processing, neural networks process a sentence from beginning to end with the weights of words close to each other being higher than those further apart. This leaves the end of the sentence very disconnected from the beginning causing an effect called the vanishing gradient problem. Transformers look at each word in parallel and determine weights for the relationships to each of the other words in the sentence. These relationships are called hidden states because they are later condensed for use into one vector called the context vector. Transformers can be used in addition to neural networks. This architecture is described here.

### Encoder-Decoder Architecture

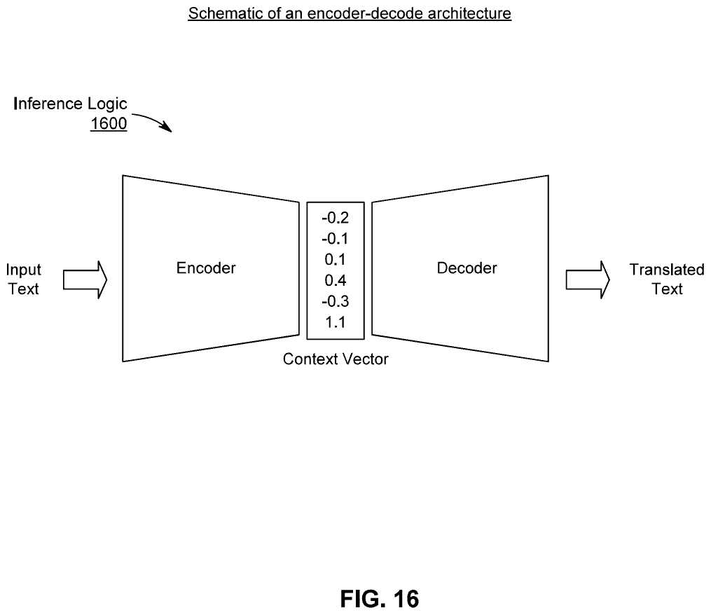

FIG. 16 is a schematic representation of an encoder-decoder architecture. This architecture is often used for NLP and has two main building blocks. The first building block is the encoder that encodes an input into a fixed-size vector. In the system we describe here, the encoder is based on a recurrent neural network (RNN). At each time step, t, a hidden state of time step, t−1, is combined with the input value at time step t to compute the hidden state at timestep t. The hidden state at the last time step, encoded in a context vector, contains relationships encoded at all previous time steps. For NLP, each step corresponds to a word. Then the context vector contains information about the grammar and the sentence structure. The context vector can be considered a low-dimensional representation of the entire input space. For NLP, the input space is a sentence, and a training set consists of many sentences.

The context vector is then passed to the second building block, the decoder. For translation, the decoder has been trained on a second language. Conditioned on the input context vector, the decoder generates an output sequence. At each time step, t, the decoder is fed the hidden state of time step, t−1, and the output generated at time step, t−1. The first hidden state in the decoder is the context vector, generated by the encoder. The context vector is used by the decoder to perform the translation.

The whole model is optimized end-to-end by using backpropagation, a method of training a neural network in which the initial system output is compared to the desired output and the system is adjusted until the difference is minimized. In backpropagation, the encoder is trained to extract the right information from the input sequence, the decoder is trained to capture the grammar and vocabulary of the output language. This results in a fluent model that uses context and generalizes well. When training an encoder-decoder model, the real output sequence is used to train the model to prevent mistakes from stacking. When testing the model, the previously predicted output value is used to predict the next one.

When performing a translation task using the encoder-decoder architecture, all information about the input sequence is forced into one vector, the context vector. Information connecting the beginning of the sentence with the end is lost, the vanishing gradient problem. Also, different parts of the input sequence are important for different parts of the output sequence, information that cannot be learned using only RNNs in an encoder-decoder architecture.

### Attention Mechanism

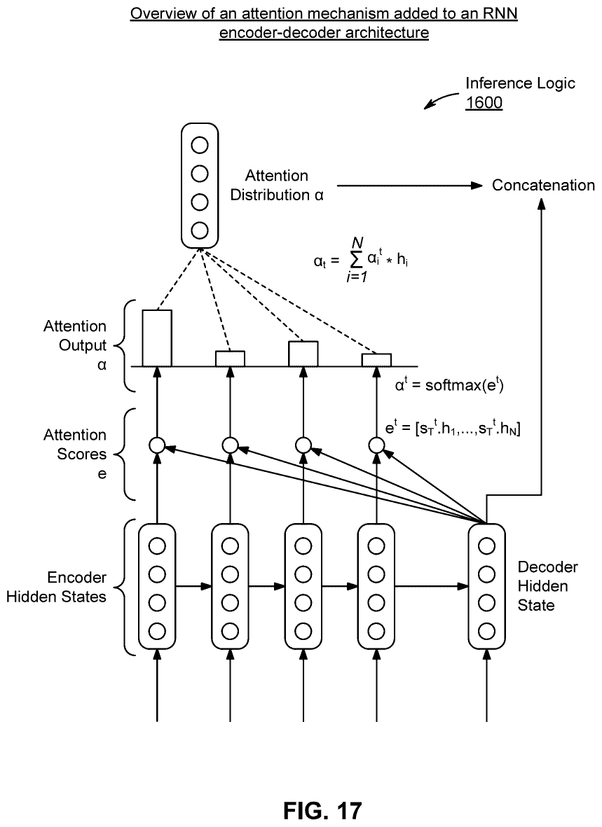

Attention mechanisms distinguish Transformers from other machine learning models. The attention mechanism provides a solution for the vanishing gradient problem. FIG. 17 shows an overview of an attention mechanism added to an RNN encoder-decoder architecture. At every step, the decoder is given an attention score, e, for each encoder hidden state. In other words, the decoder is given weights for each relationship between words in a sentence. The decoder uses the attention score concatenated with the context vector during decoding. The output of the decoder at time step t is based on all encoder hidden states and the attention outputs. The attention output captures the relevant context for time step t from the original sentence. Thus, words at the end of a sentence may now have a strong relationship with words at the beginning of the sentence. In the sentence “The quick brown fox, upon arriving at the doghouse, jumped over the lazy dog,” fox and dog can be closely related despite being far apart in this complex sentence.

To weight encoder hidden states, a dot product between the decoder hidden state of the current time step, and all encoder hidden states, is calculated. This results in an attention score for every encoder hidden state. The attention scores are higher for those encoder hidden states that are similar to the decoder hidden state of the current time step. Higher values for the dot product indicate the vectors are pointing more closely in the same direction. The attention scores are converted to fractions that sum to one using the SoftMax function.

The SoftMax scores provide an attention distribution. The x-axis of the distribution is position in a sentence. The y-axis is attention weight. The scores show which encoder hidden states are most closely related. The SoftMax scores specify which encoder hidden states are the most relevant for the decoder hidden state of the current time step.

The elements of the attention distribution are used as weights to calculate a weighted sum over the different encoder hidden states. The outcome of the weighted sum is called the attention output. The attention output is used to predict the output, often in combination (concatenation) with the decoder hidden states. Thus, both information about the inputs, as well as the already generated outputs, can be used to predict the next outputs.

By making it possible to focus on specific parts of the input in every decoder step, the attention mechanism solves the vanishing gradient problem. By using attention, information flows more directly to the decoder. It does not pass through many hidden states. Interpreting the attention step can give insights into the data. Attention can be thought of as a soft alignment. The words in the input sequence with a high attention score align with the current target word. Attention describes long-range dependencies better than RNN alone. This enables analysis of longer, more complex sentences.

The attention mechanism can be generalized as: given a set of vector values and a vector query, attention is a technique to compute a weighted sum of the vector values, dependent on the vector query. The vector values are the encoder hidden states, and the vector query is the decoder hidden state at the current time step.

The weighted sum can be considered a selective summary of the information present in the vector values. The vector query determines on which of the vector values to focus. Thus, a fixed-size representation of the vector values can be created, in dependence upon the vector query.

The attention scores can be calculated by the dot product, or by weighing the different values (multiplicative attention).

### Embeddings

For most machine learning models, the input to the model needs to be numerical. The input to a translation model is a sentence, and words are not numerical. multiple methods exist for the conversion of words into numerical vectors. These numerical vectors are called the embeddings of the words. Embeddings can be used to convert any type of symbolic representation into a numerical one.

Embeddings can be created by using one-hot encoding. The one-hot vector representing the symbols has the same length as the total number of possible different symbols. Each position in the one-hot vector corresponds to a specific symbol. For example, when converting colors to a numerical vector, the length of the one-hot vector would be the total number of different colors present in the dataset. For each input, the location corresponding to the color of that value is one, whereas all the other locations are valued at zero. This works well for working with images. For NLP, this becomes problematic, because the number of words in a language is very large. This results in enormous models and the need for a lot of computational power. Furthermore, no specific information is captured with one-hot encoding. From the numerical representation, it is not clear that orange and red are more similar than orange and green. For this reason, other methods exist.

A second way of creating embeddings is by creating feature vectors. Every symbol has its specific vector representation, based on features. With colors, a vector of three elements could be used, where the elements represent the amount of yellow, red, and/or blue needed to create the color. Thus, all colors can be represented by only using a vector of three elements. Also, similar colors have similar representation vectors.

For NLP, embeddings based on context, as opposed to words, are small and can be trained. The reasoning behind this concept is that words with similar meanings occur in similar contexts. Different methods take the context of words into account. Some methods, like GloVe, base their context embedding on co-occurrence statistics from corpora (large texts) such as Wikipedia. Words with similar co-occurrence statistics have similar word embeddings. Other methods use neural networks to train the embeddings. For example, they train their embeddings to predict the word based on the context (Common Bag of Words), and/or to predict the context based on the word (Skip-Gram). Training these contextual embeddings is time intensive. For this reason, pre-trained libraries exist. Other deep learning methods can be used to create embeddings. For example, the latent space of a variational autoencoder (VAE) can be used as the embedding of the input. Another method is to use ID convolutions to create embeddings. This causes a sparse, high-dimensional input space to be converted to a denser, low-dimensional feature space.

### Self-Attention: Queries (Q), Keys (K), Values (V)

Transformer models are based on the principle of self-attention. Self-attention allows each element of the input sequence to look at all other elements in the input sequence and search for clues that can help it to create a more meaningful encoding. It is a way to look at which other sequence elements are relevant for the current element. The Transformer can grab context from both before and after the currently processed element.

When performing self-attention, three vectors need to be created for each element of the encoder input: the query vector (Q), the key vector (K), and the value vector (V). These vectors are created by performing matrix multiplications between the input embedding vectors using three unique weight matrices.

After this, self-attention scores are calculated. When calculating self-attention scores for a given element, the dot products between the query vector of this element and the key vectors of all other input elements are calculated. To make the model mathematically more stable, these self-attention scores are divided by the root of the size of the vectors. This has the effect of reducing the importance of the scalar thus emphasizing the importance of the direction of the vector. Just as before, these scores are normalized with a SoftMax layer. This attention distribution is then used to calculate a weighted sum of the value vectors, resulting in a vector z for every input element. In the attention principle explained above, the vector to calculate attention scores and to perform the weighted sum was the same, in self-attention two different vectors are created and used. As the self-attention needs to be calculated for all elements (thus a query for every element), one formula can be created to calculate a Z matrix. The rows of this Z matrix are the z vectors for every sequence input element, giving the matrix a size length sequence dimension QKV.

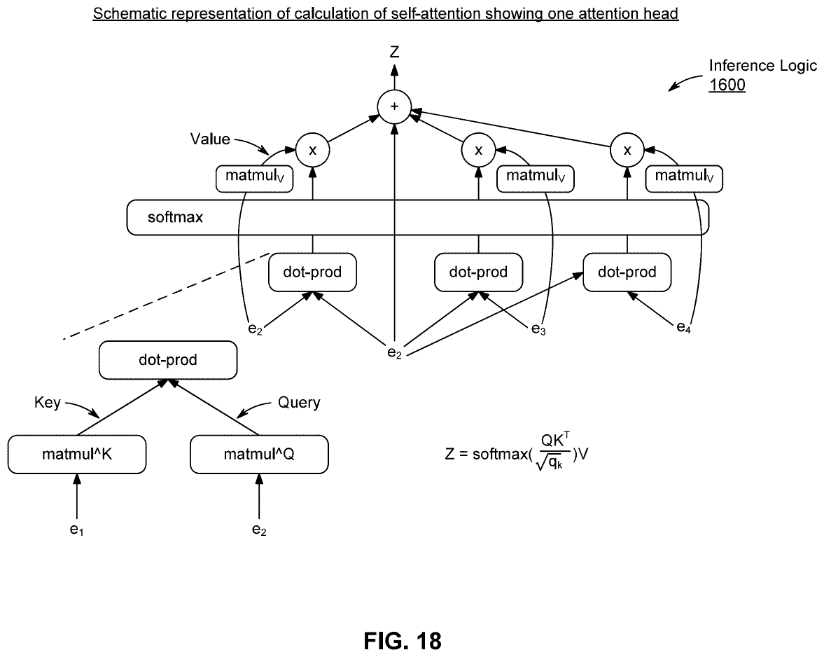

Multi-headed attention is executed in the Transformer. FIG. 18 is a schematic representation of the calculation of self-attention showing one attention head. For every attention head, different weight matrices are trained to calculate Q, K, and V. Every attention head outputs a matrix Z. Different attention heads can capture different types of information. The different Z matrices of the different attention heads are concatenated. This matrix can become large when multiple attention heads are used. To reduce dimensionality, an extra weight matrix W is trained to condense the different attention heads into a matrix with the same size as one Z matrix. This way, the amount of data given to the next step does not enlarge every time self-attention is performed.

When performing self-attention, information about the order of the different elements within the sequence is lost. To address this problem, positional encodings are added to the embedding vectors. Every position has its unique positional encoding vector. These vectors follow a specific pattern, which the Transformer model can learn to recognize. This way, the model can consider distances between the different elements.

As discussed above, in the core of self-attention are three objects: queries (Q), keys (K), and values (V). Each of these objects has an inner semantic meaning of their purpose. One can think of these as analogous to databases. We have a user-defined query of what the user wants to know. Then we have the relations in the database, i.e., the values which are the weights. More advanced database management systems create some apt representation of its relations to retrieve values more efficiently from the relations. This can be achieved by using indexes, which represent information about what is stored in the database. In the context of attention, indexes can be thought of as keys. So instead of running the query against values directly, the query is first executed on the indexes to retrieve where the relevant values or weights are stored. Lastly, these weights are run against the original values to retrieve data that is most relevant to the initial query.

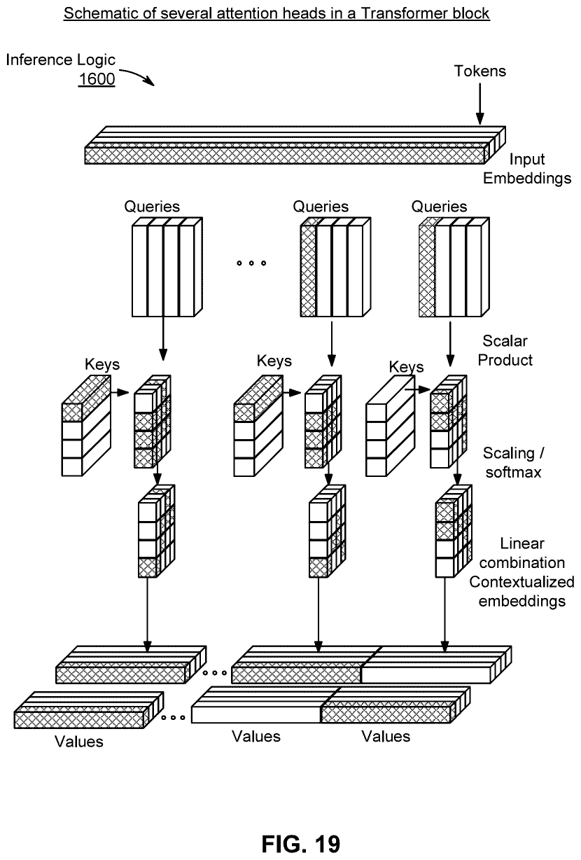

FIG. 19 depicts several attention heads in a Transformer block. We can see that the outputs of queries and keys dot products in different attention heads are differently colored. This depicts the capability of the multi-head attention to focus on different aspects of the input and aggregate the obtained information by multiplying the input with different attention weights.

Examples of attention calculation include scaled dot-product attention and additive attention. There are several reasons why scaled dot-product attention is used in the Transformers. Firstly, the scaled dot-product attention is relatively fast to compute, since its main parts are matrix operations that can be run on modern hardware accelerators. Secondly, it performs similarly well for smaller dimensions of the K matrix, dk, as the additive attention. For larger dk, the scaled dot-product attention performs a bit worse because dot products can cause the vanishing gradient problem. This is compensated via the scaling factor, which is defined as \sqrt{dk}.

As discussed above, the attention function takes as input three objects: key, value, and query. In the context of Transformers, these objects are matrices of shapes (n, d), where n is the number of elements in the input sequence and d is the hidden representation of each element (also called the hidden vector). Attention is then computed as:

$$Attention ( Q , K , V ) = SoftMax ( \frac{Q {K}^{T}}{\sqrt{dk}} ) V$$

where Q, K, V are computed as:

$$X \cdot {W}_{Q} , X \cdot {W}_{K} , X \cdot {W}_{V}$$

X is the input matrix and WQ, WK, WV are learned weights to project the input matrix into the representations. The dot products appearing in the attention function are exploited for their geometrical interpretation where higher values of their results mean that the inputs are more similar, i.e., pointing in the geometrical space in the same direction. Since the attention function now works with matrices, the dot product becomes matrix multiplication. The SoftMax function is used to normalize the attention weights into the value of 1 prior to being multiplied by the values matrix. The resulting matrix is used either as input into another layer of attention or becomes the output of the Transformer.

### Multi-Head Attention

Transformers become even more powerful when multi-head attention is used. Queries, keys, and values are computed the same way as above, though they are now projected into h different representations of smaller dimensions using a set of h learned weights. Each representation is passed into a different scaled dot-product attention block called a head. The head then computes its output using the same procedure as described above.

Formally, the multi-head attention is defined as:

MultiHeadAttention (Q, K, V)=[head1, . . . , headh]W0 where

$$headi = Attention ( {QW}_{i}^{Q} , {KW}_{i}^{K} , {VW}_{i}^{V} )$$

The outputs of all heads are concatenated together and projected again using the learned weights matrix W0 to match the dimensions expected by the next block of heads or the output of the Transformer. Using the multi-head attention instead of the simpler scaled dot-product attention enables Transformers to jointly attend to information from different representation subspaces at different positions.

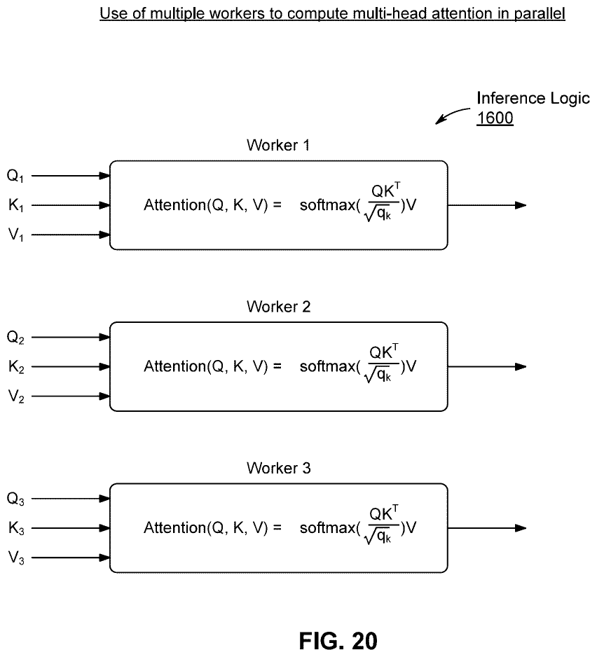

As shown in FIG. 20, one can use multiple workers to compute the multi-head attention in parallel, as the respective heads compute their outputs independently of one another. Parallel processing is one of the advantages of Transformers over RNNs.

Assuming the naive matrix multiplication algorithm which has a complexity of:

$$a \cdot b \cdot c$$

For matrices of shape (a, b) and (c, d), to obtain values Q, K, V, we need to compute the operations:

$$X \cdot WQ , X \cdot WK , X \cdot WV$$

The matrix X is of shape (n, d) where n is the number of patches and d is the hidden vector dimension. The weights WQ, WK, WV are all of shape (d, d). Omitting the constant factor 3, the resulting complexity is:

$$n \cdot d 2$$

We can proceed to the estimation of the complexity of the attention function itself, i.e., of

SoftMax

$$( \frac{Q {K}^{T}}{\sqrt{dk}} ) V .$$

The matrices Q and K are both of shape (n, d). The transposition operation does not influence the asymptotic complexity of computing the dot product of matrices of shapes (n, d)·(d, n), therefore its complexity is:

$$n 2 \cdot d$$

Scaling by a constant factor of \sqrt{dk}, where dk is the dimension of the keys vector, as well as applying the SoftMax function, both have the complexity of a·b for a matrix of shape (a, b), hence they do not influence the asymptotic complexity. Lastly the dot product SoftMax

$$( \frac{Q {K}^{T}}{\sqrt{dk}} ) \cdot V$$

is between matrices of shapes (n, n) and (n, d) and so its complexity is:

$$n 2 \cdot d$$

The final asymptotic complexity of scaled dot-product attention is obtained by summing the complexities of computing Q, K, V, and of the following attention function:

$$n \cdot d 2 + n 2 \cdot d .$$

The asymptotic complexity of multi-head attention is the same since the original input matrix X is projected into h matrices of shapes

$$( n , \frac{d}{h} ) ,$$

where h is the number of heads. From the point of view of asymptotic complexity, h is constant, therefore we would arrive at the same estimate of asymptotic complexity using a similar approach as for the scaled dot-product attention.

Transformer models often have the encoder-decoder architecture, although this is not necessarily the case. The encoder is built out of different encoder layers which are all constructed in the same way. The positional encodings are added to the embedding vectors. Afterward, self-attention is performed.

### Encoder Block of Transformer

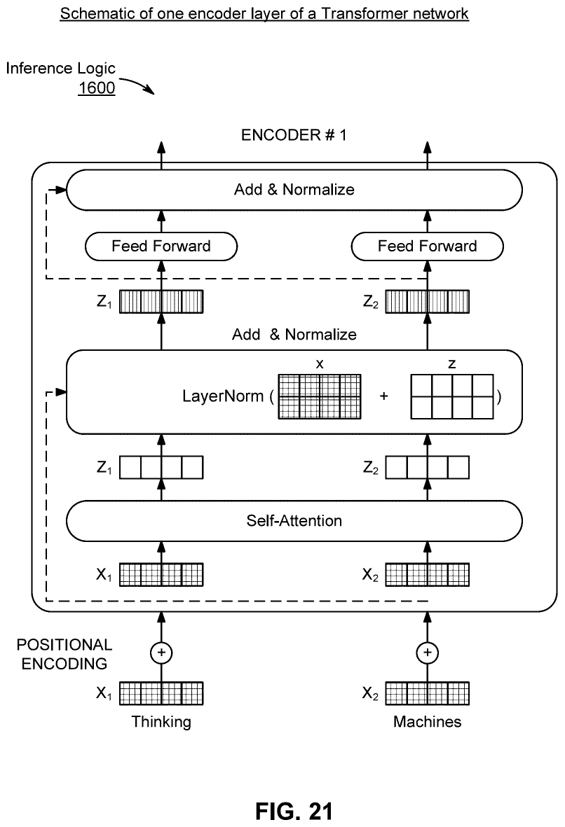

FIG. 21 portrays one encoder layer of a Transformer network. Every self-attention layer is surrounded by a residual connection, summing up the output and input of the self-attention. This sum is normalized, and the normalized vectors are fed to a feed-forward layer. Every z vector is fed separately to this feed-forward layer. The feed-forward layer is wrapped in a residual connection and the outcome is normalized too. Often, numerous encoder layers are piled to form the encoder. The output of the encoder is a fixed-size vector for every element of the input sequence.

Just like the encoder, the decoder is built from different decoder layers. In the decoder, a modified version of self-attention takes place. The query vector is only compared to the keys of previous output sequence elements. The elements further in the sequence are not known yet, as they still must be predicted. No information about these output elements may be used.

### Encoder-Decoder Blocks of Transformer

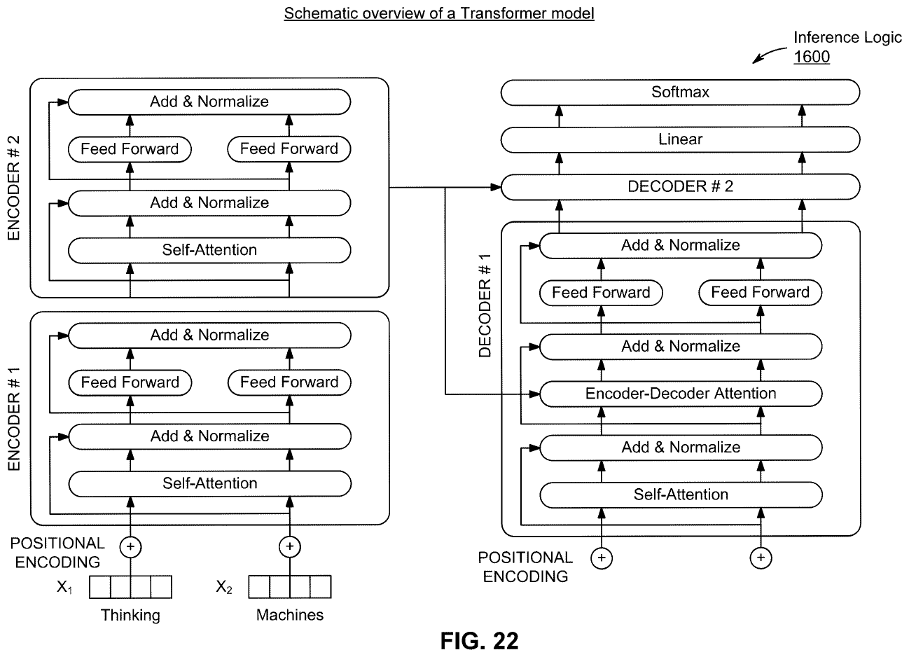

FIG. 22 shows a schematic overview of a Transformer model. Next to a self-attention layer, a layer of encoder-decoder attention is present in the decoder, in which the decoder can examine the last Z vectors of the encoder, providing fluent information transmission. The ultimate decoder layer is a feed-forward layer. All layers are packed in a residual connection. This allows the decoder to examine all previously predicted outputs and all encoded input vectors to predict the next output. Thus, information from the encoder is provided to the decoder, which could improve the predictive capacity. The output vectors of the last decoder layer need to be processed to form the output of the entire system. This is done by a combination of a feed-forward layer and a SoftMax function. The output corresponding to the highest probability is the predicted output value for a subject time step.

For some tasks other than translation, only an encoder is needed. This is true for both document classification and name entity recognition. In these cases, the encoded input vectors are the input of the feed-forward layer and the SoftMax layer. Transformer models have been extensively applied in different NLP fields, such as translation, document summarization, speech recognition, and named entity recognition. These models have applications in the field of biology as well for predicting protein structure and function and labeling DNA sequences.

### Vision Transformer

There are extensive applications of transformers in vision including popular recognition tasks (e.g., image classification, object detection, action recognition, and segmentation), generative modeling, multi-modal tasks (e.g., visual-question answering, visual reasoning, and visual grounding), video processing (e.g., activity recognition, video forecasting), low-level vision (e.g., image super-resolution, image enhancement, and colorization) and 3D analysis (e.g., point cloud classification and segmentation).

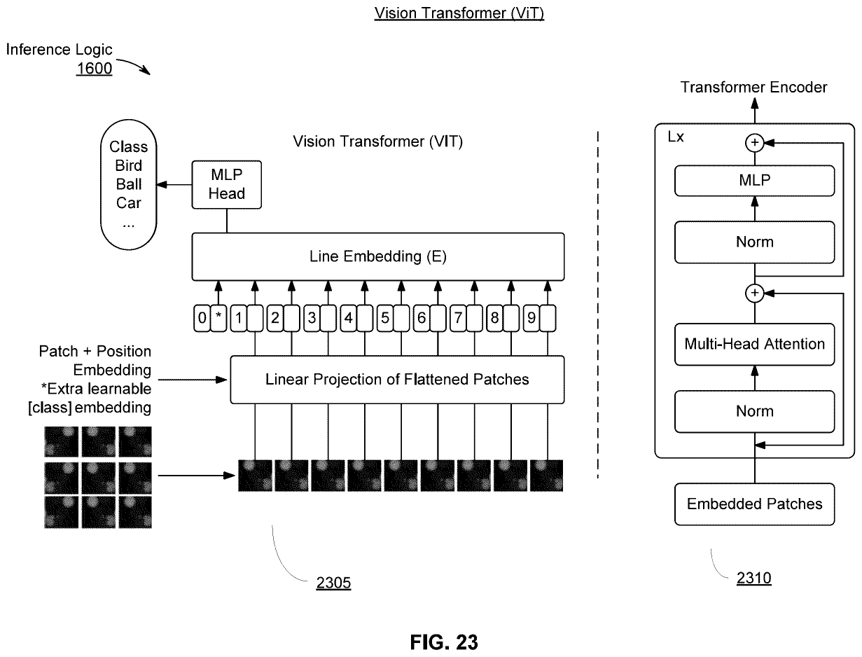

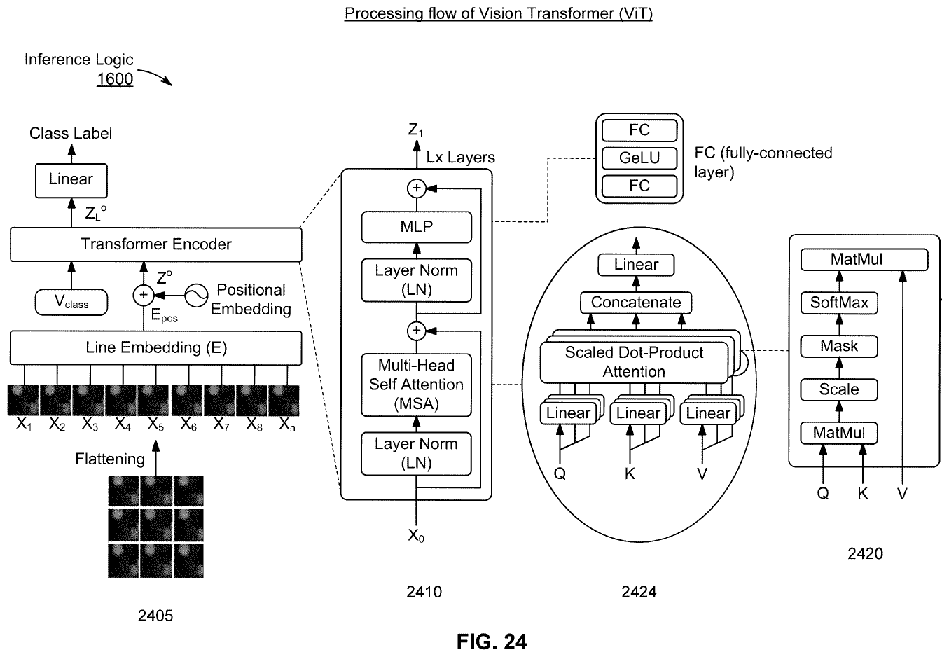

Transformers were originally developed for NLP and worked with sequences of words. In image classification, we often have a single input image in which the pixels are in a sequence. To reduce the computation required, Vision Transformers (ViTs) cut the input image into a set of fixed-sized patches of pixels. The patches are often 16×16 pixels. They are treated much like words in NLP Transformers. ViTs are depicted in FIG. 23 (2305 and 2310) and FIG. 24 (2405, 2410, 2415 and 2420). Unfortunately, important positional information is lost because image sets are position-invariant. This problem is solved by adding a learned positional encoding into the image patches.

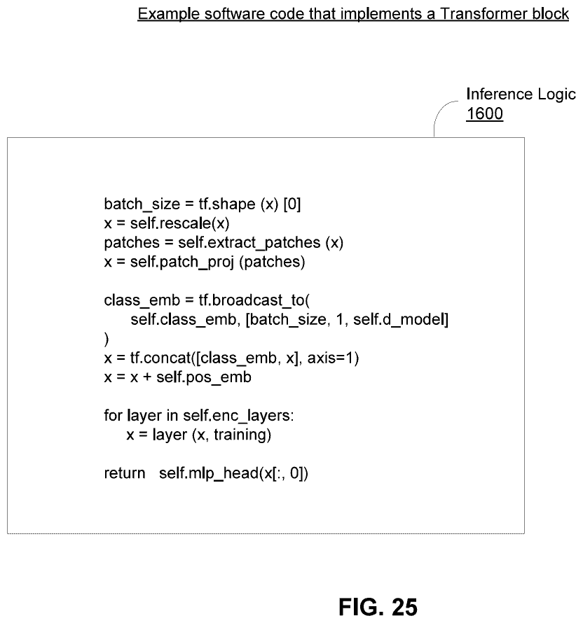

The computations of the ViT architecture can be summarized as follows. The first layer of a ViT extracts a fixed number of patches from an input image (2305 in FIG. 23). The patches are then projected to linear embeddings. A special class token vector is added to the sequence of embedding vectors to include all representative information of all tokens through the multi-layer encoding procedure. The class vector is unique to each image. Vectors containing positional information are combined with the embeddings and the class token. The sequence of embedding vectors is passed into the Transformer blocks. The class token vector is extracted from the output of the last Transformer block and is passed into a multilayer perceptron (MLP) head whose output is the final classification. The perceptron takes the normalized input and places the output in categories. It classifies the images. This procedure directly translates into the Python Keras code shown in FIG. 25.

When the input image is split into patches, a fixed patch size is specified before instantiating a ViT. Given the quadratic complexity of attention, patch size has a large effect on the length of training and inference time. A single Transformer block comprises several layers. The first layer implements Layer Normalization, followed by the multi-head attention that is responsible for the performance of ViTs. In the depiction of a Transformer block (2310) in FIG. 23, we can see two arrows. These are residual skip connections. Including skip connection data can simplify the output and improve the results. The output of the multi-head attention is followed again by Layer Normalization. And finally, the output layer is an MLP (Multi-Layer Perceptron) with the GELU (Gaussian Error Linear Unit) activation function.

ViTs can be pretrained and fine-tuned. Pretraining is generally done on a large dataset. Fine-tuning is done on a domain specific dataset.

Domain-specific architectures, like convolutional neural networks (CNNs) or long short-term memory networks (LSTMs), have been derived from the usual architecture of MLPs and suffer from so-called inductive biases that predispose the networks towards a certain output. ViTs stepped in the opposite direction of CNNs and LSTMs and became more general architectures by eliminating inductive biases. A ViT can be seen as a generalization of MLPs because MLPs, after being trained, do not change their weights for different inputs. On the other hand, ViTs compute their attention weights at runtime based on the particular input.

The following detailed description is made with reference to the figures. Example implementations are described to illustrate the technology disclosed, not to limit its scope. Those of ordinary skill in the art will recognize a variety of equivalent variations on the description that follows. Reference will now be made in detail to the exemplary implementations of the technology disclosed, examples of which are illustrated in the accompanying drawings. Wherever possible, the same reference numbers will be used throughout the drawings to refer to the same or like parts.

The following discussion is presented to enable any person skilled in the art to make and use the technology disclosed and is provided in the context of a particular application and its requirements. Various modifications to the disclosed implementations will be readily apparent to those skilled in the art, and the general principles defined herein may be applied to other implementations and applications without departing from the spirit and scope of the technology disclosed. Thus, the technology disclosed is not intended to be limited to the implementations shown but is to be accorded the widest scope consistent with the principles and features disclosed herein.

The systems, devices, and methods disclosed herein are described in detail by way of examples and with reference to the figures. The examples discussed herein are examples only and are provided to assist in the explanation of the apparatuses, devices, systems, and methods described herein. None of the features or components shown in the drawings or discussed below should be taken as mandatory for any specific implementation of any of these devices, systems, or methods unless specifically designated as mandatory.

Also, for any methods described, regardless of whether the method is described in conjunction with a flow diagram, it should be understood that unless otherwise specified or required by context, any explicit or implicit ordering of steps performed in the execution of a method does not imply that those steps must be performed in the order presented but instead may be performed in a different order or in parallel.

The detailed description of various implementations will be better understood when read in conjunction with the appended drawings. To the extent that the figures illustrate diagrams of the functional blocks of the various implementations, the functional blocks are not necessarily indicative of the division between hardware circuitry. Thus, for example, one or more of the functional blocks (e.g., modules, processors, or memories) may be implemented in a single piece of hardware (e.g., a general-purpose signal processor or a block of random-access memory, hard disk, or the like) or multiple pieces of hardware. Similarly, the programs may be stand-alone programs, may be incorporated as subroutines in an operating system, may be functions in an installed software package, and the like. It should be understood that the various implementations are not limited to the arrangements and instrumentality shown in the drawings.

The processing engines and databases of the figures, designated as modules, can be implemented in hardware or software, and need not be divided up in precisely the same blocks as shown in the figures. Some of the modules can also be implemented on different processors, computers, or servers, or spread among a number of different processors, computers, or servers. In addition, it will be appreciated that some of the modules can be combined, operated in parallel or in a different sequence than that shown in the figures without affecting the functions achieved. The modules in the figures can also be thought of as flowchart steps in a method. A module also need not necessarily have all its code disposed contiguously in memory; some parts of the code can be separated from other parts of the code with code from other modules or other functions disposed in between.

### Computer Architecture

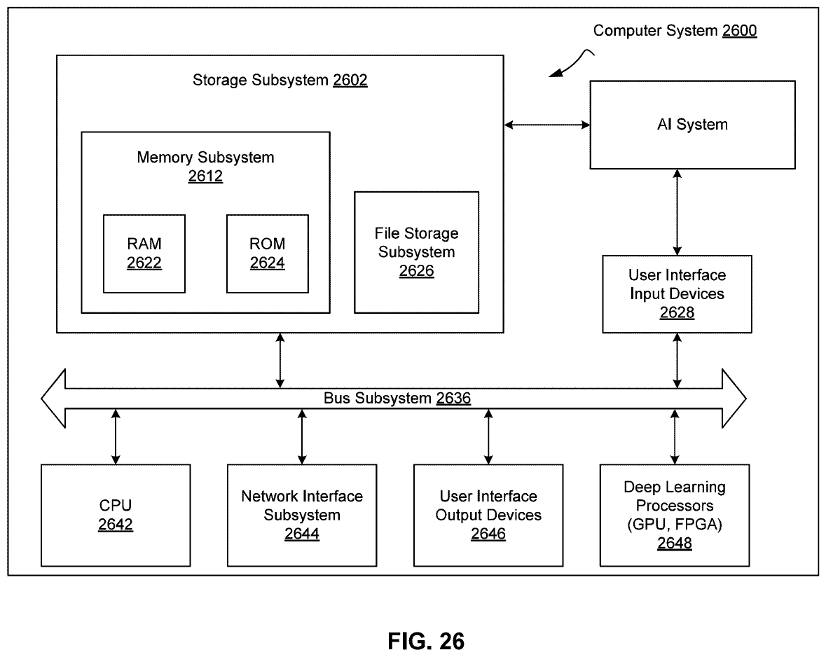

FIG. 26 illustrates a computing system 2600 for implementing one or more computational aspects of the present disclosure, including, for example, execution of instructions for characterizing a biological neural network, operating a simulated task environment in closed loop, evaluating task performance, and adaptively selecting and delivering training electrical stimulation patterns. The computing system 2600 is provided as one non-limiting example of a suitable computing platform and is not intended to suggest any limitation as to the scope of use or functionality. Regardless of the particular configuration, the computing system 2600 is capable of implementing any of the functionality described herein.

The computing system 2600 may be implemented using any of a variety of general-purpose or special-purpose computing environments or configurations. Examples of suitable computing systems, environments, and configurations include, without limitation, personal computers, server computer systems, thin clients, thick clients, handheld or laptop devices, multiprocessor systems, microprocessor-based systems, set-top boxes, programmable consumer electronics, network PCs, minicomputer systems, mainframe computer systems, and distributed computing environments that include any of the foregoing systems or devices.

The computing system 2600 may be described in the general context of computer system-executable instructions, such as program modules, being executed by one or more processors. Program modules may include routines, programs, objects, components, logic, data structures, and the like that perform particular tasks or implement particular abstract data types. The computing system 2600 may be practiced in distributed computing environments where tasks are performed by remote processing devices that are linked through a communications network. In a distributed computing environment, program modules may be located in both local and remote computer system storage media including memory storage devices.

As depicted in FIG. 26, the computing system 2600 includes a storage subsystem 2602, a bus subsystem 2616, a central processing unit (CPU) 2618, a network interface subsystem 2620, and a user interface output device 2622. The storage subsystem 2602 further includes a memory subsystem 2604 and a file storage subsystem 2610. The memory subsystem 2604 includes random access memory (RAM) 2606 and read-only memory (ROM) 2608, which together provide system memory for storing program instructions and data that are immediately accessible to the CPU 2618 during operation.

The bus subsystem 2616 couples the CPU 2618, the storage subsystem 2602, the network interface subsystem 2620, the user interface output device 2622, and a user interface input device 2614. The bus subsystem 2616 represents one or more of any of several types of bus structures, including a memory bus or memory controller, a peripheral bus, an accelerated graphics port, and a processor or local bus using any of a variety of bus architectures. By way of example and not limitation, such architectures may include an Industry Standard Architecture (ISA) bus, a Micro Channel Architecture (MCA) bus, an Enhanced ISA (EISA) bus, a Video Electronics Standards Association (VESA) local bus, a Peripheral Component Interconnect (PCI) bus, a Peripheral Component Interconnect Express (PCIe) bus, and an Advanced Microcontroller Bus Architecture (AMBA) bus.

The computing system 2600 typically includes a variety of computer system readable media. Such media may be any available media that is accessible by the computing system 2600 and may include both volatile and non-volatile media, and removable and non-removable media. System memory provided by the memory subsystem 2604 can include computer system readable media in the form of volatile memory, such as RAM 2606 and/or cache memory. The computing system 2600 may further include other removable or non-removable, volatile or non-volatile computer system storage media within the file storage subsystem 2610. By way of example only, the file storage subsystem 2610 may include one or more non-removable, non-volatile storage devices such as magnetic hard drives, solid-state drives, or other mass-storage devices. In other implementations, the file storage subsystem 2610 may also support removable storage, such as magnetic disks, optical disks (for example, CD-ROM or DVD-ROM media), or other removable non-volatile media, connected to the bus subsystem 2616 through one or more data media interfaces.

The memory subsystem 2604 may store at least one program product having a set of program modules configured to carry out the functions described herein, including the operations for characterizing putative neural units, computing connectivity information, operating the simulated dynamical task environment, decoding control signals, evaluating task performance, and adaptively selecting and delivering training electrical stimulation patterns. A program/utility having one or more program modules may be stored in the memory subsystem 2604, together with an operating system, one or more application programs, other program modules, and program data. Each of the operating system, application programs, other program modules, and program data, or some combination thereof, may implement a networking environment and the closed-loop control functionality associated with the present disclosure. The program modules generally carry out the functions and methodologies of the embodiments described herein.

Computer readable program instructions for carrying out operations of the present disclosure may be assembler instructions, instruction-set-architecture (ISA) instructions, machine instructions, machine-dependent instructions, microcode, firmware instructions, state-setting data, or either source code or object code written in any combination of one or more programming languages, including object-oriented programming languages such as Smalltalk or C++, and conventional procedural programming languages such as the C programming language or similar languages. The computer readable program instructions may execute entirely on the computing system 2600, partly on the computing system 2600 and partly on a remote computer, or entirely on a remote computer or server. In the latter scenario, the remote computer may be connected to the computing system 2600 through any type of network, including a local area network (LAN) or a wide area network (WAN), or through an external network such as the Internet using an Internet service provider. In some implementations, electronic circuitry such as programmable logic circuitry, field-programmable gate arrays (FPGA), or programmable logic arrays (PLA) may execute the computer readable program instructions by utilizing state information of the instructions to personalize the electronic circuitry to perform aspects of the present disclosure.

Aspects of the present disclosure may be described with reference to flowchart illustrations and/or block diagrams of methods, systems, and computer program products. It will be understood that each block of such flowcharts and/or block diagrams, and combinations of blocks, can be implemented by computer readable program instructions. These computer readable program instructions may be provided to the CPU 2618 or to another processor of a general-purpose or special-purpose computing device to produce a machine, such that the instructions executed by the processor implement the functions specified in the flowchart or block diagram blocks.

The computer readable program instructions may also be stored in a computer readable storage medium of the storage subsystem 2602 that can direct the computing system 2600 or another programmable apparatus to function in a particular manner, such that the storage medium having instructions stored therein comprises an article of manufacture including instructions which implement aspects of the functions described herein. The instructions may also be loaded onto the computing system 2600 or another device to cause a series of operational steps to be performed so as to implement processes such as the real-time read, environment-update, and conditional training phases of the closed-loop system.

The user interface input device 2614 may include one or more devices such as a keyboard, mouse, touch screen, pointing device, or other human-machine interface configured to receive user commands, configuration parameters, or experimental control inputs relevant to operation of the system described in this specification. The user interface output device 2622 may include a display, monitor, graphical user interface, speakers, or other output peripherals configured to present task-performance metrics, connectivity visualizations, or real-time status information to an operator. The network interface subsystem 2620 enables the computing system 2600 to communicate with external systems, databases, remote servers, or laboratory information systems over wired or wireless communication links, thereby supporting remote data storage, collaborative analysis, or distributed experiment control.

Accordingly, the computing system 2600 provides a flexible and scalable platform for implementing the computational operations associated with inducing adaptive learning in biological neural networks cultured in vitro, while remaining compatible with a broad range of hardware and software environments.

### Clauses

The technology disclosed can be practiced as a system, method, or article of manufacture. One or more features of an implementation can be combined with the base implementation. Implementations that are not mutually exclusive are taught to be combinable. One or more features of an implementation can be combined with other implementations. This disclosure periodically reminds the user of these options. Omission from some implementations of recitations that repeat these options should not be taken as limiting the combinations taught in the preceding sections—these recitations are hereby incorporated forward by reference into each of the following implementations.

One or more implementations and clauses of the technology disclosed, or elements thereof can be implemented in the form of a computer product, including a non-transitory computer readable storage medium with computer usable program code for performing the method steps indicated. Furthermore, one or more implementations and clauses of the technology disclosed, or elements thereof can be implemented in the form of an apparatus including a memory and at least one processor that is coupled to the memory and operative to perform exemplary method steps. Yet further, in another aspect, one or more implementations and clauses of the technology disclosed or elements thereof can be implemented in the form of means for carrying out one or more of the method steps described herein; the means can include (i) hardware module(s), (ii) software module(s) executing on one or more hardware processors, or (iii) a combination of hardware and software modules; any of (i)-(iii) implement the specific techniques set forth herein, and the software modules are stored in a computer readable storage medium (or multiple such media).

The clauses described in this section can be combined as features. In the interest of conciseness, the combinations of features are not individually enumerated and are not repeated with each base set of features. The reader will understand how features identified in the clauses described in this section can readily be combined with sets of base features identified as implementations in other sections of this application. These clauses are not meant to be mutually exclusive, exhaustive, or restrictive; and the technology disclosed is not limited to these clauses but rather encompasses all possible combinations, modifications, and variations within the scope of the claimed technology and its equivalents.

Other implementations of the clauses described in this section can include a non-transitory computer readable storage medium storing instructions executable by a processor to perform any of the clauses described in this section. Yet another implementation of the clauses described in this section can include a system including memory and one or more processors operable to execute instructions, stored in the memory, to perform any of the clauses described in this section.

We disclose the following clauses:

### Method Clauses

1. A computer-implemented method for transforming input data for large language models, the method comprising:
constructing a paired input dataset by:
   receiving an initial input data comprising a prompt component and a contextual data component, wherein the contextual data component comprises at least one of: outputs from prior task executions, memory elements, retrieved documents, reasoning traces, tool observations, or environment state data;
   generating, using at least two different input optimization methods selected from a group consisting of heuristic editing, reinforcement learning-based optimization, search-based optimization, soft prompt tuning, extractive compression, abstractive summarization, and cost-aware refinement, a plurality of candidate optimized inputs from the initial input data;
   evaluating responses produced by at least one large language model in response to the plurality of candidate optimized inputs, wherein evaluating comprises computing at least one of: a response quality metric measuring accuracy, relevance, or coherence of a response, a computational cost metric measuring token usage, latency, or inference cost, or a semantic equivalence metric measuring similarity between responses produced using the initial input data and responses produced using a candidate optimized input; and
   selecting, based on the evaluation, a candidate optimized input that, relative to the initial input data, improves quality of a response produced by the at least one large language model or reduces computational cost of producing the response, the initial input data and the selected candidate optimized input forming a paired entry in the paired input dataset;
training an input transformation model on the paired input dataset to learn a mapping from initial input data to corresponding optimized inputs, wherein:
   the input transformation model comprises an encoder-decoder architecture having an encoder configured to process the initial input data and a decoder configured to generate the optimized input;
   training the input transformation model comprises minimizing a loss function comprising a reconstruction loss measuring fidelity between a generated optimized input and a target optimized input from the paired input dataset, and a semantic preservation loss measuring semantic similarity between the initial input data and the generated optimized input; and
   the input transformation model is separate from any target large language model and does not share parameters with any target large language model;
training an inter-model adaptation module to convert an optimized input produced for a first large language model into an adapted input for a second large language model that is different from the first large language model, wherein:
   training the inter-model adaptation module comprises contrastive learning on input-response pairs collected from a plurality of different large language models;
   the contrastive learning encourages the inter-model adaptation module to map semantically equivalent inputs for different large language models to nearby positions in a shared embedding space; and
   the inter-model adaptation module is configured to preserve semantic meaning of the optimized input while restructuring the optimized input for differences in architecture, tokenization, or interpretive characteristics between the first large language model and the second large language model;
at runtime, receiving a new initial input data not present in the paired input dataset, the new initial input data comprising a prompt component and a contextual data component, and receiving a target large language model specification identifying a target large language model;
applying the trained input transformation model to transform the new initial input data into an optimized input, wherein applying comprises performing a single forward pass through the input transformation model without querying the target large language model during transformation, without task-specific retraining of the input transformation model, and without iterative optimization of the new initial input data;
when the target large language model identified by the target large language model specification is different from the first large language model, applying the inter-model adaptation module to convert the optimized input into an adapted input for the target large language model; and
outputting the optimized input or the adapted input for invocation of the target large language model.

2. The method of clause 1, wherein the contextual data component comprises reasoning traces, and wherein the reasoning traces comprise intermediate reasoning steps generated by prior invocations of a large language model during execution of a multi-step workflow.

3. The method of clause 1, wherein the contextual data component comprises tool observations, and wherein the tool observations comprise structured or unstructured outputs returned by external tools, application programming interfaces, or software functions invoked during execution of a workflow.

4. The method of clause 1, wherein the contextual data component comprises retrieved documents, and wherein the retrieved documents comprise content retrieved from a knowledge base, vector database, document repository, or external data source based on a retrieval query.

5. The method of clause 1, wherein the contextual data component comprises memory elements, and wherein the memory elements comprise information persisted across workflow steps or across separate workflow executions in a memory store accessible to a large language model agent.

6. The method of clause 1, wherein the contextual data component comprises environment state data, and wherein the environment state data comprises current state information of an execution environment, a software application, or a computing system with which a large language model agent interacts.

7. The method of clause 1, wherein the contextual data component comprises at least three of: reasoning traces, tool observations, retrieved documents, memory elements, and environment state data, and wherein a total token count of the contextual data component exceeds a token count of the prompt component.

8. The method of clause 1, wherein the initial input data is accumulated during execution of a multi-step workflow by a large language model agent, and wherein the multi-step workflow comprises at least five sequential or branching tasks.

9. The method of clause 1, wherein the at least two different input optimization methods comprise heuristic editing and reinforcement learning-based optimization, wherein heuristic editing comprises applying rule-based transformations to modify structure, length, or formatting of the initial input data, and wherein reinforcement learning-based optimization comprises training a policy to generate modifications that maximize a reward signal based on response quality.

10. The method of clause 1, wherein the at least two different input optimization methods comprise search-based optimization and soft prompt tuning, wherein search-based optimization comprises exploring a space of candidate modifications using beam search, Monte Carlo tree search, or evolutionary algorithms, and wherein soft prompt tuning comprises optimizing continuous embedding vectors prepended to the initial input data.

11. The method of clause 1, wherein the at least two different input optimization methods comprise extractive compression and abstractive summarization, wherein extractive compression comprises selecting and retaining portions of the contextual data component while removing other portions, and wherein abstractive summarization comprises generating a condensed representation of the contextual data component that captures semantic content in fewer tokens.

12. The method of clause 1, wherein the at least two different input optimization methods comprise cost-aware refinement, and wherein cost-aware refinement comprises optimizing the initial input data to reduce a target metric selected from the group consisting of: total token count, inference latency, computational cost measured in floating point operations, and monetary cost based on a pricing model of the target large language model.

13. The method of clause 1, wherein generating the plurality of candidate optimized inputs comprises applying the at least two different input optimization methods independently and in parallel to the initial input data, and wherein selecting the candidate optimized input comprises performing a unified ranking across all candidate optimized inputs regardless of which input optimization method generated each candidate.

14. The method of clause 1, wherein generating the plurality of candidate optimized inputs comprises generating at least five candidate optimized inputs from the initial input data using the at least two different input optimization methods.

15. The method of clause 1, wherein the response quality metric comprises an accuracy metric, and wherein the accuracy metric measures correctness of a response relative to a ground truth answer, a reference output, or an expected outcome.

16. The method of clause 1, wherein the response quality metric comprises a relevance metric, and wherein the relevance metric measures alignment of a response with an intent, objective, or information need expressed in the prompt component of the initial input data.

17. The method of clause 1, wherein the response quality metric comprises a coherence metric, and wherein the coherence metric measures logical consistency, fluency, and structural organization of a response.

18. The method of clause 1, wherein the computational cost metric comprises a token usage metric, and wherein the token usage metric measures a total number of input tokens processed by the target large language model or a total number of output tokens generated by the target large language model.

19. The method of clause 1, wherein the computational cost metric comprises a latency metric, and wherein the latency metric measures elapsed time from submission of an input to receipt of a complete response from the target large language model.

20. The method of clause 1, wherein the semantic equivalence metric comprises a cosine similarity between embedding vectors, and wherein computing the semantic equivalence metric comprises:
generating a first embedding vector by applying a sentence embedding model to a response produced using the initial input data;
generating a second embedding vector by applying the sentence embedding model to a response produced using the candidate optimized input; and
computing the semantic equivalence metric as a cosine similarity between the first embedding vector and the second embedding vector.

21. The method of clause 20, wherein the sentence embedding model comprises a transformer-based encoder trained on a sentence similarity task.

22. The method of clause 1, wherein evaluating further comprises applying an evaluation large language model to compare responses and generate a preference judgment indicating whether a response produced using a candidate optimized input is better than, equal to, or worse than a response produced using the initial input data.

23. The method of clause 1, wherein the encoder of the encoder-decoder architecture comprises a transformer encoder having a plurality of self-attention layers and feed-forward layers, and wherein the decoder comprises a transformer decoder having a plurality of cross-attention layers configured to attend to encoder outputs.

24. The method of clause 1, wherein the encoder-decoder architecture comprises a pre-trained sequence-to-sequence model that is fine-tuned on the paired input dataset.

25. The method of clause 1, wherein the reconstruction loss comprises a cross-entropy loss computed over tokens of the target optimized input, and wherein the semantic preservation loss comprises a contrastive loss or a cosine embedding loss computed over dense representations of the initial input data and the generated optimized input.

26. The method of clause 1, wherein minimizing the loss function comprises weighting the reconstruction loss and the semantic preservation loss according to respective weighting coefficients, and wherein the weighting coefficients are selected to balance fidelity to training targets against preservation of input semantics.

27. The method of clause 1, wherein the input transformation model is trained to generate both:
a hard output comprising human-readable text tokens; and
a soft output comprising continuous embedding vectors;
and wherein applying the trained input transformation model comprises selecting between the hard output and the soft output based on whether the target large language model accepts embedding-level inputs.

28. The method of clause 1, wherein the input transformation model has fewer parameters than the target large language model.

29. The method of clause 1, wherein training the inter-model adaptation module comprises:
collecting a corpus of input-response pairs from the plurality of different large language models, wherein each input-response pair comprises an input provided to a large language model and a corresponding response generated by the large language model;
for each input in the corpus, generating an embedding using an input encoder; and
applying contrastive learning to train the input encoder and the inter-model adaptation module such that embeddings of semantically equivalent inputs for different large language models are closer in the shared embedding space than embeddings of semantically different inputs.

30. The method of clause 1, wherein the plurality of different large language models comprise at least two large language models selected from the group consisting of: GPT-family models, Claude-family models, Gemini-family models, Llama-family models, and Mistral-family models.

31. The method of clause 1, wherein the inter-model adaptation module is configured to restructure the optimized input to account for differences in tokenization schemes between the first large language model and the second large language model.

32. The method of clause 1, wherein the inter-model adaptation module is configured to restructure the optimized input to account for differences in context window sizes between the first large language model and the second large language model.

33. The method of clause 1, wherein the inter-model adaptation module is further configured to generate a confidence score indicating a predicted quality of the adapted input for the target large language model, and wherein the adapted input is output only when the confidence score exceeds a predetermined confidence threshold.

34. The method of clause 1, wherein performing the single forward pass through the input transformation model produces the optimized input in a time duration that is less than a time duration required to perform iterative optimization of the new initial input data using the target large language model.

35. The method of clause 1, wherein the target large language model specification comprises at least one of: an identifier of the target large language model, a model architecture descriptor specifying architecture type and parameter count, a model capability profile specifying supported input modalities and context window size, or an API endpoint specification identifying a network address for invoking the target large language model.

### System Clauses

36. A system for transforming input data for large language models, the system comprising:
one or more processors; and
one or more non-transitory computer-readable media storing instructions that, when executed by the one or more processors, cause the system to:
   construct a paired input dataset by:
      receiving an initial input data comprising a prompt component and a contextual data component, wherein the contextual data component comprises at least one of: outputs from prior task executions, memory elements, retrieved documents, reasoning traces, tool observations, or environment state data;
      generating, using at least two different input optimization methods selected from a group consisting of heuristic editing, reinforcement learning-based optimization, search-based optimization, soft prompt tuning, extractive compression, abstractive summarization, and cost-aware refinement, a plurality of candidate optimized inputs from the initial input data;
      evaluating responses produced by at least one large language model in response to the plurality of candidate optimized inputs, wherein evaluating comprises computing at least one of: a response quality metric, a computational cost metric, or a semantic equivalence metric; and
      selecting, based on the evaluation, a candidate optimized input that, relative to the initial input data, improves quality of a response produced by the at least one large language model or reduces computational cost of producing the response, the initial input data and the selected candidate optimized input forming a paired entry in the paired input dataset;
   train an input transformation model on the paired input dataset to learn a mapping from initial input data to corresponding optimized inputs, wherein:
      the input transformation model comprises an encoder-decoder architecture;
      training the input transformation model comprises minimizing a loss function comprising a reconstruction loss and a semantic preservation loss; and
      the input transformation model is separate from any target large language model;
   train an inter-model adaptation module using contrastive learning on input-response pairs collected from a plurality of different large language models, wherein the inter-model adaptation module is configured to convert an optimized input produced for a first large language model into an adapted input for a second large language model while preserving semantic meaning;
   at runtime, receive a new initial input data comprising a prompt component and a contextual data component, and receive a target large language model specification;
   apply the trained input transformation model to transform the new initial input data into an optimized input via a single forward pass without iterative optimization;
   when the target large language model identified by the target large language model specification is different from the first large language model, apply the inter-model adaptation module to convert the optimized input into an adapted input; and
   output the optimized input or the adapted input for invocation of the target large language model.

37. The system of clause 36, wherein the input transformation model and the inter-model adaptation module are stored as separately deployable model artifacts, and wherein the system is configured to load the inter-model adaptation module only when the target large language model specification identifies a target large language model different from the first large language model.

38. The system of clause 36, wherein the system further comprises a model registry storing metadata for a plurality of supported target large language models, and wherein receiving the target large language model specification comprises resolving the specification against the model registry to identify model-specific adaptation parameters for the inter-model adaptation module.

39. The system of clause 38, wherein the metadata for each supported target large language model comprises at least one of: a model identifier, a model architecture type, a parameter count, a context window size, supported input modalities, a tokenizer identifier, or an API endpoint.

40. The system of clause 36, wherein the system exposes an application programming interface configured to receive, via a single API call, the new initial input data comprising the prompt component and the contextual data component together with the target large language model specification, and to return the optimized input or the adapted input.

41. The system of clause 40, wherein the application programming interface is a RESTful API or a gRPC API.

42. The system of clause 36, wherein the system is deployed as a cloud-based service accessible over a network.

43. The system of clause 36, wherein the system is deployed on-premises within an enterprise network.

44. The system of clause 36, wherein the contextual data component comprises accumulated context from a multi-step workflow executed by a large language model agent, and wherein the system is configured to process contextual data components having a token count exceeding 10,000 tokens.

45. The system of clause 36, wherein the system is configured to reduce a total token count of the new initial input data by at least 30 percent when transforming the new initial input data into the optimized input, while maintaining a semantic equivalence score above a predetermined threshold.

46. The system of clause 45, wherein the predetermined threshold is at least 0.80 as measured by cosine similarity between embedding vectors of responses.

47. The system of clause 36, wherein the system further comprises a context analyzer configured to identify, within the contextual data component, context elements relevant to a task specified in the prompt component, and wherein transforming the new initial input data comprises retaining identified relevant context elements while compressing or removing context elements identified as not relevant.

48. The system of clause 36, wherein the system further comprises a dataset expansion module configured to iteratively expand the paired input dataset by repeating construction of paired entries across a plurality of different initial input data instances spanning multiple task domains.

49. The system of clause 48, wherein the multiple task domains comprise at least two of: question answering, summarization, code generation, document analysis, data extraction, and conversational dialogue.

50. The system of clause 36, wherein the system further comprises a continuous learning module configured to update the paired input dataset with additional paired entries generated from input data received during runtime, and to periodically retrain the input transformation model on the updated paired input dataset.

51. The system of clause 36, wherein the encoder-decoder architecture of the input transformation model comprises a transformer encoder and a transformer decoder, the transformer encoder having at least six self-attention layers and the transformer decoder having at least six cross-attention layers.

52. The system of clause 36, wherein the reconstruction loss comprises a token-level cross-entropy loss, and wherein the semantic preservation loss comprises a sentence-level contrastive loss.

53. The system of clause 36, wherein the shared embedding space has a dimensionality of at least 256 dimensions.

54. The system of clause 36, wherein the plurality of different large language models from which input-response pairs are collected comprises at least three different large language model families.

55. The system of clause 36, wherein the inter-model adaptation module comprises a neural network having at least two hidden layers and trained using a contrastive loss function that maximizes similarity between embeddings of semantically equivalent inputs and minimizes similarity between embeddings of semantically different inputs.

### Non-Transitory Computer-Readable Medium Clauses

56. One or more non-transitory computer-readable media storing instructions that, when executed by one or more processors, cause the one or more processors to perform operations for transforming input data for large language models, the operations comprising:
constructing a paired input dataset by:
   receiving an initial input data comprising a prompt component and a contextual data component, wherein the contextual data component comprises at least one of: outputs from prior task executions, memory elements, retrieved documents, reasoning traces, tool observations, or environment state data;
   generating, using at least two different input optimization methods selected from a group consisting of heuristic editing, reinforcement learning-based optimization, search-based optimization, soft prompt tuning, extractive compression, abstractive summarization, and cost-aware refinement, a plurality of candidate optimized inputs from the initial input data;
   evaluating responses produced by at least one large language model in response to the plurality of candidate optimized inputs; and
   selecting, based on the evaluation, a candidate optimized input that improves quality of a response or reduces computational cost relative to the initial input data, the initial input data and the selected candidate optimized input forming a paired entry in the paired input dataset;
training an input transformation model comprising an encoder-decoder architecture on the paired input dataset to learn a mapping from initial input data to corresponding optimized inputs, wherein the input transformation model is separate from any target large language model, and wherein training comprises minimizing a loss function comprising a reconstruction loss and a semantic preservation loss;
training an inter-model adaptation module using contrastive learning to convert an optimized input produced for a first large language model into an adapted input for a second large language model while preserving semantic meaning;
at runtime, receiving a new initial input data comprising a prompt component and a contextual data component, and receiving a target large language model specification;
applying the trained input transformation model via a single forward pass to transform the new initial input data into an optimized input without iterative optimization;
when the target large language model is different from the first large language model, applying the inter-model adaptation module to produce an adapted input; and
outputting the optimized input or the adapted input for invocation of the target large language model.

1. A computer-implemented method comprising:
receiving an input;
applying, by at least one processor, a transformation model to the input in a single forward pass to produce a transformed input, the transformation model having parameters independent of a target language model and trained on paired training data generated by applying two or more transformation techniques to training inputs and selecting one candidate per training input based on output quality; and
providing the transformed input to the target language model, the transformed input requiring fewer computational resources for the target language model to process than the input.

2. The method of claim 1, wherein the paired training data is generated by, for each training input:
applying, by the at least one processor, each of the two or more transformation techniques to the training input as a distinct computational operation to produce at least one corresponding candidate; and
evaluating each candidate against a quality criterion measuring how well the candidate preserves information from the training input and selecting the candidate that satisfies the quality criterion to a greater degree than the remaining candidates.

3. The method of claim 2, wherein the quality criterion is a measure of output similarity between an output produced by the target language model in response to the candidate and a reference output produced by the target language model in response to the corresponding training input, the quality criterion being computed by applying the target language model in inference mode.

4. The method of claim 2, wherein the two or more transformation techniques comprise at least two of: a paraphrasing technique that rewrites the training input while preserving semantic content, a summarization technique that produces a condensed version of the training input, a key information extraction technique that retains salient information from the training input, a structured reformatting technique that reorganizes the training input into a structured form, and a semantic compression technique that encodes the semantic content of the training input in a shorter representation.

5. The method of claim 1, wherein the transformation model is trained using a training objective independent of a training objective of the target language model, and the parameters of the target language model remain unchanged throughout training of the transformation model.

6. The method of claim 1, wherein the transformed input has fewer tokens than the input.

7. The method of claim 1, wherein the input is one of: natural language text, programming code, structured data in a machine-readable format, and a multimodal input combining two or more of natural language text, image data, and audio data.

8. The method of claim 1, wherein the single forward pass comprises the transformation model processing the input through all layers of the transformation model in one forward direction to produce the transformed input, without iterative processing of the input and without querying the target language model during production of the transformed input.

9. The method of claim 1, further comprising:
applying a trained adaptation model to the transformed input to produce an adapted input, the trained adaptation model having parameters independent of the parameters of the transformation model and of a second target language model, the trained adaptation model trained to convert outputs of the transformation model into a form accepted by the second target language model; and
providing the adapted input to the second target language model, the second target language model being different from the target language model.

10. A computer-implemented method comprising:
receiving an input and a task identifier specifying a task for a target language model;
applying, by at least one processor, a transformation model to the input and the task identifier in a single forward pass to produce a compressed output having fewer tokens than the input, the transformation model having parameters independent of the target language model and trained on task-conditioned paired training data generated by applying two or more transformation techniques to training inputs and selecting one candidate per training input based on output quality, the compressed output retaining information sufficient for the target language model to complete the task; and
providing the compressed output to the target language model to perform the task, the compressed output requiring fewer computational resources for the target language model to process than the input.

11. The method of claim 10, wherein the input is a context window from an agentic workflow comprising interaction history from two or more prior agent steps, and the compressed output retains portions of the interaction history the transformation model determines to be critical to completing the task and represents, at a reduced level of detail, portions the transformation model determines to be less critical to completing the task.

12. The method of claim 11, wherein the transformation model applies a relevance scoring function to each portion of the interaction history, the relevance scoring function learned from the task-conditioned paired training data and producing a relevance score for each portion with respect to the task, portions scoring above a learned threshold being retained at full detail and portions scoring below the learned threshold being represented at a reduced level of detail.

13. The method of claim 10, wherein the task-conditioned paired training data is generated by, for each training input and each associated task identifier:
applying two or more transformation techniques to the training input to produce candidates; and
selecting one candidate based on a quality criterion measuring how well the candidate preserves information sufficient for the target language model to complete the task specified by the task identifier.

14. The method of claim 10, further comprising:
receiving two or more inputs each with a corresponding task identifier; and
executing the transformation model concurrently on each input together with its corresponding task identifier in a respective single forward pass to produce a corresponding compressed output conditioned on that task identifier.

15. A system comprising:
one or more processors; and
a memory storing instructions that, when executed by the one or more processors, cause the system to:
receive an input;
apply a transformation model to the input in a single forward pass to produce a transformed input, the transformation model having a first set of parameters independent of each of a plurality of target language models and trained on paired training data to produce a transformed input from the input;
apply an adaptation model to the transformed input to produce an adapted input for a selected one of the plurality of target language models, the adaptation model having a second set of parameters independent of the first set of parameters and of the selected target language model, the adaptation model trained to convert outputs of the transformation model into a form accepted by the selected target language model; and
provide the adapted input to the selected target language model, the transformation model and the adaptation model together enabling the system to process inputs for each of the plurality of target language models using the first set of parameters.

16. The system of claim 15, wherein the transformation model is trained on paired training data generated by applying two or more transformation techniques to training inputs and selecting one candidate per training input based on a quality criterion measuring how well the candidate preserves information from the corresponding training input.

17. The system of claim 15, wherein the transformation model is trained using a training objective independent of a training objective of each of the plurality of target language models, and the first set of parameters converge to values encoding input-output mappings learned from the paired training data.

18. The system of claim 15, wherein the adaptation model is trained on adaptation training data comprising pairs of transformation model outputs and corresponding input representations of the selected target language model, and the first set of parameters of the transformation model remain unchanged during training of the adaptation model.

19. The system of claim 15, wherein the instructions further cause the system to receive a task identifier specifying a task, and the transformation model produces the transformed input conditioned on the task identifier such that the transformed input has fewer tokens than the input and retains information sufficient for the target language model to complete the task.

20. The system of claim 15, wherein the instructions further cause the system to:
select the selected target language model from among the plurality of target language models based on a selection criterion associated with the input; and
apply, from among a plurality of adaptation models, the adaptation model corresponding to the selected target language model, each adaptation model in the plurality corresponding to a respective one of the plurality of target language models and having parameters mapping outputs of the transformation model to an input format accepted by that target language model.
